(19) United States
(12) Patent Application Publication
(10) Pub. No.: US 2005/0187834 A1
(43) Pub. Date: Aug. 25, 2005

(54) On-line parts location and transaction system

(76) Inventors: Jeffrey William Painter, Dayton, OH (US); Larry Ron Newcomer, Springboro, OH (US); Richard David Welage, Mason, OH (US); Roscoe Matthias Rush, Barlett, IL (US); Edward James Wasser, Dayton, OH (US); Timothy Joseph Koeneman, Palatine, IL (US); Douglas Doughty, Mount Prospect, IL (US)

Correspondence Address: Katten Muchin Zavis;Patent Administrator, Suite 1600, 525 West Monroe Street, Chicago, IL, 60661-3693, US

(21) Appl. No.: 10/432,567

(22) PCT Filed: Nov. 27, 2001
(86) PCT No.: PCT/US01/44736

Related U.S. Application Data
(60) Provisional application No. 60/253,689, filed on Nov. 28, 2000.

(51) Int. Cl. G06F 17/60

(52) U.S. Cl. 705/28

(57) ABSTRACT

An integrated parts location and transaction system for original equipment manufacturer (OEM), non-OEM as well as aftermarket automobile parts is adapted to be integrated with business management computer system (BMS) software, currently used by automobile dealerships (210) as well as repair shops. All participating parts suppliers, including dealerships (210), and repair shops are networked together, for example, over a combination of public and private communication networks to enable participating parts suppliers and potential buyers (for example, dealers and repair shops) to easily and quickly locate as well as buy and sell parts from each other.

### CROSS REFERENCE TO RELATED APPLICATIONS

This application claims priority and the benefit of U.S. provisional application Ser. No. 60/253,689, filed on Nov. 28, 2000.

### COMPUTER LISTING APPENDIX

This application includes a Computer Listing Appendix on compact disc, hereby incorporated by reference.

### BACKGROUND OF THE INVENTION

1. Field of the Invention

The present invention relates to an on-line parts location and transaction system which may be integrated directly into more comprehensive general business computer systems of target users, such as those, for example, in automobile dealerships and repair shops (collectively, “Business Management Systems”), to provide a virtual network which enables parts to be located, bought and sold on-line, quickly and efficiently from the various members in the network.

2. Description of the Prior Art

Automobile parts suppliers, such as those who carry OEM, aftermarket (non-OEM), recycled or mechanical parts, stock such parts in inventory for potential resale to various buyers, such as automotive dealers, repair facilities, and consumers. These parts are normally tracked by way of various computerized inventory systems, generally referred to as Business Management Systems (BMS). Various companies are known to provide software for one or more of the functions performed by the BMS, such as, The Reynolds and Reynolds Company, CCC Information Services Inc. and the Dealer Services and claims Solutions Group of Automatic Data Processing Inc.

Such BMS (also known as Dealer Management Systems) are used at various automobile dealerships and repair facilities for creating electronic service orders for the repair work to be performed. Essentially, data regarding the vehicle owner and vehicle, as well as the service to be performed, is input by a service technician into the DMS. The DMS assembles the data and prints a work order that is normally signed by the vehicle owner to authorize the repairs.

If the requested service requires parts, the service technician contacts the parts department personnel to ascertain whether the parts are available in stock at the dealership. If not, the parts personnel contacts other potential suppliers. This task can be quite cumbersome and time consuming, depending upon the availability of the particular parts in the service area. Once the parts personnel locates the desired part, the parts personnel then has to prepare the necessary paperwork to purchase the part from another dealership or other supplier.

The practice of locating and buying the required parts is quite cumbersome and requires a lot of time by either the service technicians or parts personnel, as the case may be. Thus, there is a need for a system which simplifies the location of vehicle parts and reduces the amount of time service technicians and other personnel must spend on this task.

### SUMMARY OF THE INVENTION

Briefly, the present invention relates to an on-line parts location and transaction system, which may be used for original equipment manufacturer (OEM), non-OEM, as well as recycled automobile parts. The on-line parts location and transaction system in accordance with the present invention is adapted to be integrated with existing or legacy BMS software, currently used by automotive dealerships, as well as repair shops. All participating suppliers and vehicle repair shops are networked together, for example, over a combination of public and private communications networks, to enable participating parts suppliers and buyers to easily and quickly locate, as well as, buy and sell parts over a public or private communications network. The system has the capability of maintaining a central database of regularly-updated parts inventories for all participants.

### DESCRIPTION OF THE DRAWINGS

These and other advantages of the present invention will be readily understood from the following specification and attached drawing wherein:

FIG. 1 is a generalized block diagram of the on-line parts location and transaction system in accordance with the present invention.

FIG. 2 is a simplified system level process flow diagram for the on-line parts location and transaction system in accordance with the present invention.

FIG. 3 is a system level logical process flow diagram of the on-line parts location and transaction system in accordance with the present invention.

FIGS. 4A and 4B are exemplary network architecture diagrams illustrating various exemplary network implementations for connecting dealerships to the on-line parts location and transaction system in accordance with the present invention.

FIG. 5 is a network architecture diagram for the system in accordance with the present invention illustrating various communication networks between the dealerships and the system.

FIG. 6 illustrates a communication architecture between a dealership and the system utilizing a virtual private network (VPN).

FIG. 7 is similar to FIG. 5 but for a restricted access network.

FIG. 8 is similar to FIG. 5 but shown utilizing a secure socket layer (SSL).

FIG. 9 is similar to FIG. 5 but for a managed network.

FIG. 10 is a network architecture diagram of the central office portion of the on-line transaction parts location and transaction system in accordance with the present invention.

### DETAILED DESCRIPTION

The system in accordance with the present invention relates to an on-line parts location and transaction system that, in one embodiment, is adapted to be integrated with existing or legacy BMS systems, such as dealer management systems (DMS), for example, used in automobile dealerships. Examples of various DMS systems utilized in automobile dealerships and repair shops are available by Automatic Data Processing, Inc.; The Reynolds and Reynolds Company; and CCC Information Services Inc.

The on-line parts location and transaction system in accordance with the present invention is adapted to connect various automobile parts suppliers (including automobile dealers), for example, over a combination of public and private communication networks, such as the Internet, dial-up modem, managed private access or broadband, to provide a virtual network of parts suppliers to enable vehicle parts to be located on-line quickly and efficiently and to facilitate electronic buying and selling of automobile parts by participants connected to a the virtual trading network.

Although the system is discussed in terms of vehicle dealerships, such as automobile dealerships, known to utilize original equipment manufacture (OEM) parts, the system can be readily adapted for use by repair facilities, other than dealerships, and for location and transactions of other types of automobile parts as well. For example, the system can be used with non-OEM parts as well as recycled parts.

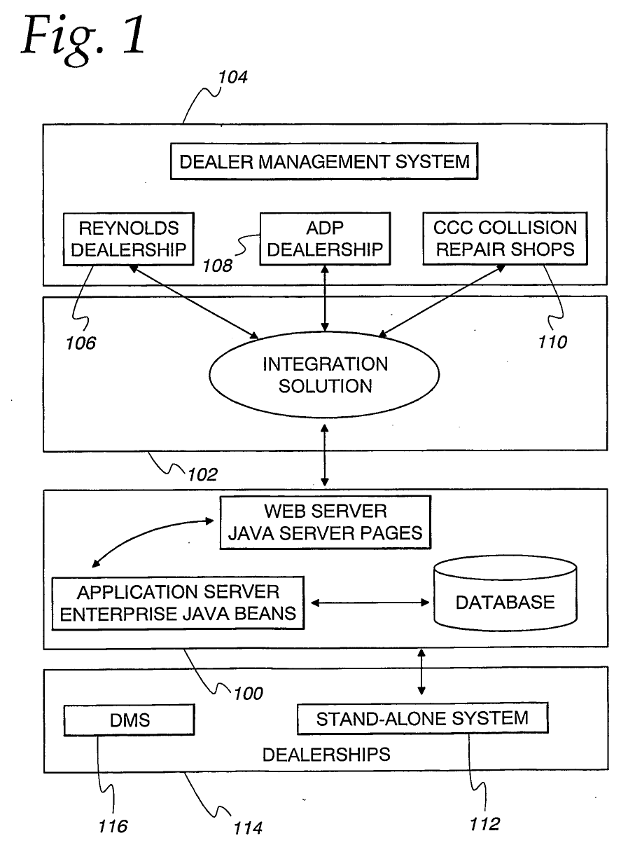

An overview of the on-line parts location and transaction system, generally identified with the reference numeral 100, is illustrated in FIG. 1. In one embodiment of the invention, the on-line parts location and transaction system 100 is adapted to integrate various legacy DMS, used, for example, at various automobile dealerships to eliminate the problems heretofore associated with the stand-alone DMS, used primarily for generating work orders for vehicle repair work. In accordance with an important aspect of the invention, the on-line parts location and transaction system 100 provides a virtual inventory of vehicle parts, that in one embodiment, is accessible via integration into the legacy DMS system to enable any required vehicle parts to be ordered and supplied by any of the various members in the network, directly from the DMS software application. More specifically, the on-line parts location and transaction system 100 checks the requesting automobile dealership's inventory for the requested vehicle parts, as well as searches for the requested parts in the parts inventories of the participating dealerships. The on-line parts location and transaction system 100 returns search results in one or more of the following exemplary categories: requesting dealers own parts inventory; preferred supplier inventory; or all dealers within the network. The requesting dealer then is provided with an opportunity to select the source for the requested parts. If the requested parts are available in the requesting dealers own parts inventory, the parts requirements may be filled from the dealer's own inventory. Should one or more of the existing parts not be available from the requesting dealers own parts inventory, the requesting dealer can place an order on line for one or more of the requested parts from one or more of the sources indicated in the search results via integration with the DMS application. In particular, the on-line parts location and ordering system 100 can be used to prepare purchase orders and electronically transmit those purchase orders to participating parts suppliers, for example, other automobile dealerships, participating in the system 100. The orders from the requesting dealerships appear as alerts on the selling dealership's DMS. In response to a request for parts, the participating selling dealership is provided with several options within their integrated DMS, for example; accepting the order, declining the order and placing the order on review status. If the participating selling dealership accepts the order, the on-line parts location and transaction system 100 notifies the requesting dealership and automatically adjusts the on-line inventory of the selling dealership. If the order is declined by the selling dealership, the requesting dealership is notified on-line. This option provides a selling dealership with the opportunity to choose whether or not to sell the parts to the requesting dealership for the selling dealership's own business reasons. Alternately, the order can be put the order on review status, which automatically indicates to the requesting dealership that the order is being considered.

In addition to parts location and transactions, the on-line parts location and transaction system 100 may provide additional functionality beyond parts location and transactions. For example, the on-line parts location and transaction system 100 may be used to obtain parts pricing. Other optional functionality includes key-cut data; business profile data and business searches.

As described above, the on-line parts location and transaction system 100, in one embodiment of the invention, is configured as an integrated solution 102, (FIG. 1) that is integrated directly into the legacy DMS 104, available at participating dealerships and collision repair shops, 106, 108 and 110, respectively. Alternatively, the on-line parts location and transaction system 100 can be used as a stand-alone system 112 at dealerships 114 which either do not include a Dealer Management System 116 or in which the on-line parts location and transaction system 100 is not integrated with the dealers legacy DMS 116. In the non-integrated embodiment, the on-line parts location and transaction system 100 operates independently of the DMS 116, either on a separate terminal or as an independent application on the same terminal. In such an embodiment, requested parts information is entered manually by the service technician into the stand-alone parts location and transaction system 112. In all other respects, the stand-alone on-line parts location and transaction system 112 operates in a similar manner as the integrated on-line parts location and transaction system 100.

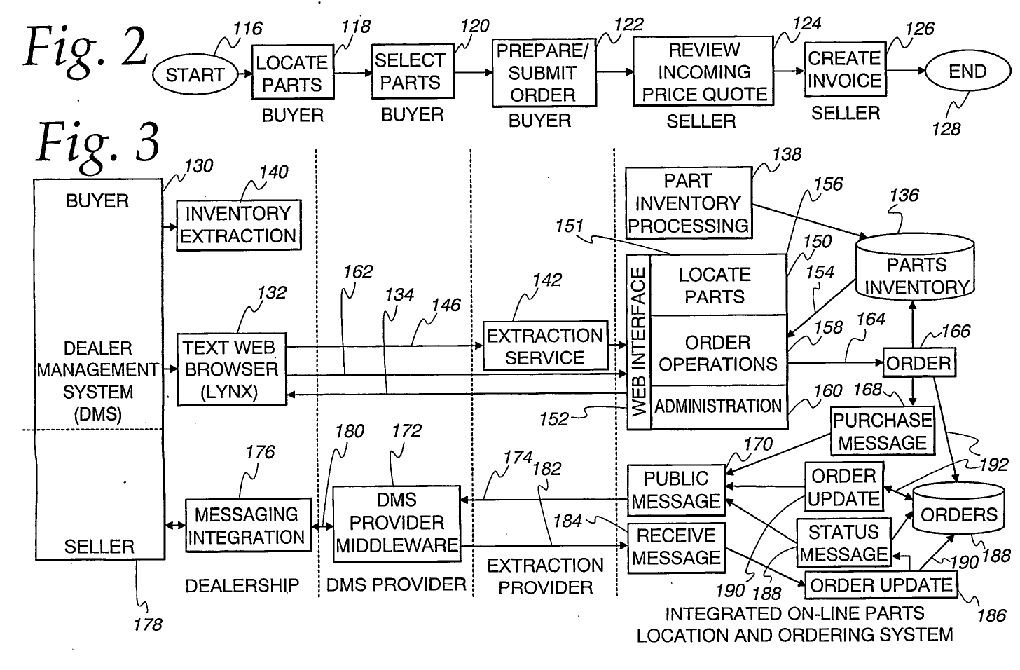

FIG. 2 is a system level process flow diagram for the on-line parts location and transaction system 100 in accordance with the present invention. As mentioned above, multiple embodiments of the on-line parts location and ordering system 100 are contemplated. The simplified system level process flow diagram illustrated in FIG. 2 applies to both embodiments.

Referring to FIG. 2, the on-line parts location and transaction system 100 is initiated in step 116 when a dealership or collision repair shop generates a work order in which vehicle parts are required. For non-integrated or stand-alone embodiments 112, the requesting buyer manually transfers the parts requirements to the parts location and transaction system 100. In an integrated embodiment 100, in which the on-line parts location and ordering system 100 is integrated into an existing DMS, a mutual transfer of the parts data is not required by service personnel. In both embodiments, the on-line parts location and transaction system 100 locates parts from participating sellers connected to the network, as indicated in step 118. As indicated above, the on-line parts location and transaction system 100 may be utilized to locate vehicle parts existing within the requesting dealers own parts inventory, preferred suppliers or other market level suppliers. After the system 100 locates the requested parts, the requesting dealership can then select the source for the parts, as indicated in step 120. If the selected parts are from other than the requesting dealers own parts inventory, the on-line parts location and transaction system 100 can be used to prepare and submit a purchase order in step 122 to the selected parts supplier.

The purchase order submitted by the system 100 to the selected parts supplier generates an alert which enables the request for parts to be reviewed in step 124. The parts selling dealership then has the option of accepting and fulfilling the order; declining the order or optionally reviewing the order at a later time. If the selected automobile dealership accepts the order for vehicle parts, an invoice is created in step 126 and returned to the requesting dealership and the system ends in step 128. The parts order may then be filled by the accepting dealership. Alternately, a selling dealership may decline the parts order, in which case the requesting dealership is notified and the requesting dealership may request parts from a different supplier and repeats steps 120 through 126 with a different supplier. Optionally, the selling dealership can select a review status in which case, the requesting dealership is notified of the same.

A more detailed system level logical flow diagram of the on-line parts location and transaction system 100 is illustrated in FIG. 3. In non-integrated, stand-alone embodiments, the functionality of the on-line parts location and transaction system 100 is accessed by a participating dealership by way of an Internet connected web browser. For implementations in which the on-line parts location and transaction system 100 is integrated with the dealer management system 130, a session is initiated by launching a web browser directly from the DMS application, as indicated by the box 132. As will be discussed in more detail below, communication between the participating dealerships and the on-line parts location and transaction system 100 is by way of the web browser interface 132 over a public communication network, such as the Internet, or a private communications network, as indicated by the line 134.

As will be discussed in more detail below, a Parts Inventory Database 136 is maintained by the on-line parts location and transaction system 100, which maintains a current parts inventory of all of the automobile dealerships and/or collision repair shops, connected to the on-line parts location and transaction system 100. The Parts Inventory Database 136 is updated by way of a Parts Inventory Processing application 138, which forms part of the on-line parts location and transaction system 100.

In an exemplary application, an Inventory Extraction Application 140, which may be integrated with the DMS 130, is used to extract inventory data from each of the dealerships, connected to the on-line parts location and transaction system 100 and transfers it to the parts inventory database 136 on a periodic basis. In one embodiment, the Inventory Extraction Application 140 may be hosted by an extraction provider, for example, an extraction service over a public or private communication channel 146. The Extraction Service Application 140 transfers the inventory data to a Part Inventory Processing application 138, hosted by the on-line parts location and transaction system 100, by way of a public or private communication channel 148, in order to update the Parts Inventory Database 136 on a periodic basis, for example, once a day or once a week as indicated by the line 150.

The Parts Inventory Database 136 is then used to supply data to a Parts and Order System 151, configured to communicate with the web browser 132, located at the dealership, by way of a web interface 152, as indicated by the line 154. The Parts and Order System 151 includes three main subsystems: a “Locate Parts” subsystem 156; an “Order Operations” subsystem 158; and an “Administration” subsystem 160. The “Locate Parts” subsystem 156 is used to satisfy dealer requests for location of parts. More particularly, the web interface 152 returns the parts location data to the requesting dealership web browser 132, as indicated by the line 162, via a private or public communication network, similar to the communication channel 134. In response to the receipt of the parts location data, the requesting dealership or buyer, by way of its web browser 132, can perform one or more order operations, which are transmitted to the Order Operations subsystem 158 by way of the web interface 152 over the communication channel 134. More specifically, the requesting dealership, by way of its web browser 132, may execute various order operations, such as: select supplier; prepare and submit a purchase order to a selected supplier; and cancel the order. These order operations are transferred from the dealership web browser 132 to the Order Operations subsystem 158 by way of the communication channel 134 and the web interface 152.

In response to an action from a requesting dealership to submit an order, the Order Operations subsystem 158 processes the order operation, as indicated by the line 164. As indicated by the box 168, a purchase message is generated by the Order Operations subsystem 158. This message is published to the selling dealers, as indicated by the box 170. The submit order message 170 is then transmitted, for example, to a middleware server 172, hosted by the Extraction Provider, over a communication channel 174 and ultimately to a Messaging Integration Application 176 at a selling dealers DMS 178 by way of a communication channel link 180. Alternately, the submit order message may be transferred directly from the Order subsystem 158 to the Messaging Integration Application 176 at the seller DMS. Should the seller accept, modify or decline an order, a message from the Messaging Integration Application 176 is directed to the receive message box 184, for example, by way of the middleware server 172, over a communication link 182, or alternately, directly from the Messaging Integration Application 176 to the receive message box 184. The received message box 184 is processed by the on-line parts location and transaction system 100 to generate an order update 186 which, in turn, causes a status message 188 to be formulated and a message 170 to be published to a requesting dealer's DMS, for example, by way of the middleware server 172 and a Messaging Integration Application (not shown) coupled to the Buyer's DMS 130.

All orders 166, as well as order updates, are stored in an Orders Database 188, as shown by the lines 190 and 192. Should a requesting dealer wish to cancel an order, a message is sent from the buyer's DMS 130 by way of the text web browser application 132 over the communications network 134 to the web interface 152 to the on-line parts location and transaction system 100. This message is sent to the Orders Database 188, which, in turn, causes an order update 190, as indicated by the line 192, to be generated. The order update is published to the seller's DMS, for example, to the Messaging Integration Application 176, interfaced to the seller's DMS, for example, by way of the middleware server 172 and the communication links 174 and 180.

The system may be configured to cause an order to expire if no action is taken by the Seller's DMS 178 within a predetermined time frame. In response to expired orders, the on-line parts location and transaction system 100 generates an order update 190 which may be published to the buyer's DMS 130 as well as the seller's DMS 130 to indicate the expired status of the order.

Exemplary Network Architecture

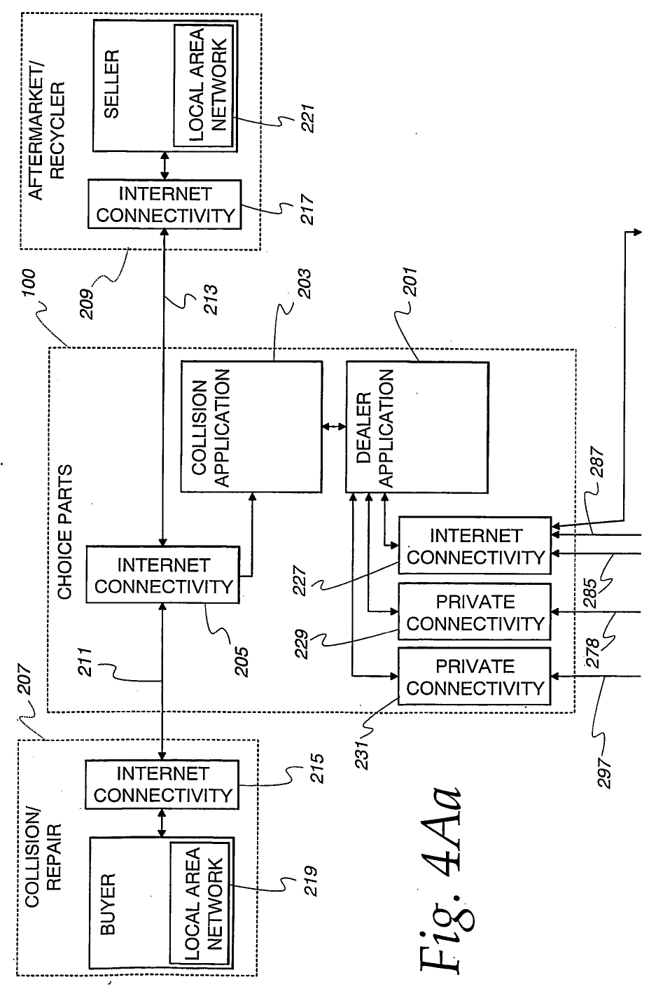

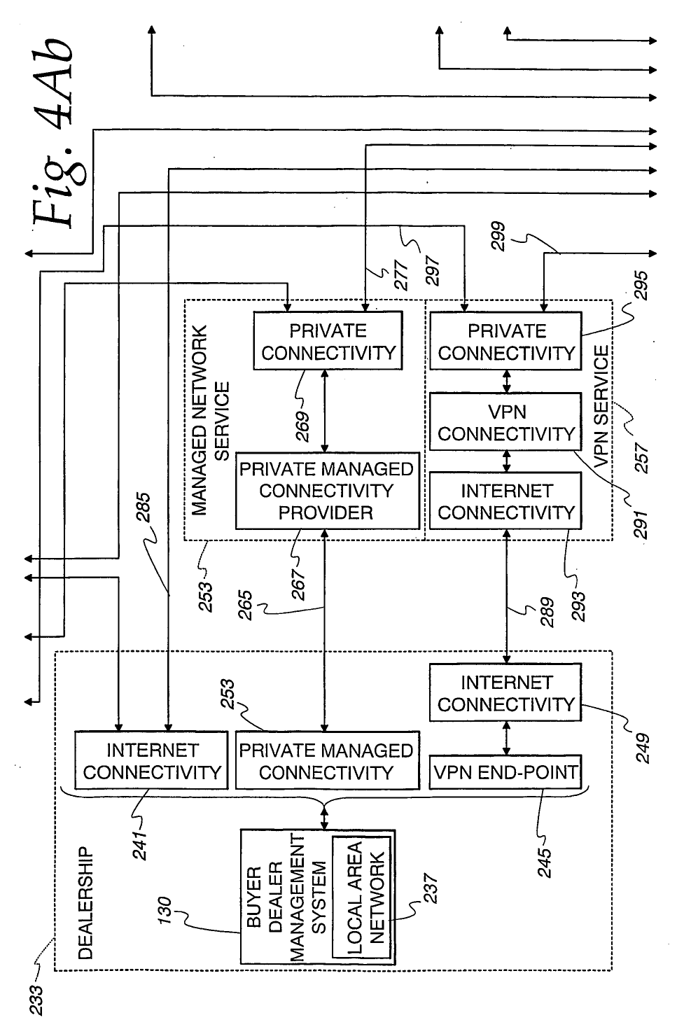

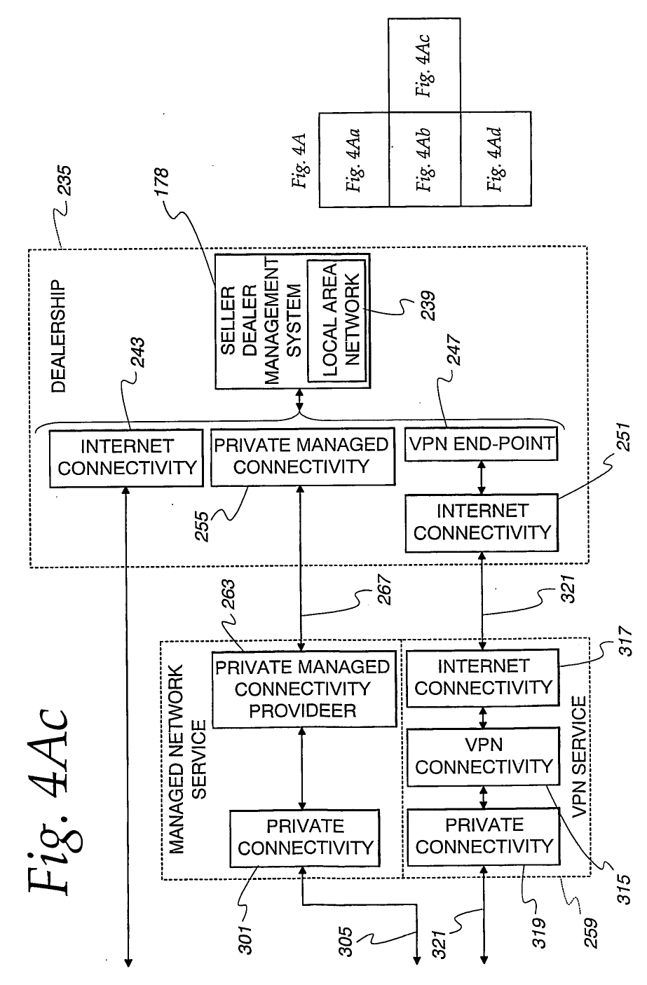

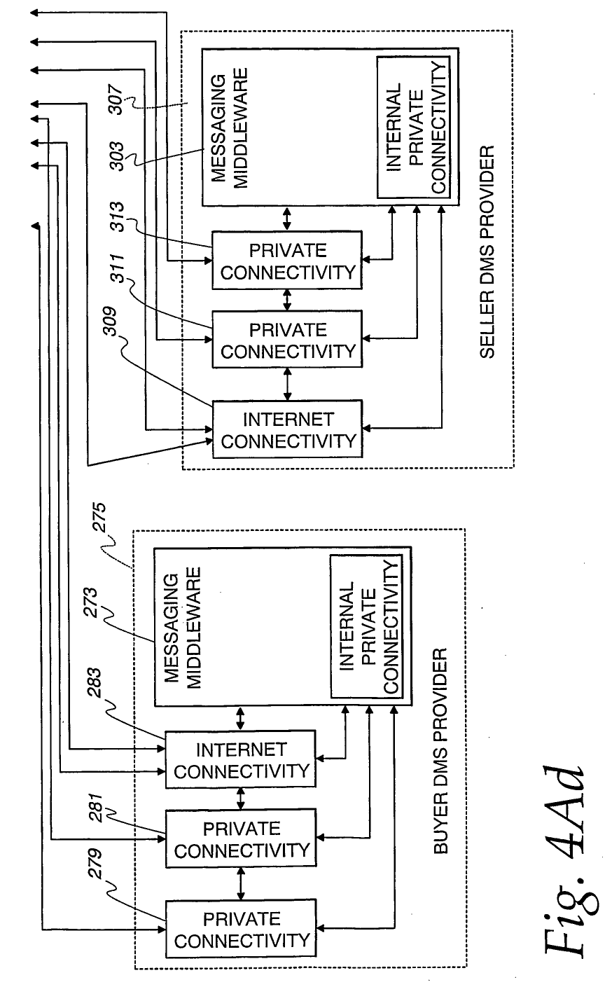

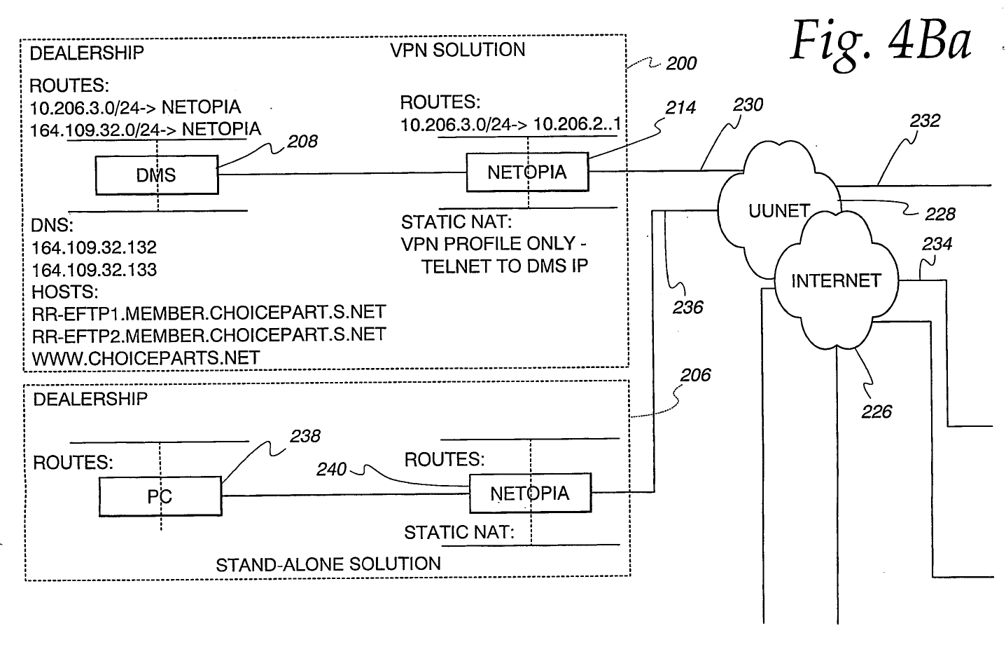

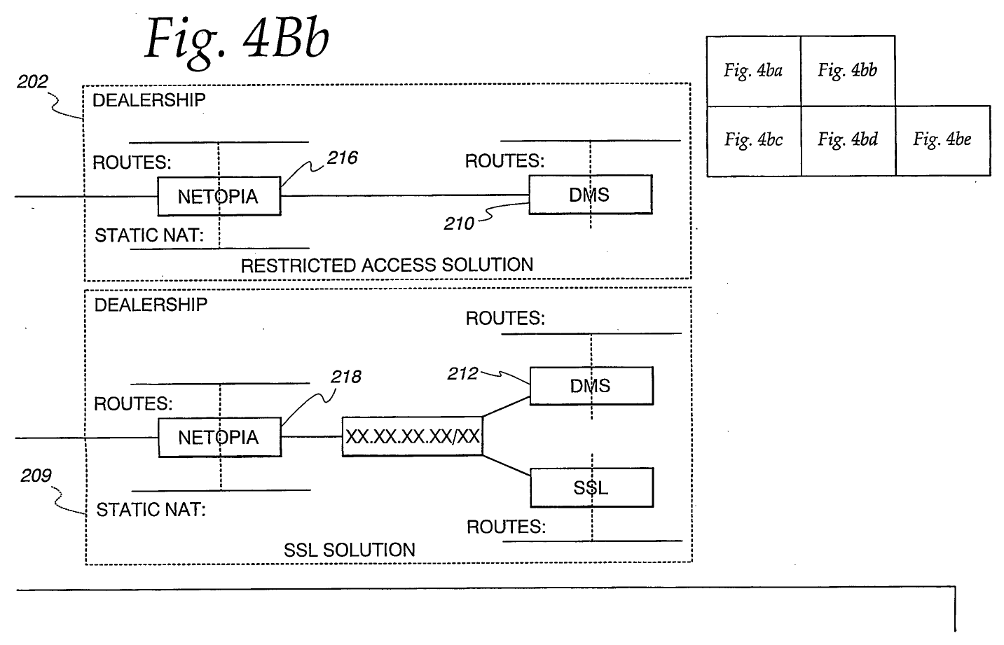

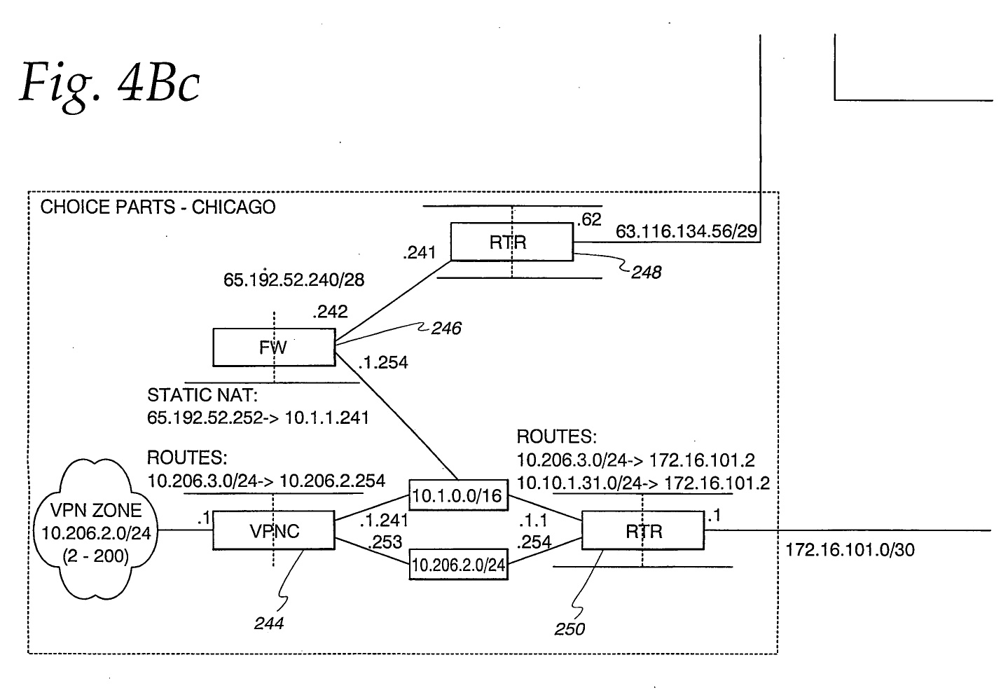

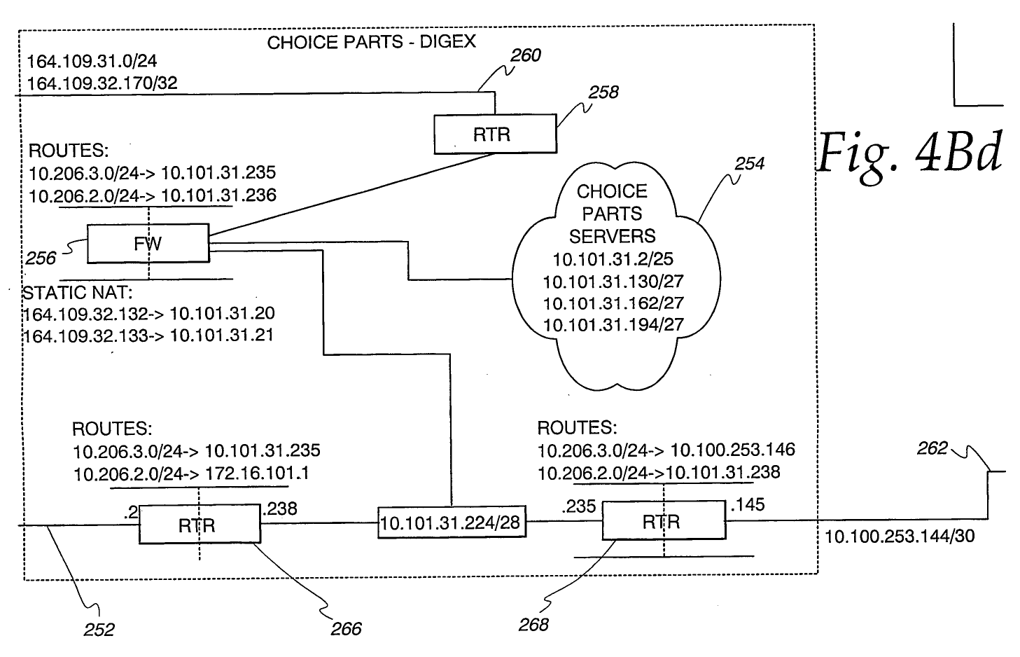

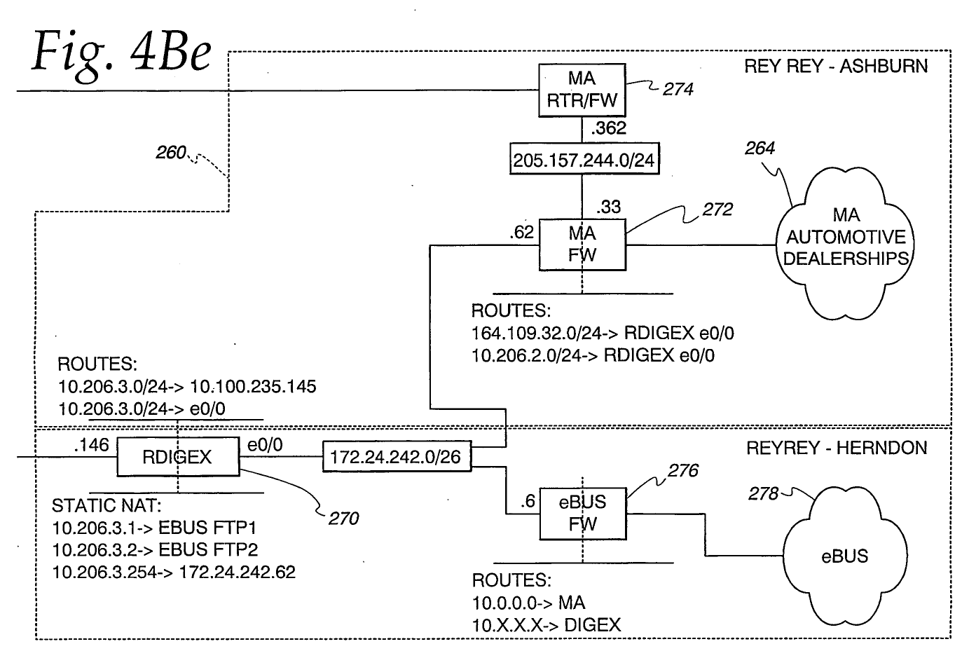

The on-line parts location and transaction system 100 in accordance with the present invention may be integrated with various DMS located at automobile dealerships in a number of different ways. FIGS. 4A and 4B illustrates various exemplary network configurations that may be used to link the on-line parts location and transaction system 100 to various dealerships. It is to be understood that the network configurations are merely exemplary and that other network configurations can be utilized and fall within the broad scope of the invention.

Referring to FIG. 4A, the on-line parts location and transaction system 100 is shown within the dashed box 100 and may include a Dealer Application 201 as well as a Collision application 203, for example, as disclosed in commonly-owned co-pending application Ser. No. 60/266,271, filed on Feb. 5, 2001, hereby incorporated by reference.

As shown, the Collision Application 203 is shown configured for Internet connectivity, as indicated by the box 205, for communicating with collision/repair shops 207 as well as aftermarket/recyclers 209, for example, over the Internet, as indicated by the lines 211 and 213 respectively. In such an application, the collision/repair shop 207 functions as a parts buyer while the aftermarket/recycler 209 functions as a parts seller. Both the collision/repair shop 207 and the aftermarket/recycler 209 are provided with, for example, Internet connectivity, as indicated by the boxes 215 and 217, respectively. The collision/repair shop 207, as well as the aftermarket/recyclers 209, may be provided with stand-alone terminals or may be part of a local area networks 219 and 221, as shown, connected to the Collision Application portion of the on-line parts location and ordering system 100 to form a virtual network of buyers and sellers which facilitates the buying or selling of parts for both buyers 207 and sellers 209.

As mentioned above, the on-line parts location and transaction system 100 also includes a Dealer Application 201 for connection to various automobile dealerships, for example, by way of a combination of public and private communication networks and is thus configured for both Internet connectivity and private connectivity as indicated by the boxes 227, 229 and 231.

As discussed above and as will be discussed in more detail below, the Dealer Application 201 and participating dealerships 233 and 235 provide a virtual network for locating parts and facilitating the buying and selling of such parts. In accordance with an important aspect of the invention, the parts location and transaction system 100 is configured in one embodiment to be integrated with the existing or legacy dealer management system applications 130 and 178, which may be hosted by stand alone terminals or local area networks 237 and 239, respectively, as shown.

The participating dealerships 233 and 235 are configured to communicate over the network 100 over the Internet directly, as indicated by the boxes 241 and 243, as well as by way of a virtual private network (VPN) tunnel and thus may include VPN end points 245 and 247, as well as Internet connectivity, as indicated by the boxes 249 and 251. The participating dealerships 233 and 235 may also be configured for private managed connectivity, as indicated by the boxes 253 and 255.

Messaging between the Dealer Application 201 and the buyer and seller dealer management systems 130 and 178, respectively, may be by way of managed network services 253 and 255 and VPN services 257 and 259. More specifically, each managed network service 253 and 255 may be connected to a private managed connectivity provider 261, 263 by way of a leased communication line 265, 267. As shown, the managed network service 253, coupled to the buyer's dealer management system 130, is configured for private connectivity, as indicated by the box 269 for communicating with the Dealer Application 201 over a private communication line 271 and, for example, a messaging middleware server 273, hosted, for example, by the buyer DMS provider 275, by way of a private communication line 277. As shown, the DMS Provider 275 is configured for both private and Internet connectivity, as indicated by the boxes 279, 281 and 283. Bi-directional communication lines 285, 287 and 323 may also be provided between the messaging middleware server 273, and the buyer dealer management system 130 and dealer application 201, respectively.

As will be discussed in more detail below, communication between the buyer dealer management system 130 may also be over the Internet, as indicated by the line 289 to the host of the VPN service 257. The VPN service host 257 includes a VPN concentrator 291 and is configured for both Internet and private connectivity, as indicated by the boxes 293 and 295, respectively. The VPN service 257 may be coupled to the messaging middleware server 273 and the Dealer application 201 by way of the private communication lines 297 and 299.

As mentioned above, the seller dealer management system 178 may be coupled to the managed network service 255 and the VPN service 259. The managed network service 255 may be hosted by the private managed connectivity provider 263 and is configured for private connectivity, as indicated by the box 301. The managed network service 255 may be connected to a messaging middleware server 303 by way of a private communication channel 305. The messaging middleware service 303 may be hosted by a seller DMS provider 305, configured for both Internet and private connectivity, as indicated by the boxes 309, 311 and 313, respectively.

Communication between the seller dealer management system 178 and the VPN service 259 may be over the Internet, as indicated by the line 321. Communication between the VPN service 259 is by way of a leased line 325.

Referring to FIG. 4B, various exemplary methods for providing communication links between different vehicle dealerships and the on-line parts location and transaction system 100 in accordance with the present invention are illustrated in more detail including; a virtual private network (VPN) network 200; a restricted access network 202; and a secure sockets layer (SSL) network 204. The VPN network 200; restricted access network 202; and the SSL network 204 relate to embodiments in which the on-line parts location and transaction system 100 is integrated into the dealer management system at the respective automobile or vehicle dealerships.

The dashed box 206 illustrates an implementation in which the parts location and ordering system is not integrated into the dealer DMS. In this application, the stand-alone dealership 206 has access to the on-line functionality of the parts location and transaction system 100, but through a separate web browser interface. In other words in the non-integrated embodiment, the on-line parts location and transaction system 100 functionality cannot be accessed directly through the DMS application.

The integrated dealerships 200, 202 and 204 all contain pre-requisite DMS servers 208, 210 and 212, respectively. These DMS servers 208, 210 and 212 all host the DMS application and integrated text web browser 132. Each of the dealerships 200, 202 and 204 includes a router 214, 216, 218, respectively, for connecting the DMS servers 208, 210 and 212 to the network.

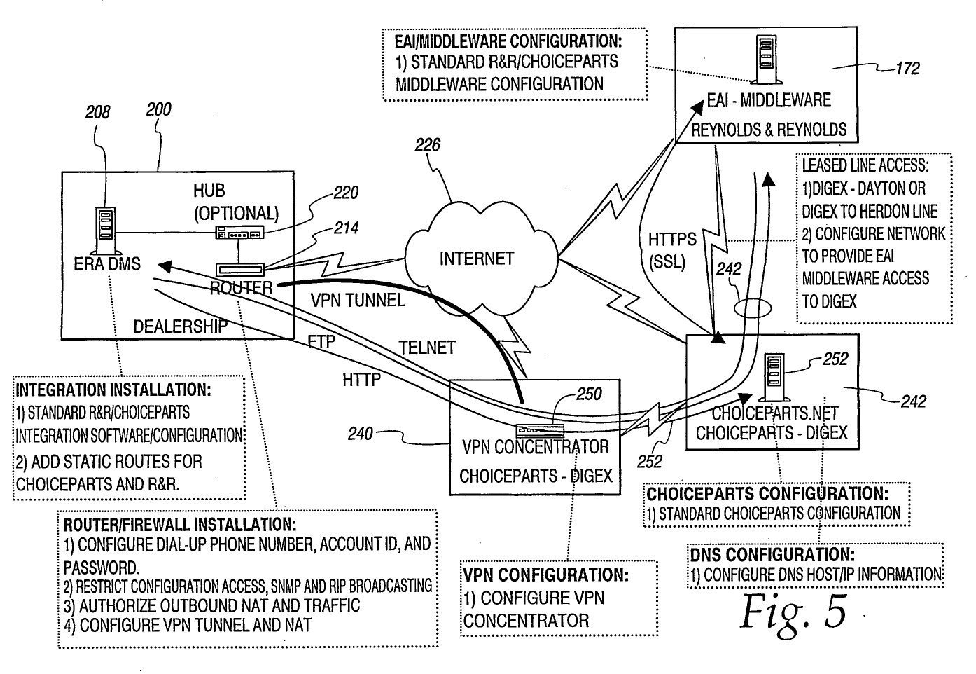

Commonly owned dealerships may include multiple DMS servers (not shown) connected to hubs 220, 222 and 224 (FIGS. 5, 6 and 7) which, in turn, are connected to the communication network by way of the routers 214, 216 and 218, respectively. As shown, each of the dealerships 200, 202, 204 and 206 are connected to the Internet 226 by way of an Internet service provider (ISP) 228, such as MCI Worldcom's UUNet, for example, by way of leased access lines 230, 232, 234 and 236, for example, T1 or DSL lines.

The stand-alone dealership 206 may include a personal computer (PC) 238 or server and a router 240. In this application the PC 238, by way of a web browser interface, is able to access the on-line parts location and transaction system 100 by way of a communication link 236 to the ISP 228, which hosts the connections to the Internet 226. In this application, the on-line parts location and transaction system 100 is not integrated into the DMS. Thus, in order to access the on-line parts location and transaction system 100, service personnel at such stand-alone dealerships 206 must switch from the DMS application and access the on-line parts location and transaction system 100 by way of a web browser or, alternatively, the web browser interface can be hosted on a separate personal computer (not shown).

The on-line parts location and transaction system 100 may consist of an administrative office 240 and a central office 242. The administrative office 240 is used primarily for administration purposes, such as verifying dealer log-ins, but may also be used to support virtual private network (VPN) connections to various dealerships. The administration office 240 may include one or more servers, 244, connected to the Internet 226 by way of a firewall 246 and a router 248. The server 244 may also be used to host VPN connections. The server 244 may be coupled to the central office 242 by way of a router 250 over a leased line 252, such as a T1 or DSL line.

The central office 242, includes one or more servers 254, connected to the Internet 226 by way of a firewall 256 and a router 258 over, for example, a leased line 260. As mentioned above, the administrative office 240 may host VPN services for automotive dealerships 264. These VPN services may hosted by the server 244 and coupled to the automotive dealerships 264 by way of a plurality of routers 266, 268, 270, by way of a firewall 272, over the leased access lines 252 and 262. As discussed above in connection with FIG. 3, inventory data may be gathered by an extraction or managed private access provider and stored in the Parts Inventory Database 136 (FIG. 3). The managed private access provider is illustrated within the dashed box 260. Connection between the managed private access provider 260 and the central office 242 may be provided by a leased line 262. The managed private access provider 260 may also be connected to the Internet 226 by way of the firewalls 272 and 274. The managed private access provider 260 may also be the dealer management system provider and may include a middleware server 172 (FIG. 3) and host other functionality and thus may include an eBus firewall 276 connected to eBus 278. For example, the middleware server 172 (FIG. 3) may reside in the DMS provider's eBusiness infrastructure, eBus 278.

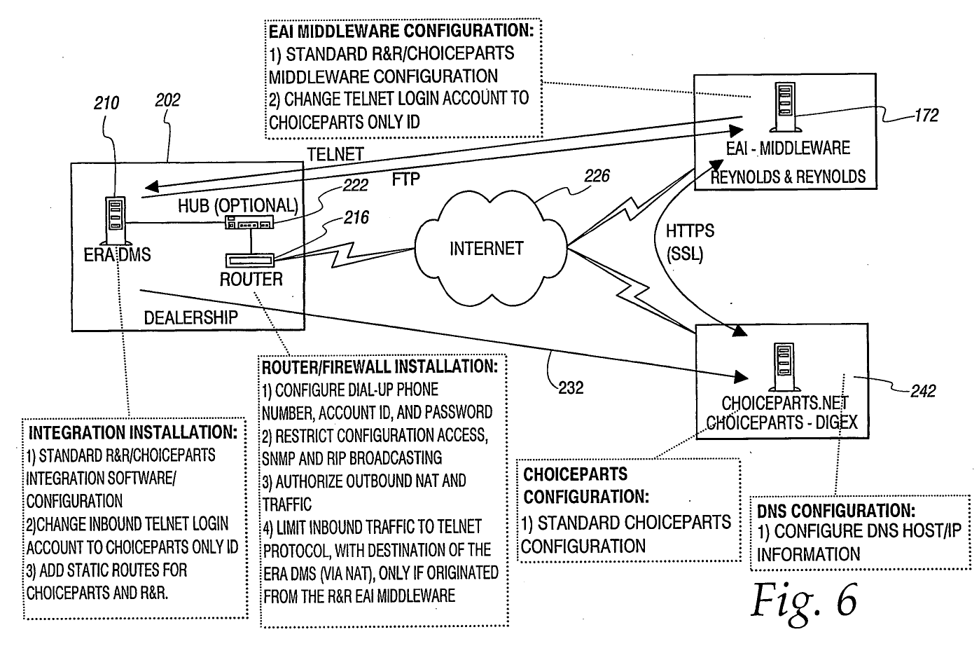

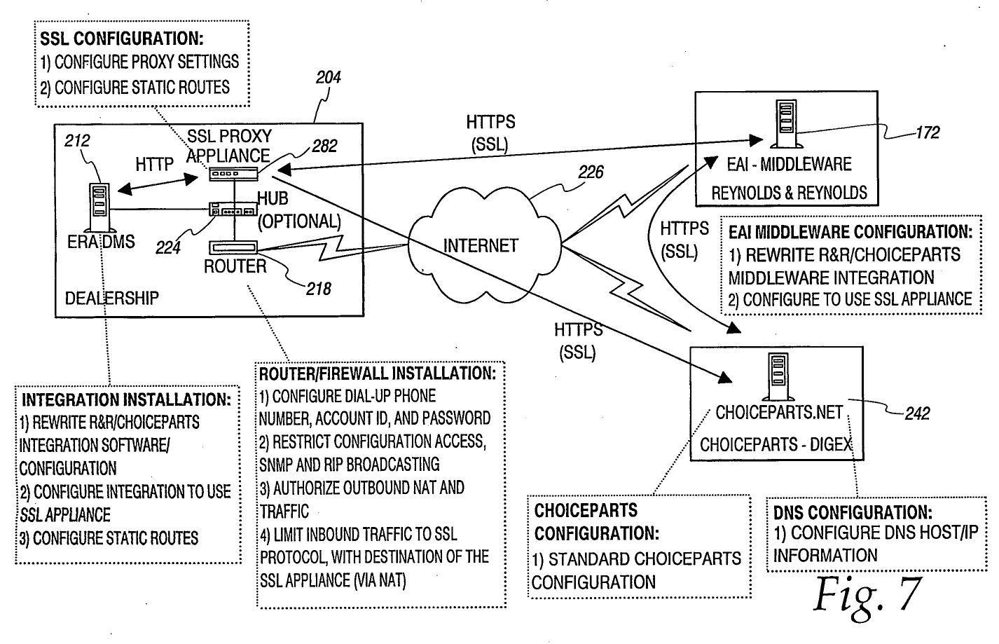

FIGS. 5, 6 and 7 illustrate the various types of network configurations for the automobile dealerships 200, 202, 204 connected to the on-line parts location and transaction system 100. In particular, FIG. 5 illustrates a VPN configuration for the dealership 200. FIG. 6 illustrates a restricted access dealership 202, while FIG. 7 illustrates an SSL configuration for the dealership 204. FIG. 8 illustrates an alternate managed network configuration.

Referring to FIG. 5, the connectivity between the dealership 200 and the on-line parts location and transaction system 100 is by way of a virtual private network (VPN). In this embodiment, communication between the dealership 200 and the administrative office 240 is by way of a VPN tunnel to a VPN concentrator 280, over, for example, a leased line. Messaging from the requesting dealership 200 is passed by way of FTP and Telnet protocol to the administrative office 240 via the central office 242 and through to a dealer management system provider 260 which includes a messaging middleware server 172. Messaging between the central office 242 and the middleware server 172 at the dealer management system provider 260 may be by way of a secure sockets layer (SSL) session over the Internet. Messages to the selling dealership are returned to the central office 242 by way of an SSL session using HTTPS protocol over the leased line 262 and to the administrative office 240 and returned to selling dealership over the VPN tunnel.

FIG. 6 illustrates the dealership 202 connected to the on-line parts location and transaction system 100 by way of a restricted access network. In this embodiment, a requesting dealership locate request is directed directly to the central office 242 by way of the Internet 226 using standard HTTP protocol. Messaging between the central office 242 and the middleware server 172 at the dealer management system provider 260 is by way of an SSL session over the Internet 226 utilizing HTTPS protocol. Messages from the middleware server 172 may be provided by way of the Internet, for example, directly to the dealership 202 utilizing Telnet and FTP protocol. The router 216 is configured to restrict access via the Telnet and FTP protocols from the middleware server 172 only.

FIG. 7 is an exemplary embodiment illustrating connection of the dealership 204 to the on-line parts location and transaction system 100 by way of SSL sessions. In this embodiment, the dealership 204 is provided with an SSL proxy appliance 283 for converting the HTTP protocol to HTTPS protocol. Locate messages are directed to the central office 242 over the Internet 226 by way of HTTPS protocol. Messaging between the central office 242 and the middleware server 172 is also established during SSL sessions utilizing HTTPS protocol. Return messaging to the dealership 204 is also accomplished over the Internet 226 during SSL sessions.

FIG. 8 illustrates another alternate configuration. In this embodiment, an automobile dealership 290 with a pre-requisite DMS server 292, engages in communications between the DMS server 292 and the middleware server 172 are by way of a managed network 294, such as a private communication network, utilizing Telnet and FTP protocol. In this embodiment, locate requests are directed from the dealership 292 to the middleware server 172 by way of the managed network 294. Locate requests are routed through the managed network and directed to the central office 242 utilizing HTTP protocol. Messaging between the central office 242 and the middleware server 172 is established over the Internet 226 by way of SSL sessions utilizing HTTPS protocol.

Central Office Hardware

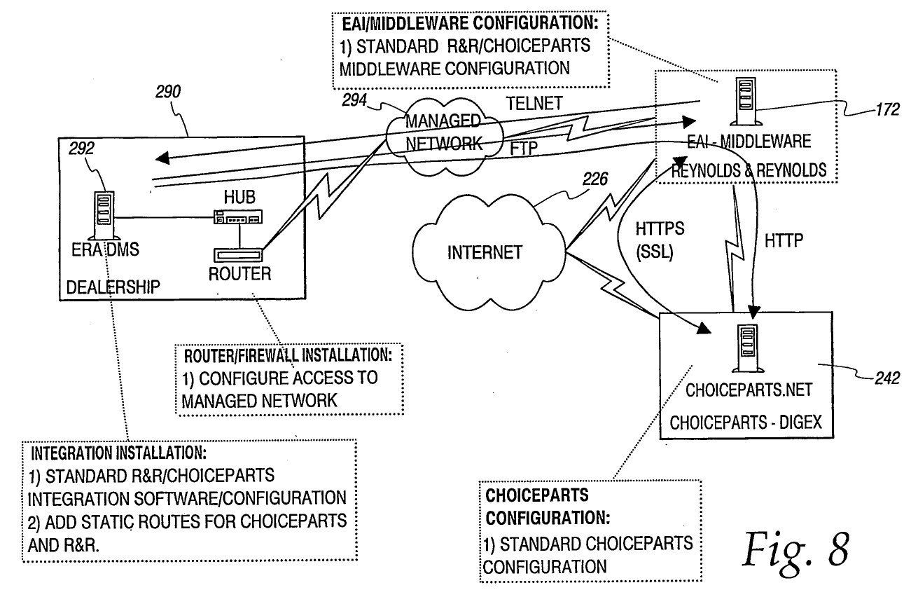

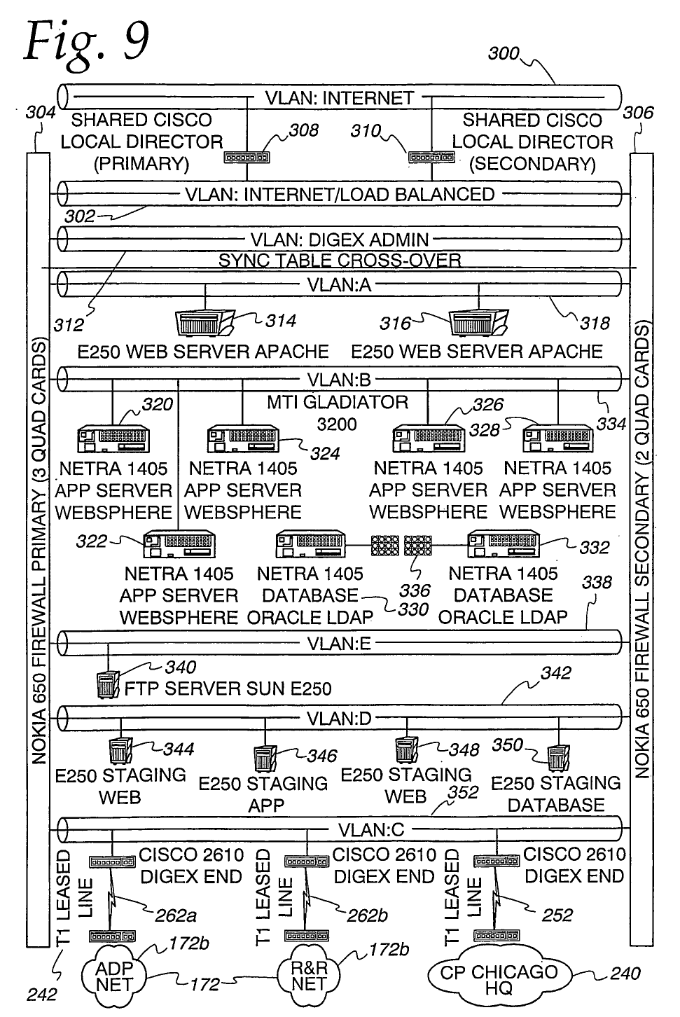

The central office 242 architecture is illustrated in FIG. 9. As shown, the central office 242 is configured as a plurality of virtual local area networks (VLAN). The VLAN:Internet 300 provides access to the central office 242. The VLAN:Internet/Load Balance 302 is connected to a pair of firewalls 304 and 306 and includes a pair of load directors 308 and 310 for balancing the load from the VLAN:Internet 300. A VLAN Administrator 312 is used for access by the system administrators of the hosting provider. The VLAN: administrator 312 is also connected to the primary and secondary firewalls 304 and 306.

Requests from the various dealerships are load balanced by the local directors 308 and 310 and are directed to a pair of web servers 314 and 316 through the primary and secondary firewalls 304 and 306. The web servers 314 and 316 form a VLAN:A, identified with the reference numeral 318. Requests from the various dealerships by way of the web browser interface 132 (FIG. 3) are passed on to one or more application servers 320, 322, 324, 326 and 328. The application servers 320, 322, 324, 326 and 328, along with a pair of database servers 330 and 332 are configured as VLAN:B 334. The parts inventory 136 table and orders table 188 (FIG. 3) are stored in a persistent storage device, such as a plurality of disk arrays 336, hosted by the database servers 330 and 332. The application servers 320, 322, 324, 326 and 328 processes requests from the dealerships and performs messaging functions which are passed back to the respective dealerships or middleware server 172 by way of the web servers 314 and 316.

As mentioned above, the on-line parts location and transaction system 100 maintains inventories of various dealerships. The inventory data may be accessed via the application servers 320, 322, 324, 326 and 328, as discussed above. A VLAN:E 318, connected to both the primary and secondary firewalls 304 and 306, includes an FTP server 340 for providing part inventory processing 138, used to update dealership inventories, as discussed above.

A VLAN:D 342 is used for staging. The VLAN:D 342 may include a staging web server 344; a staging application server 346, a staging database server 348 and a staging directory server 350. The VLAN:D 342 is used for testing applications updates and enhancements.

Lastly, a VLAN:C 352 is used to connect the various private networks of managed private access providers and/or dealer management system providers, collectively identified with the reference number 172, by way of leased lines through the firewalls 304 and 306, to the VLAN:E 338 for inventory processing as discussed above. The VLAN:E 338 is also used to connect the administrative office 240 to the central office 242.

It should be understood that the architecture for the central engine 242 is merely exemplary. Other network architectures may be suitable.

Operation

As mentioned above, the on-line parts location and transaction system may be integrated directly into a dealer management system. Alternatively, the system can be used in a stand-alone application independent of the dealer management system as discussed in detail in Appendices A and B.

Database Architecture

An exemplary architecture for the Parts Inventory and Orders databases 136 and 188 (FIG. 3) is shown below.

| | | | | Col- | Col- |
|---|---|---|---|---|---|
| | | | Column Null | umn | umn |
| Table Name | Column Name | Column Datatype | Option | Is PK | Is Fk |
| BILLING_TRANSACTION_LOG | ORDER_ID | NUMBER | NOT NULL | Yes | No |
| BILLING_TRANSACTION_LOG | MFG_ID | CHAR(2) | NOT NULL | Yes | No |
| BILLING_TRANSACTION_LOG | PART_ID | VARCHAR2(25) | NOT NULL | Yes | No |
| BILLING_TRANSACTION_LOG | TRANSACTION_DATE | DATE | NOT NULL | Yes | No |
| BILLING_TRANSACTION_LOG | QTY_TO_SHIP | NUMBER | NULL | No | No |
| BILLING_TRANSACTION_LOG | UNIT_PRICE | FLOAT(126) | NULL | No | No |
| BILLING_TRANSACTION_LOG | BUYER_CUST_ID | VARCHAR2(7) | NULL | No | No |
| BILLING_TRANSACTION_LOG | SELLER_CUST_ID | VARCHAR2(7) | NULL | No | No |
| BILLING_TRANSACTION_LOG | ORDER_STATUS_ID | VARCHAR2(20) | NULL | No | No |
| BULLETIN | PART_ID | VARCHAR2(25) | NOT NULL | Yes | No |
| BULLETIN | MFG_ID | CHAR(2) | NOT NULL | Yes | No |
| BULLETIN | BULLETIN | VARCHAR2(4000) | NULL | No | No |
| BUSINESS_TYPE | BUSINESS_TYPE_ID | VARCHAR2(20) | NOT NULL | Yes | No |
| BUSINESS_TYPE | BUSINESS_TYPE | VARCHAR2(60) | NOT NULL | No | No |
| CITY_CODE | CITY_CODE_ID | CHAR(3) | NOT NULL | Yes | No |
| CITY_CODE | CITY_CODE_DESC | VARCHAR2(60) | NOT NULL | No | No |
| CITY_CODE | COUNTRY_ID | VARCHAR2(20) | NULL | No | No |
| CITY_CODE | SORT_ORDER | NUMBER | NULL | No | No |
| CITY_CODE_DISTANCE | FROM_CITY_CODE_ID | CHAR(3) | NOT NULL | Yes | No |
| CITY_CODE_DISTANCE | TO_CITY_CODE_ID | CHAR(3) | NOT NULL | Yes | No |
| CITY_CODE_DISTANCE | DISTANCE | NUMBER | NOT NULL | No | No |
| CONNECTIVITY_TYPE | CONNECTIVITY_TYPE_ID | VARCHAR2(20) | NOT NULL | Yes | No |
| CONNECTIVITY_TYPE | CONNECTIVITY_TYPE | VARCHAR2(60) | NULL | No | No |
| CONNECTORCOMMITS | CONNECTORNAME | VARCHAR2(255) | NOT NULL | Yes | No |
| CONNECTORCOMMITS | LASTTRANSID | NUMBER | NOT NULL | Yes | No |
| COUNTRY | COUNTRY_ID | VARCHAR2(20) | NOT NULL | Yes | No |
| COUNTRY | COUNTRY | VARCHAR2(60) | NULL | No | No |
| COUNTRY | SORT_ORDER | NUMBER | NULL | No | No |
| COUNTRY_CURRENCY | COUNTRY_ID | VARCHAR2(20) | NOT NULL | Yes | No |
| COUNTRY_CURRENCY | CURRENCY_ID | VARCHAR2(20) | NOT NULL | Yes | No |
| CURRENCY | CURRENCY_ID | VARCHAR2(20) | NOT NULL | Yes | No |
| CURRENCY | CURRENCY | VARCHAR2(60) | NOT NULL | No | No |
| CURRENCY_EXCHANGE | EXCHANGE_DATE | DATE | NOT NULL | Yes | No |
| CURRENCY_EXCHANGE | CURRENCY_ID | VARCHAR2(20) | NOT NULL | Yes | No |
| CURRENCY_EXCHANGE | USD_PER_UNIT | NUMBER | NOT NULL | No | No |
| CURRENCY_EXCHANGE | UNIT_PER_USD | NUMBER | NOT NULL | No | No |
| CUSTOMER | CUST_ID | VARCHAR2(7) | NOT NULL | Yes | No |
| CUSTOMER | CUST_NAME | VARCHAR2(60) | NOT NULL | No | No |
| CUSTOMER | EPARTS_IND | CHAR(1) | NOT NULL | No | No |
| CUSTOMER | BEG_DATE | DATE | NULL | No | No |
| CUSTOMER | END_DATE | DATE | NULL | No | No |
| CUSTOMER | CUST_STATUS_ID | VARCHAR2(20) | NOT NULL | No | No |
| CUSTOMER | BUSINESS_TYPE_ID | VARCHAR2(20) | NULL | No | No |
| CUSTOMER | CITY_CODE_ID | CHAR(3) | NOT NULL | No | No |
| CUSTOMER | DFLT_MARKET_LEVEL_ID | VARCHAR2(20) | NOT NULL | No | No |
| CUSTOMER | DFLT_MFG_ID | CHAR(2) | NOT NULL | No | No |
| CUSTOMER | DFLT_SHIP_INSTR_ID | VARCHAR2(9) | NOT NULL | No | No |
| CUSTOMER | DMS_ID | VARCHAR2(20) | NULL | No | No |
| CUSTOMER | DFLT_BUYER_NUM_SELLERS_DMS | VARCHAR2(20) | NULL | No | No |
| CUSTOMER | PO_REQD_INCOMING_ORDER | CHAR(1) | NOT NULL | No | No |
| CUSTOMER | PO_REQD_OUTGOING_ORDER | CHAR(1) | NOT NULL | No | No |
| CUSTOMER | DFLT_ACCEPT_MOD_ORDER | CHAR(1) | NOT NULL | No | No |
| CUSTOMER | MEMO_REQD_OUTGOING_ORDER | CHAR(1) | NOT NULL | No | No |
| CUSTOMER | INITIALS_REQD_OUTGOING_ORDER | CHAR(1) | NOT NULL | No | No |
| CUSTOMER | SUBSCRPTN_GM_SPRINT_REPORT | CHAR(1) | NULL | No | No |
| CUSTOMER | ALLOW_DIRECT_MAIL_MKTG | CHAR(1) | NOT NULL | No | No |
| CUSTOMER | ALLOW_FAX_MKTG | CHAR(1) | NOT NULL | No | No |
| CUSTOMER | DATE_TIME_INV_LAST_UPDATE | DATE | NULL | No | No |
| CUSTOMER | EXPIRE_DURATION | NUMBER | NOT NULL | No | No |
| CUSTOMER | DUP_ORD_PREVENTION_TIME | NUMBER | NOT NULL | No | No |
| CUSTOMER | LOCAL_MKT_DISPLAY_INTERVAL | NUMBER | NOT NULL | No | No |
| CUSTOMER | OTHER_MKT_DISPLAY_INTERVAL | NUMBER | NOT NULL | No | No |
| CUSTOMER | CONNECTIVITY_TYPE_ID | VARCHAR2(20) | NULL | No | No |
| CUSTOMER | DFLT_PART_CONDITION_ID | VARCHAR2(20) | NULL | No | No |
| CUSTOMER | DIALUP_NUMBER | VARCHAR2(25) | NULL | No | No |
| CUSTOMER | DFLT_COUNTERMAN_NUM | VARCHAR2(20) | NULL | No | No |
| CUSTOMER | DNS_NAME | VARCHAR2(80) | NULL | No | No |
| CUSTOMER | DMS_STORE | VARCHAR2(20) | NULL | No | No |
| CUSTOMER | DMS_BRANCH | VARCHAR2(20) | NULL | No | No |
| CUSTOMER | EPARTS_INSTALL_DATE | DATE | NULL | No | No |
| CUSTOMER | START_BILL_DATE | DATE | NULL | No | No |
| CUSTOMER | DFLT_ALL_NOTHING_FLAG | CHAR(1) | NULL | No | No |
| CUSTOMER | ACCESS_KEY_CUT_DATA | CHAR(1) | NULL | No | No |
| CUSTOMER | PASSWORD_REQ_DMS_LOGIN_IND | CHAR(1) | NULL | No | No |
| CUSTOMER | MARKET_LEVEL_PREPOPULATION_IND | CHAR(1) | NULL | No | No |
| CUSTOMER | DFLT_COUNTERMAN_INITIALS | CHAR(3) | NULL | No | No |
| CUSTOMER | EXTERNAL_CUST_ID | VARCHAR2(20) | NULL | No | No |
| CUSTOMER_BIN_ASSOC | CUST_ID | VARCHAR2(7) | NOT NULL | Yes | No |
| CUSTOMER_BIN_ASSOC | BIN_LOCATION | VARCHAR2(20) | NOT NULL | Yes | No |
| CUSTOMER_BIN_ASSOC | PROTECT_PUBLIC_DISPLAY | CHAR(1) | NOT NULL | No | No |
| CUSTOMER_CITIES_ADVERTISED | CUST_ID | VARCHAR2(7) | NOT NULL | Yes | No |
| CUSTOMER_CITIES_ADVERTISED | CITY_CODE_ID | CHAR(3) | NOT NULL | Yes | No |
| CUSTOMER_DMS_CONVERSION | SELLER_CUST_ID | VARCHAR2(7) | NOT NULL | Yes | No |
| CUSTOMER_DMS_CONVERSION | BUYER_CUST_ID | VARCHAR2(7) | NOT NULL | Yes | No |
| CUSTOMER_DMS_CONVERSION | DFLT_BUYER_NUM_SELLERS_DMS | VARCHAR2(20) | NULL | No | No |
| CUSTOMER_DMS_CONVERSION | DFLT_COUNTERMAN_NUM | VARCHAR2(20) | NULL | No | No |
| CUSTOMER_DMS_CONVERSION | DFLT_COUNTERMAN_USER_ID | VARCHAR2(20) | NULL | No | No |
| CUSTOMER_DMS_CONVERSION | DFLT_COUNTERMAN_CUST_ID | VARCHAR2(7) | NULL | No | No |
| CUSTOMER_DMS_CONVERSION | COLLISION_BODY_SHOP_FLAG | CHAR(1) | NOT NULL | No | No |
| CUSTOMER_MARKET | CUST_ID | VARCHAR2(7) | NOT NULL | Yes | No |
| CUSTOMER_MARKET | CITY_CODE_ID | CHAR(3) | NOT NULL | Yes | No |
| CUSTOMER_MARKET | MARKET_LEVEL_ID | VARCHAR2(20) | NOT NULL | Yes | No |
| CUSTOMER_MARKET_LEVEL | BUYER_CUST_ID | VARCHAR2(7) | NOT NULL | Yes | No |
| CUSTOMER_MARKET_LEVEL | MARKET_LEVEL_ID | VARCHAR2(20) | NOT NULL | Yes | No |
| CUSTOMER_MARKET_LEVEL | DATE_LAST_UPDATED | DATE | NULL | No | No |
| CUSTOMER_MARKET_LEVEL | CUST_MARKET_LEVEL_NAME | VARCHAR2(60) | NOT NULL | No | No |
| CUSTOMER_MARKET_LEVEL | EDIT_NAME_FLAG | CHAR(1) | NOT NULL | No | No |
| CUSTOMER_MARKET_LEVEL | EDIT_MEMBERS_FLAG | CHAR(1) | NOT NULL | No | No |
| CUSTOMER_MARKET_LEVEL | PRICING_ORDER | NUMBER | NOT NULL | No | No |
| CUSTOMER_MARKET_LEVEL | DISPLAY_ORDER | NUMBER | NOT NULL | No | No |
| CUSTOMER_MARKET_LEVEL | SALES_TERMS_ID | VARCHAR2(20) | NULL | No | No |
| CUSTOMER_MARKET_MEMBER | BUYER_CUST_ID | VARCHAR2(7) | NOT NULL | Yes | No |
| CUSTOMER_MARKET_MEMBER | SELLER_CUST_ID | VARCHAR2(7) | NOT NULL | Yes | No |
| CUSTOMER_MARKET_MEMBER | MARKET_LEVEL_ID | VARCHAR2(20) | NOT NULL | Yes | No |
| CUSTOMER_MARKET_MEMBER | DATE_LAST_UPDATED | DATE | NULL | No | No |
| CUSTOMER_MARKET_PRICE | SELLER_CUST_ID | VARCHAR2(7) | NOT NULL | Yes | No |
| CUSTOMER_MARKET_PRICE | MARKET_LEVEL_ID | VARCHAR2(20) | NOT NULL | Yes | No |
| CUSTOMER_MARKET_PRICE | MFG_ID | CHAR(2) | NOT NULL | Yes | No |
| CUSTOMER_MARKET_PRICE | PRICE_BASIS_ID | VARCHAR2(20) | NULL | No | No |
| CUSTOMER_MARKET_PRICE | DATE_LAST_UPDATED | DATE | NULL | No | No |
| CUSTOMER_MARKET_PRICE | PRICE_AMOUNT | NUMBER | NULL | No | No |
| CUSTOMER_PROPAGATE | CUST_ID | VARCHAR2(7) | NOT NULL | Yes | No |
| CUSTOMER_PROPAGATE | CITY_CODE_ID | CHAR(3) | NOT NULL | No | No |
| CUSTOMER_SS_ASSOC | CUST_ID | VARCHAR2(7) | NOT NULL | Yes | No |
| CUSTOMER_SS_ASSOC | SS_ID | VARCHAR2(20) | NOT NULL | Yes | No |
| CUSTOMER_SS_ASSOC | PROTECT_PUBLIC_DISPLAY | CHAR(1) | NOT NULL | No | No |
| CUSTOMER_STATUS | CUST_STATUS_ID | VARCHAR2(20) | NOT NULL | Yes | No |
| CUSTOMER_STATUS | CUST_STATUS | VARCHAR2(60) | NOT NULL | No | No |
| DEALER_MANAGEMENT_SYSTEM | DMS_ID | VARCHAR2(20) | NOT NULL | Yes | No |
| DEALER_MANAGEMENT_SYSTEM | DMS_DESC | VARCHAR2(60) | NOT NULL | No | No |
| DEALER_MANAGEMENT_SYSTEM | INTEGRATION_FLG | CHAR(1) | NOT NULL | No | No |
| DEALER_MANAGEMENT_SYSTEM | DMS_PROVIDER_ID | VARCHAR(8) | NULL | No | No |
| DMS_MANUFACTURER_ASSOC | DMS_PROVIDER_ID | VARCHAR2(8) | NOT NULL | Yes | No |
| DMS_MANUFACTURER_ASSOC | MFG_ID | CHAR(2) | NOT NULL | Yes | No |
| DMS_MANUFACTURER_ASSOC | DMS_PROVIDER_MFG_ID | VARCHAR2(20) | NULL | No | No |
| DMS_MFG_ASSOC | DMS_ID | VARCHAR2(20) | NOT NULL | Yes | No |
| DMS_MFG_ASSOC | MFG_ID | CHAR(2) | NOT NULL | No | No |
| DMS_MFG_ASSOC | DMS_MFG_ID | VARCHAR2(20) | NOT NULL | Yes | No |
| DMS_PROVIDER | DMS_PROVIDER_ID | VARCHAR2(8) | NOT NULL | Yes | No |
| DMS_PROVIDER | DMS_PROVIDER_NAME | VARCHAR2(40) | NULL | No | No |
| DMS_PROVIDER | DMS_PROVIDER_ADDRESS | VARCHAR2(40) | NULL | No | No |
| DMS_PROVIDER | DMS_PROVIDER_CITY | VARCHAR2(30) | NULL | No | No |
| DMS_PROVIDER | DMS_PROVIDER_STATE | VARCHAR2(20) | NULL | No | No |
| DMS_PROVIDER | DMS_PROVIDER_ZIP | VARCHAR2(20) | NULL | No | No |
| DMS_PROVIDER | CONTACT_NAME | VARCHAR2(40) | NULL | No | No |
| DMS_PROVIDER | CONTACT_PHONE_NUMBER | VARCHAR2(20) | NULL | No | No |
| DMS_PROVIDER | CONTACT_MOBILE_NUMBER | VARCHAR2(20) | NULL | No | No |
| DM5_PROVIDER | CONTACT_PAGER_NUMBER | VARCHAR2(20) | NULL | No | No |
| DMS_PROVIDER | CONTACT_EMAIL_ADDRESS | VARCHAR2(40) | NULL | No | No |
| DMS_PROVIDER | PARTNER_CODE | VARCHAR2(20) | NULL | No | No |
| DMS_PROVIDER | PARTNER_URL | VARCHAR2(254) | NULL | No | No |
| DMS_PROVIDER | NOTES | VARCHAR2(254) | NULL | No | No |
| DMS_PROVIDER | PARTNER_IDENTITY | VARCHAR2(20) | NULL | No | No |
| DMS_PROVIDER | PARTNER_SHARED_SECRET | VARCHAR2(20) | NULL | No | No |
| DMS_SS_ASSOC | DMS_ID | VARCHAR2(20) | NOT NULL | Yes | No |
| DMS_SS_ASSOC | SS_ID | VARCHAR2(20) | NOT NULL | Yes | No |
| ENTERPRISE | ENTERPRISE_ID | VARCHAR2(20) | NOT NULL | Yes | No |
| ENTERPRISE | ENTERPRISE | VARCHAR2(60) | NOT NULL | No | No |
| ENTERPRISE | SORT_ORDER | NUMBER | NULL | No | No |
| ENTERPRISE_CUSTOMER | ENTERPRISE_ID | VARCHAR2(20) | NOT NULL | Yes | No |
| ENTERPRISE_CUSTOMER | CUST_ID | VARCHAR2(7) | NOT NULL | Yes | No |
| ERROR_MESSAGE | ERROR_CODE | VARCHAR2(20) | NOT NULL | Yes | No |
| ERROR_MESSAGE | SEVERITY | VARCHAR2(20) | NULL | No | No |
| ERROR_MESSAGE | SHORT_MESSAGE | VARCHAR2(75) | NOT NULL | No | No |
| ERROR_MESSAGE | DETAIL_MESSAGE | VARCHAR2(254) | NOT NULL | No | No |
| ERROR_MESSAGE | INACTIVE_FLG | CHAR(1) | NULL | No | No |
| GLOBAL_PARAMETER | GLOBAL_PARAMETER_ID | VARCHAR2(20) | NOT NULL | Yes | No |
| GLOBAL_PARAMETER | GLOBAL_PARAMETER_DESC | VARCHAR2(60) | NOT NULL | No | No |
| GLOBAL_PARAMETER | GLOBAL_PARAMETER_VALUE | VARCHAR2(254) | NOT NULL | No | No |
| INCOMING_MESSAGE_LOG | DOCUMENT_ID | VARCHAR2(38) | NOT NULL | Yes | No |
| INCOMING_MESSAGE_LOG | DMS_PROVIDER_ID | VARCHAR2(8) | NULL | No | No |
| INCOMING_MESSAGE_LOG | DOCUMENT_DATE_TIME | DATE | NULL | No | No |
| INCOMING_MESSAGE_LOG | DOCUMENT_PROCESSED_TIME_STAMP | DATE | NULL | No | No |
| INCOMING_MESSAGE_LOG | XML_DOCUMENT | LONG | NULL | No | No |
| INVLOAD_ERRMSG | ERR_MSG | VARCHAR2(80) | NOT NULL | Yes | No |
| INVLOAD_ERRMSG | TIMESTAMP | DATE | NOT NULL | Yes | No |
| KEY_CUT_DETAIL | MFG_ID | CHAR(2) | NOT NULL | Yes | No |
| KEY_CUT_DETAIL | KEY_CUT_CODE | VARCHAR2(12) | NOT NULL | Yes | No |
| KEY_CUT_DETAIL | KEY_CUT_TYPE_CODE | CHAR(1) | NOT NULL | Yes | No |
| KEY_CUT_DETAIL | UPPER_CUT_NUM | VARCHAR2(12) | NULL | No | No |
| KEY_CUT_DETAIL | LOWER_CUT_NUM | VARCHAR2(12) | NULL | No | No |
| KEY_CUT_DETAIL | KEY_CUT_HEADER_SEQUENCE | NUMBER | NULL | No | No |
| KEY_CUT_HEADER | KEY_CUT_HEADER_SEQUENCE | NUMBER | NOT NULL | Yes | No |
| KEY_CUT_HEADER | MFG_ID | CHAR(2) | NULL | No | No |
| KEY_CUT_HEADER | KEY_CUT_TYPE_CODE | CHAR(1) | NULL | No | No |
| KEY_CUT_HEADER | HIGH_KEY_CUT_CODE | VARCHAR2(12) | NULL | No | No |
| KEY_CUT_HEADER | LOW_KEY_CUT_CODE | VARCHAR2(12) | NULL | No | No |
| KEY_CUT_HEADER | VEHICLE_DESC | VARCHAR2(40) | NULL | No | No |
| KEY_CUT_HEADER | KEY_BLANK_NUM | VARCHAR2(10) | NULL | No | No |
| KEY_CUT_HEADER | KEY_BLANK_PART_NUM | VARCHAR2(15) | NULL | No | No |
| KEY_CUT_HEADER | CUTTER_MODEL_NUM | VARCHAR2(10) | NULL | No | No |
| KEY_CUT_HEADER | CAM_SET | VARCHAR2(10) | NULL | No | No |
| KEY_CUT_HEADER | KEY_BLANK_CARRIAGE | VARCHAR2(10) | NULL | No | No |
| KEY_CUT_HEADER | DECODER_SCALE | VARCHAR2(10) | NULL | No | No |
| KEY_CUT_HEADER | LEFT_RIGHT_INDICATOR | CHAR(1) | NULL | No | No |
| KEY_CUT_HEADER | REVERSE_INDICATOR | CHAR(1) | NULL | No | No |
| KEY_CUT_HEADER | NOTE_1 | VARCHAR2(60) | NULL | No | No |
| KEY_CUT_HEADER | NOTE_2 | VARCHAR2(60) | NULL | No | No |
| KEY_CUT_HEADER | NOTE_3 | VARCHAR2(60) | NULL | No | No |
| KEYS | TABLE_NAME | VARCHAR2(254) | NOT NULL | Yes | No |
| KEYS | KEY_PREFIX | VARCHAR2(30) | NULL | No | No |
| KEYS | KEY_SEQ_TYPE | CHAR(1) | NOT NULL | No | No |
| KEYS | KEY_SEQ_START | VARCHAR2(30) | NOT NULL | No | No |
| KEYS | KEY_SEQ_LENGTH | NUMBER | NOT NULL | No | No |
| KEYS | KEY_SEQ_NEXT | VARCHAR2(30) | NOT NULL | No | No |
| KEYS | KEY_SEQ_END | VARCHAR2(30) | NOT NULL | No | No |
| LOCATION | CUST_ID | VARCHAR2(7) | NOT NULL | Yes | No |
| LOCATION | LOCATION_TYPE_ID | VARCHAR2(20) | NOT NULL | Yes | No |
| LOCATION | ADDRESS_1 | VARCHAR2(40) | NULL | No | No |
| LOCATION | ADDRESS_2 | VARCHAR2(40) | NULL | No | No |
| LOCATION | CITY | VARCHAR2(30) | NULL | No | No |
| LOCATION | STATE_PROVINCE_ID | VARCHAR2(20) | NULL | No | No |
| LOCATION | POSTAL_CODE | VARCHAR2(20) | NULL | No | No |
| LOCATION | COUNTRY_ID | VARCHAR2(20) | NULL | No | No |
| LOCATION | PRIMARY_CONTACT | VARCHAR2(40) | NULL | No | No |
| LOCATION | DFLT_PARTS_MGR | VARCHAR2(40) | NULL | No | No |
| LOCATION | PHONE_1 | VARCHAR2(25) | NULL | No | No |
| LOCATION | PHONE_1_TYPE_ID | VARCHAR2(20) | NULL | No | No |
| LOCATION | PHONE_2 | VARCHAR2(25) | NULL | No | No |
| LOCATION | PHONE_2_TYPE_ID | VARCHAR2(20) | NULL | No | No |
| LOCATION | PHONE_3 | VARCHAR2(25) | NULL | No | No |
| LOCATION | PHONE_3_TYPE_ID | VARCHAR2(20) | NULL | No | No |
| LOCATION | PHONE_4 | VARCHAR2(25) | NULL | No | No |
| LOCATION | PHONE_4_TYPE_ID | VARCHAR2(20) | NULL | No | No |
| LOCATION | LANG_ID | VARCHAR2(20) | NULL | No | No |
| LOCATION | TIME_ZONE_ID | VARCHAR2(20) | NULL | No | No |
| LOCATION | DAYLIGHT_SAVINGS | CHAR(1) | NULL | No | No |
| LOCATION_TYPE | LOCATION_TYPE_ID | VARCHAR2(20) | NOT NULL | Yes | No |
| LOCATION_TYPE | LOCATION_TYPE | VARCHAR2(60) | NOT NULL | No | No |
| MANUFACTURER | MFG_ID | CHAR(2) | NOT NULL | Yes | No |
| MANUFACTURER | COUNTRY_ID | CHAR(20) | NOT NULL | No | No |
| MANUFACTURER | MFG_DESC | VARCHAR2(60) | NOT NULL | No | No |
| MANUFACTURER | KEY_CUT_DATA_INDICATOR | CHAR(1) | NULL | No | No |
| MANUFACTURER | SORT_ORDER | NUMBER | NULL | No | No |
| MANUFACTURER | DENY_VIEW | CHAR(1) | NULL | No | No |
| MANUFACTURER_CUSTOMER_ASSOC | CUST_ID | VARCHAR2(7) | NOT NULL | Yes | No |
| MANUFACTURER_CUSTOMER_ASSOC | MFG_ID | CHAR(2) | NOT NULL | Yes | No |
| MANUFACTURER_CUSTOMER_ASSOC | CUST_DMS_MFG_ID | VARCHAR2(20) | NULL | No | No |
| MANUFACTURER_CUSTOMER_ASSOC | MFG_DEALER_CODE | VARCHAR2(20) | NULL | No | No |
| MANUFACTURER_CUSTOMER_ASSOC | AUTHORIZED_VIEW_PRICE_IND | CHAR(1) | NULL | No | No |
| MANUFACTURER_CUSTOMER_ASSOC | ACCESS_MFG_VEH_OPTION | CHAR(1) | NULL | No | No |
| MANUFACTURER_CUSTOMER_ASSOC | ACCESS_MFG_PDC_INQUIRY | CHAR(1) | NULL | No | No |
| MANUFACTURER_CUSTOMER_ASSOC | ACCESS_MFG_PARTNER_INQUIRY | CHAR(1) | NULL | No | No |
| MANUFACTURER_CUSTOMER_ASSOC | ACCESS_MFG_NATIONAL_INQUIRY | CHAR(1) | NULL | No | No |
| MANUFACTURER_CUSTOMER_ASSOC | ACCESS_MFG_INVENTORY_SYSTEM | CHAR(1) | NULL | No | No |
| MARKET_LEVEL | MARKET_LEVEL_ID | VARCHAR2(20) | NOT NULL | Yes | No |
| MARKET_LEVEL | MARKET_LEVEL | VARCHAR2(60) | NOT NULL | No | No |
| MARKET_LEVEL | DFLT_EDIT_NAME_FLAG | CHAR(1) | NULL | No | No |
| MARKET_LEVEL | DFLT_EDIT_MEMBERS_FLAG | CHAR(1) | NULL | No | No |
| MARKET_LEVEL | DFLT_PRICING_ORDER | NUMBER | NULL | No | No |
| MARKET_LEVEL | DFLT_DISPLAY_ORDER | NUMBER | NULL | No | No |
| MARKET_LEVEL | DFLT_SALES_TERMS_ID | VARCHAR2(20) | NULL | No | No |
| MESSAGE_QUEUE | MESSAGE_ID | NUMBER | NOT NULL | Yes | No |
| MESSAGE_QUEUE | DMS_PROVIDER_ID | VARCHAR2(8) | NOT NULL | No | No |
| MESSAGE_QUEUE | MESSAGE_TIME_STAMP | DATE | NULL | No | No |
| MESSAGE_QUEUE | EXPIRATION_TIME_STAMP | DATE | NULL | No | No |
| MESSAGE_QUEUE | ORDER_ID | NUMBER | NULL | No | No |
| MESSAGE_QUEUE | ORDER_TIME_STAMP | DATE | NULL | No | No |
| MESSAGE_QUEUE | ATTEMPT_COUNT | NUMBER | NULL | No | No |
| MESSAGE_QUEUE | MESSAGE_STATUS | VARCHAR2(10) | NULL | No | No |
| MESSAGE_QUEUE | LAST_RETRY_TIME_STAMP | DATE | NULL | No | No |
| MESSAGE_QUEUE | MESSAGE_DIRECTION_INDICATOR | CHAR(1) | NULL | No | No |
| MESSAGE_QUEUE | XML_DOCUMENT | LONG | NULL | No | No |
| MESSAGE_QUEUE | PUBLISH_EXCEPTION | VARCHAR2(1000) | NULL | No | No |
| MESSAGE_QUEUE | RESPONSE_TIME_STAMP | DATE | NULL | No | No |
| MESSAGE_QUEUE | RESPONSE_XML_DOCUMENT | VARCHAR2(4000) | NULL | No | No |
| NATIVE_LANGUAGE | LANG_ID | VARCHAR2(20) | NOT NULL | Yes | No |
| NATIVE_LANGUAGE | NATIVE_LANG | VARCHAR2(60) | NOT NULL | No | No |
| NOTE_LOG | ORDER_ID | NUMBER | NOT NULL | Yes | No |
| NOTE_LOG | NOTE_LOG | VARCHAR2(4000) | NULL | No | No |
| NOTE_LOG_DETAIL | ORDER_ID | NUMBER | NOT NULL | Yes | No |
| NOTE_LOG_DETAIL | NOTE_LOG | VARCHAR2(4000) | NULL | No | No |
| NOTE_LOG_DETAIL | NOTE_ENTRY_TIME_STAMP | DATE | NOT NULL | Yes | No |
| NOTE_LOG_DETAIL | USER_ID | VARCHAR2(20) | NOT NULL | No | No |
| NOTE_LOG_DETAIL | CUST_ID | VARCHAR2(7) | NOT NULL | No | No |
| ORDER_DETAIL | ORDER_ID | NUMBER | NOT NULL | Yes | No |
| ORDER_DETAIL | ITEM_ID | NUMBER | NOT NULL | Yes | No |
| ORDER_DETAIL | MFG_ID | CHAR(2) | NOT NULL | No | No |
| ORDER_DETAIL | PART_ID | VARCHAR2(25) | NOT NULL | No | No |
| ORDER_DETAIL | QTY_ON_HAND | NUMBER | NULL | No | No |
| ORDER_DETAIL | QTY_ON_ORDER | NUMBER | NOT NULL | No | No |
| ORDER_DETAIL | QTY_TO_SHIP | NUMBER | NULL | No | No |
| ORDER_DETAIL | UNIT_PRICE | FLOAT(126) | NULL | No | No |
| ORDER_DETAIL | BIN_LOCATION | VARCHAR2(20) | NULL | No | No |
| ORDER_DETAIL | MEMO | VARCHAR2(20) | NULL | No | No |
| ORDER_DETAIL | LOCATE_PART_QTY | NUMBER | NULL | No | No |
| ORDER_DETAIL | DMS_DESCRIPTION | VARCHAR2(60) | NULL | No | No |
| ORDER_DETAIL | QTY_VERIFIED | NUMBER | NULL | No | No |
| ORDER_DETAIL_HISTORY | ORDER_ID | NUMBER | NOT NULL | Yes | No |
| ORDER_DETAIL_HISTORY | ITEM_ID | NUMBER | NOT NULL | Yes | No |
| ORDER_DETAIL_HISTORY | DATE_LAST_UPDATED | DATE | NOT NULL | Yes | No |
| ORDER_DETAIL_HISTORY | MFG_ID | CHAR(2) | NOT NULL | No | No |
| ORDER_DETAIL_HISTORY | PART_ID | VARCHAR2(25) | NOT NULL | No | No |
| ORDER_DETAIL_HISTORY | QTY_ON_HAND | NUMBER | NULL | No | No |
| ORDER_DETAIL_HISTORY | QTY_ON_ORDER | NUMBER | NOT NULL | No | No |
| ORDER_DETAIL_HISTORY | QTY_TO_SHIP | NUMBER | NULL | No | No |
| ORDER_DETAIL_HISTORY | UNIT_PRICE | FLOAT(126) | NULL | No | No |
| ORDER_DETAIL_HISTORY | BIN_LOCATION | VARCHAR2(20) | NULL | No | No |
| ORDER_DETAIL_HISTORY | MEMO | VARCHAR2(20) | NULL | No | No |
| ORDER_HEADER | ORDER_ID | NUMBER | NOT NULL | Yes | No |
| ORDER_HEADER | ORDER_STATUS_ID | VARCHAR2(20) | NOT NULL | No | No |
| ORDER_HEADER | BUYER_CUST_ID | VARCHAR2(7) | NOT NULL | No | No |
| ORDER_HEADER | BUYER_USER_ID | VARCHAR2(20) | NOT NULL | No | No |
| ORDER_HEADER | SELLER_CUST_ID | VARCHAR2(7) | NOT NULL | No | No |
| ORDER_HEADER | SELLER_USER_ID | VARCHAR2(20) | NULL | No | No |
| ORDER_HEADER | CREATE_DATE | DATE | NOT NULL | No | No |
| ORDER_HEADER | DATE_LAST_UPDATED | DATE | NOT NULL | No | No |
| ORDER_HEADER | ACCEPT_MODIFIED_ORDER_IND | CHAR(1) | NOT NULL | No | No |
| ORDER_HEADER | SHIP_INSTR_ID | VARCHAR2(9) | NOT NULL | No | No |
| ORDER_HEADER | ORIGINAL_SHIP_INSTR_ID | VARCHAR2(9) | NOT NULL | No | No |
| ORDER_HEADER | PURCHASE_ORDER_NUM | VARCHAR2(30) | NULL | No | No |
| ORDER_HEADER | REQUESTORS_INITIALS | CHAR(3) | NOT NULL | No | No |
| ORDER_HEADER | ORDER_TOTAL_AMT | FLOAT(126) | NULL | No | No |
| ORDER_HEADER | TRANSACTION_FEE | FLOAT(126) | NULL | No | No |
| ORDER_HEADER | DMS_INVOICE_NUM | VARCHAR2(20) | NULL | No | No |
| ORDER_HEADER | ORDER_EXPIRED_DATE_TIME | DATE | NULL | No | No |
| ORDER_HEADER | SYSTEM_EXPIRE_DATE_TIME | DATE | NULL | No | No |
| ORDER_HEADER | BUYER_DISPLAY_END_DATE_TIME | DATE | NULL | No | No |
| ORDER_HEADER | SELLER_DISPLAY_END_DATE_TIME | DATE | NULL | No | No |
| ORDER_HEADER | NOTES | VARCHAR2(55) | NULL | No | No |
| ORDER_HEADER | LOCATE_MARKET_LEVEL_ID | VARCHAR2(20) | NULL | No | No |
| ORDER_HEADER | LOCATE_PART_CONDITION_ID | VARCHAR2(20) | NULL | No | No |
| ORDER_HEADER | LOCATE_ALL_NOTHING_FLAG | CHAR(1) | NULL | No | No |
| ORDER_HEADER | SELLERS_INITIALS | CHAR(3) | NULL | No | No |
| ORDER_HEADER | NOTE_ONLY_FLAG | CHAR(1) | NOT NULL | No | No |
| ORDER_HEADER | LAST_NOTE_UPDATE_CUST_ID | VARCHAR2(7) | NULL | No | No |
| ORDER_HEADER | CARST_PART_VENDOR_ORDER_ID | NUMBER | NULL | No | No |
| ORDER_HEADER | LONG_NOTE | LONG | NULL | No | No |
| ORDER_HEADER_HISTORY | ORDER_ID | NUMBER | NOT NULL | Yes | No |
| ORDER_HEADER_HISTORY | DATE_LAST_UPDATED | DATE | NOT NULL | Yes | No |
| ORDER_HEADER_HISTORY | ORDER_STATUS_ID | VARCHAR2(20) | NOT NULL | No | No |
| ORDER_HEADER_HISTORY | BUYER_CUST_ID | VARCHAR2(7) | NOT NULL | No | No |
| ORDER_HEADER_HISTORY | BUYER_USER_ID | VARCHAR2(20) | NOT NULL | No | No |
| ORDER_HEADER_HISTORY | SELLER_CUST_ID | VARCHAR2(7) | NOT NULL | No | No |
| ORDER_HEADER_HISTORY | SELLER_USER_ID | VARCHAR2(20) | NULL | No | No |
| ORDER_HEADER_HISTORY | CREATE_DATE | DATE | NOT NULL | No | No |
| ORDER_HEADER_HISTORY | ACCEPT_MODIFIED_ORDER_IND | CHAR(1) | NOT NULL | No | No |
| ORDER_HEADER_HISTORY | SHIP_INSTR_ID | VARCHAR2(9) | NOT NULL | No | No |
| ORDER_HEADER_HISTORY | ORIGINAL_SHIP_INSTR_ID | VARCHAR2(9) | NOT NULL | No | No |
| ORDER_HEADER_HISTORY | PURCHASE_ORDER_NUM | VARCHAR2(30) | NULL | No | No |
| ORDER_HEADER_HISTORY | REQUESTORS_INITIALS | CHAR(3) | NOT NULL | No | No |
| ORDER_HEADER_HISTORY | ORDER_TOTAL_AMT | FLOAT(126) | NULL | No | No |
| ORDER_HEADER_HISTORY | TRANSACTION_FEE | FLOAT(126) | NULL | No | No |
| ORDER_HEADER_HISTORY | DMS_INVOICE_NUM | VARCHAR2(20) | NULL | No | No |
| ORDER_HEADER_HISTORY | NOTES | VARCHAR2(55) | NULL | No | No |
| ORDER_HEADER_HISTORY | SELLERS_INITIALS | CHAR(3) | NULL | No | No |
| ORDER_STATUS | ORDER_STATUS_ID | VARCHAR2(20) | NOT NULL | Yes | No |
| ORDER_STATUS | ORDER_STATUS | VARCHAR2(60) | NOT NULL | No | No |
| ORDER_STATUS | FINAL_STATUS_FLG | CHAR(1) | NOT NULL | No | No |
| ORIGINATING_SOURCE_CO_CUST | SOURCE_COMPANY_ID | VARCHAR2(20) | NOT NULL | Yes | No |
| ORIGINATING_SOURCE_CO_CUST | CUST_ID | VARCHAR2(7) | NOT NULL | Yes | No |
| ORIGINATING_SOURCE_CO_CUST | SOURCE_COMPANY_CUST_ID | VARCHAR2(20) | NOT NULL | No | No |
| ORIGINATING_SOURCE_COMPANY | SOURCE_COMPANY_ID | VARCHAR2(20) | NOT NULL | Yes | No |
| ORIGINATING_SOURCE_COMPANY | SOURCE_COMPANY | VARCHAR2(60) | NOT NULL | No | No |
| PART_AKA | PART_ID | VARCHAR2(25) | NOT NULL | Yes | No |
| PART_AKA | AKA_PART | VARCHAR2(25) | NOT NULL | Yes | No |
| PART_AKA | MFG_ID | CHAR(2) | NOT NULL | Yes | No |
| PART_CONDITION | PART_CONDITION_ID | VARCHAR2(20) | NOT NULL | Yes | No |
| PART_CONDITION | PART_CONDITION | VARCHAR2(60) | NOT NULL | No | No |
| PART_CUSTOMER | PART_ID | VARCHAR2(25) | NOT NULL | Yes | No |
| PART_CUSTOMER | CUST_ID | VARCHAR2(7) | NOT NULL | Yes | No |
| PART_CUSTOMER | MFG_ID | CHAR(2) | NOT NULL | Yes | No |
| PART_CUSTOMER | INACTIVE_FLG | CHAR(1) | NOT NULL | No | No |
| PART_CUSTOMER | QTY_ON_HAND | NUMBER | NOT NULL | No | No |
| PART_CUSTOMER | ON_ORDER_QTY | NUMBER | NULL | No | No |
| PART_CUSTOMER | BIN_LOCATION | VARCHAR2(20) | NULL | No | No |
| PART_CUSTOMER | PROTECT_PUBLIC_DISPLAY | CHAR(1) | NOT NULL | No | No |
| PART_CUSTOMER | PROTECT_QTY_BELOW | NUMBER | NOT NULL | No | No |
| PART_CUSTOMER | DATE_PART_LAST_UPDATED | DATE | NOT NULL | No | No |
| PART_CUSTOMER | SOURCE_CODE | VARCHAR2(20) | NULL | No | No |
| PART_CUSTOMER | DMS_PART_ID | VARCHAR2(30) | NOT NULL | No | No |
| PART_CUSTOMER | SS_ID | VARCHAR2(20) | NULL | No | No |
| PART_CUSTOMER | BIN_LOCATION_PPD | CHAR(1) | NULL | No | No |
| PART_CUSTOMER | SS_ID_PPD | CHAR(1) | NULL | No | No |
| PART_CUSTOMER | DMS_MFG_ID | VARCHAR2(20) | NULL | No | No |
| PART_EASIDATA_KIT | MFG_ID | CHAR(2) | NOT NULL | Yes | No |
| PART_EASIDATA_KIT | EASIDATA_KIT_ID | VARCHAR2(25) | NOT NULL | Yes | No |
| PART_EASIDATA_KIT | PART_ID | VARCHAR2(25) | NOT NULL | Yes | No |
| PART_MASTER | PART_ID | VARCHAR2(25) | NOT NULL | Yes | No |
| PART_MASTER | MFG_ID | CHAR(2) | NOT NULL | Yes | No |
| PART_MASTER | PART_DESC | VARCHAR2(60) | NULL | No | No |
| PART_MASTER | DATE_PART_LAST_UPDATED | DATE | NOT NULL | No | No |
| PART_MASTER | PRICE_EFFECTIVE_DATE | DATE | NULL | No | No |
| PART_MASTER | DISCONTINUED_DATE | DATE | NULL | No | No |
| PART_MASTER | SUGGESTED_LIST_PRICE | FLOAT(126) | NULL | No | No |
| PART_MASTER | SUGGESTED_TRADE_PRICE | FLOAT(126) | NULL | No | No |
| PART_MASTER | DEALER_COST | FLOAT(126) | NULL | No | No |
| PART_MASTER | EXCHANGE_CHARGE | FLOAT(126) | NULL | No | No |
| PART_MASTER | HIGH_MODEL_YEAR | NUMBER | NULL | No | No |
| PART_MASTER | LOW_MODEL_YEAR | NUMBER | NULL | No | No |
| PART_MASTER | UNIT_OF_ISSUE | VARCHAR2(10) | NULL | No | No |
| PART_MASTER | UNIT_PACKAGE_QTY | NUMBER | NULL | No | No |
| PART_MASTER | WEIGHT | FLOAT(126) | NULL | No | No |
| PART_MASTER | PART_CONDITION_ID | VARCHAR2(20) | NULL | No | No |
| PART_MASTER | MFG_GROUP | VARCHAR2(10) | NULL | No | No |
| PART_MASTER | MFG_PART_TYPE | CHAR(1) | NULL | No | No |
| PART_MASTER | DEALER_DISCOUNT_CODE | CHAR(1) | NULL | No | No |
| PART_MASTER | HAZARDOUS_MATERIAL | CHAR(1) | NULL | No | No |
| PART_MASTER | TRUCK_CODE | CHAR(1) | NULL | No | No |
| PART_MASTER | FRANCHISE_CODE | VARCHAR2(2) | NULL | No | No |
| PART_MASTER | LIFETIME_SERVICE_CODE | CHAR(1) | NULL | No | No |
| PART_MASTER | LIFETIME_WARRANTY_CODE | CHAR(1) | NULL | No | No |
| PART_MASTER | PRODUCT_LINE_CODE | VARCHAR2(3) | NULL | No | No |
| PART_MASTER | RETURNABILITY_CODE | CHAR(1) | NULL | No | No |
| PART_MASTER | GMSP_IND_CODE | CHAR(1) | NULL | No | No |
| PART_MASTER | SELECTIVE_PARTS_CODE | CHAR(1) | NULL | No | No |
| PART_MASTER | PRICE_CODE | CHAR(1) | NULL | No | No |
| PART_MASTER | STOCKING_CODE | CHAR(1) | NULL | No | No |
| PART_MASTER | OBSOLESCENCE_RETURN_CODE | VARCHAR2(4) | NULL | No | No |
| PART_MASTER | REPACK_CODE | CHAR(1) | NULL | No | No |
| PART_MASTER | CAR_LINE_USAGE_CODE | VARCHAR2(7) | NULL | No | No |
| PART_MASTER | CHANGE_CODE | VARCHAR2(2) | NULL | No | No |
| PART_MASTER | ICC_CODE | CHAR(1) | NULL | No | No |
| PART_MASTER | INTERCHANGE_CODE | CHAR(1) | NULL | No | No |
| PART_MASTER | WAREHOUSE_CODE | VARCHAR2(3) | NULL | No | No |
| PART_MASTER | WHOLESALE_INCENTIVE_CODE | CHAR(1) | NULL | No | No |
| PART_MASTER | WHOLESALE_INCENTIVE | FLOAT(126) | NULL | No | No |
| PART_MASTER | PROMOTIONAL_DISCOUNT | FLOAT(126) | NULL | No | No |
| PART_MASTER | PURCHASE_ALLOWANCE | FLOAT(126) | NULL | No | No |
| PART_MASTER | APPLICATION | VARCHAR2(10) | NULL | No | No |
| PART_MASTER | ADVANCE_NOTICE_SUPRSSN | CHAR(1) | NULL | No | No |
| PART_MASTER | ELIG_PIPP_RETURN_PROGRAM | CHAR(1) | NULL | No | No |
| PART_MASTER | ELIG_SP01_RETURN_PROGRAM | CHAR(1) | NULL | No | No |
| PART_MASTER | ELIG_SP02_RETURN_PROGRAM | CHAR(1) | NULL | No | No |
| PART_MASTER | PIPP_RETURN_PRICE | FLOAT(126) | NULL | No | No |
| PART_MASTER | SP01_RETURN_PRICE | FLOAT(126) | NULL | No | No |
| PART_MASTER | SP02_RETURN_PRICE | FLOAT(126) | NULL | No | No |
| PART_MASTER | LAST_RETURN_DATE | DATE | NULL | No | No |
| PART_MASTER | PRICE_CHANGE_CODE | CHAR(1) | NULL | No | No |
| PART_MASTER | FLEET_PRICE | FLOAT(126) | NULL | No | No |
| PART_MASTER | ORIG_PART_ID | VARCHAR2(30) | NULL | No | No |
| PART_MASTER | MFG_PART_ID | VARCHAR2(30) | NULL | No | No |
| PART_SUPERSESSION | MFG_ID | CHAR(2) | NOT NULL | Yes | No |
| PART_SUPERSESSION | PART_ID | VARCHAR2(25) | NOT NULL | Yes | No |
| PART_SUPERSESSION | SUPERCEDED_PART_ID | VARCHAR2(25) | NOT NULL | No | No |
| PART_SUPERSESSION | SUPERCEDED_DATE | DATE | NULL | No | No |
| PART_SUPERSESSION | DIRECTIONAL_IND | VARCHAR2(3) | NOT NULL | No | No |
| PLAN_TABLE | STATEMENT_ID | VARCHAR2(30) | NULL | No | No |
| PLAN_TABLE | TIMESTAMP | DATE | NULL | No | No |
| PLAN_TABLE | REMARKS | VARCHAR2(80) | NULL | No | No |
| PLAN_TABLE | OPERATION | VARCHAR2(30) | NULL | No | No |
| PLAN_TABLE | OPTIONS | VARCHAR2(30) | NULL | No | No |
| PLAN_TABLE | OBJECT_NODE | VARCHAR2(128) | NULL | No | No |
| PLAN_TABLE | OBJECT_OWNER | VARCHAR2(30) | NULL | No | No |
| PLAN_TABLE | OBJECT_NAME | VARCHAR2(30) | NULL | No | No |
| PLAN_TABLE | OBJECT_INSTANCE | NUMBER | NULL | No | No |
| PLAN_TABLE | OBJECT_TYPE | VARCHAR2(30) | NULL | No | No |
| PLAN_TABLE | OPTIMIZER | VARCHAR2(255) | NULL | No | No |
| PLAN_TABLE | SEARCH_COLUMNS | NUMBER | NULL | No | No |
| PLAN_TABLE | ID | NUMBER | NULL | No | No |
| PLAN_TABLE | PARENT_ID | NUMBER | NULL | No | No |
| PLAN_TABLE | POSITION | NUMBER | NULL | No | No |
| PLAN_TABLE | COST | NUMBER | NULL | No | No |
| PLAN_TABLE | CARDINALITY | NUMBER | NULL | No | No |
| PLAN_TABLE | BYTES | NUMBER | NULL | No | No |
| PLAN_TABLE | OTHER_TAG | VARCHAR2(255) | NULL | No | No |
| PLAN_TABLE | PARTITION_START | VARCHAR2(255) | NULL | No | No |
| PLAN_TABLE | PARTITION_STOP | VARCHAR2(255) | NULL | No | No |
| PLAN_TABLE | PARTITION_ID | NUMBER | NULL | No | No |
| PLAN_TABLE | OTHER | LONG | NULL | No | No |
| PLAN_TABLE | DISTRIBUTION | VARCHAR2(30) | NULL | No | No |
| PREFERRED_CUSTOMER | BUYER_CUST_ID | VARCHAR2(7) | NOT NULL | Yes | No |
| PREFERRED_CUSTOMER | SELLER_CUST_ID | VARCHAR2(7) | NOT NULL | Yes | No |
| PRICE_BASIS | PRICE_BASIS_ID | VARCHAR2(20) | NOT NULL | Yes | No |
| PRICE_BASIS | PRICE_BASIS_NAME | VARCHAR2(60) | NOT NULL | No | No |
| PRICE_BASIS | SORT_ORDER | NUMBER | NULL | No | No |
| REPORT_ON_ORDER_HEADER | ORDER_ID | NUMBER | NULL | No | No |
| REPORT_ON_ORDER_HEADER | ORDER_STATUS_ID | VARCHAR2(20) | NULL | No | No |
| REPORT_ON_ORDER_HEADER | ORDER_DATE | DATE | NULL | No | No |
| REPORT_ON_ORDER_HEADER | LAST_UPDATED | DATE | NULL | No | No |
| REPORT_ON_ORDER_HEADER | DURATION_IN_MIN | NUMBER | NULL | No | No |
| REPORT_ON_ORDER_HEADER | BUYER_CUST_ID | VARCHAR2(7) | NULL | No | No |
| REPORT_ON_ORDER_HEADER | BUYER_USER_ID | VARCHAR2(20) | NULL | No | No |
| REPORT_ON_ORDER_HEADER | SELLER_CUST_ID | VARCHAR2(7) | NULL | No | No |
| REPORT_ON_ORDER_HEADER | SELLER_USER_ID | VARCHAR2(20) | NULL | No | No |
| REPORT_ON_ORDER_HEADER | REPORT_TIME | VARCHAR2(10) | NULL | No | No |
| ROLE | ROLE_ID | VARCHAR2(20) | NOT NULL | Yes | No |
| ROLE | ROLE | VARCHAR2(60) | NULL | No | No |
| ROLE | INTERNAL_USER_IND | CHAR(1) | NOT NULL | No | No |
| SALES_TERMS | SALES_TERMS_ID | VARCHAR2(20) | NOT NULL | Yes | No |
| SALES_TERMS | SALES_TERMS | VARCHAR2(60) | NULL | No | No |
| SALES_TERMS | SORT_ORDER | NUMBER | NULL | No | No |
| SHIPPING_INSTRUCTIONS | SHIP_INSTR_ID | VARCHAR2(9) | NOT NULL | Yes | No |
| SHIPPING_INSTRUCTIONS | SHIP_INSTR | VARCHAR2(60) | NULL | No | No |
| SHIPPING_INSTRUCTIONS | SORT_ORDER | NUMBER | NULL | No | No |
| SQLTEMP | ADDR | NUMBER | NULL | No | No |
| SQLTEMP | HASHVAL | VARCHAR2(8) | NULL | No | No |
| SQLTEMP | SQL_TEXT | VARCHAR2(2000) | NULL | No | No |
| SQLTEMP | DISK_READS | NUMBER | NULL | No | No |
| SQLTEMP | EXECUTIONS | NUMBER | NULL | No | No |
| SQLTEMP | PARSE_CALLS | NUMBER | NULL | No | No |
| SQLTEMP | PARSE_USER | VARCHAR2(30) | NULL | No | No |
| SQLTEMP | STMT_ID | VARCHAR2(100) | NULL | No | No |
| STAGE_INVENTORY_LOAD | PART_ID | VARCHAR2(25) | NOT NULL | Yes | No |
| STAGE_INVENTORY_LOAD | CUST_ID | VARCHAR2(7) | NOT NULL | Yes | No |
| STAGE_INVENTORY_LOAD | MFG_ID | CHAR(2) | NOT NULL | Yes | No |
| STAGE_INVENTORY_LOAD | QTY_ON_HAND | NUMBER | NULL | No | No |
| STAGE_INVENTORY_LOAD | ON_ORDER_QTY | NUMBER | NULL | No | No |
| STAGE_INVENTORY_LOAD | BIN_LOCATION | VARCHAR2(20) | NULL | No | No |
| STAGE_INVENTORY_LOAD | PROTECT_PUBLIC_DISPLAY | CHAR(1) | NULL | No | No |
| STAGE_INVENTORY_LOAD | PROTECT_QTY_BELOW | NUMBER | NULL | No | No |
| STAGE_INVENTORY_LOAD | LOAD_TIME_STAMP | DATE | NULL | No | No |
| STAGE_INVENTORY_LOAD | SOURCE_CODE | VARCHAR2(20) | NULL | No | No |
| STAGE_INVENTORY_LOAD | INVENTORY_EXTRACT_TIME | DATE | NULL | No | No |
| STAGE_INVENTORY_LOAD | INVENTORY_FILE_NAME | VARCHAR2(80) | NULL | No | No |
| STAGE_INVENTORY_LOAD | PART_STATUS | CHAR(3) | NULL | No | No |
| STAGE_INVENTORY_LOAD | LOAD_PROCESS_STATUS | CHAR(3) | NULL | No | No |
| STAGE_INVENTORY_LOAD | LAST_LOAD_ATTEMPTED_TIME_STAMP | DATE | NULL | No | No |
| STAGE_INVENTORY_LOAD | INTERIM_ACTIVITY_QUANTITY | NUMBER | NULL | No | No |
| STAGE_INVENTORY_LOAD | DMS_PART_ID | VARCHAR2(30) | NULL | No | No |
| STAGE_INVENTORY_LOAD | SS_ID | VARCHAR2(20) | NULL | No | No |
| STAGE_INVENTORY_LOAD | BIN_LOCATION_PPD | CHAR(1) | NULL | No | No |
| STAGE_INVENTORY_LOAD | SS_ID_PPD | CHAR(1) | NULL | No | No |
| STAGE_INVENTORY_LOAD | DMS_MFG_ID | VARCHAR2(20) | NULL | No | No |
| STATE_PROVINCE | STATE_PROVINCE_ID | VARCHAR2(20) | NOT NULL | Yes | No |
| STATE_PROVINCE | COUNTRY_ID | VARCHAR2(20) | NOT NULL | No | No |
| STATE_PROVINCE | STATE_PROVINCE | VARCHAR2(60) | NOT NULL | No | No |
| STATE_PROVINCE | STATE_PROVINCE_CODE | VARCHAR2(3) | NULL | No | No |
| STATE_PROVINCE | SORT_ORDER | NUMBER | NULL | No | No |
| TELEPHONE_TYPE | PHONE_TYPE_ID | VARCHAR2(20) | NOT NULL | Yes | No |
| TELEPHONE_TYPE | PHONE_TYPE | VARCHAR2(60) | NOT NULL | No | No |
| TELEPHONE_TYPE | SORT_ORDER | NUMBER | NULL | No | No |
| TEMP_TABLE_WEEKLY_UPD | CUST_ID | VARCHAR2(7) | NOT NULL | No | No |
| TEMP_TABLE_HISTORY | TEMPTABLE_NAME | VARCHAR2(30) | NULL | No | No |
| TEMPTABLE_HISTORY | CREATED_TIMESTAMP | DATE | NULL | No | No |
| TEMPTABLE_HISTORY | DROPPED_TIMESTAMP | DATE | NULL | No | No |
| TIME_ZONE | TIME_ZONE_ID | VARCHAR2(20) | NOT NULL | Yes | No |
| TIME_ZONE | TIME_ZONE | VARCHAR2(60) | NULL | No | No |
| TIME_ZONE | GMT_DIFFERENCE | NUMBER | NOT NULL | No | No |
| TRANSACTION_LOG | TRANSACTION_LOG_ID | NUMBER | NOT NULL | Yes | No |
| TRANSACTION_LOG | TRANSACTION_TYPE_ID | VARCHAR2(20) | NOT NULL | No | No |
| TRANSACTION_LOG | USER_ID | VARCHAR2(20) | NOT NULL | No | No |
| TRANSACTION_LOG | CUST_ID | VARCHAR2(7) | NOT NULL | No | No |
| TRANSACTION_LOG | TRANSACTION_LOG_TIMESTAMP | DATE | NOT NULL | No | No |
| TRANSACTION_LOG | TRANSACTION_LOG_DETAIL | VARCHAR2(254) | NULL | No | No |
| TRANSACTION_TYPE | TRANSACTION_TYPE_ID | VARCHAR2(20) | NOT NULL | Yes | No |
| TRANSACTION_TYPE | TRANSACTION_EVENT | VARCHAR2(60) | NULL | No | No |
| TRANSACTION_TYPE | TRANSACTION_OCCURRENCE | VARCHAR2(254) | NULL | No | No |
| TRANSACTION_TYPE | TRANSACTION_DATA | VARCHAR2(60) | NULL | No | No |
| USER_PROFILE | USER_ID | VARCHAR2(20) | NOT NULL | Yes | No |
| USER_PROFILE | CUST_ID | VARCHAR2(7) | NOT NULL | Yes | No |
| USER_PROFILE | FIRST_NAME | VARCHAR2(40) | NOT NULL | No | No |
| USER_PROFILE | LAST_NAME | VARCHAR2(40) | NOT NULL | No | No |
| USER_PROFILE | INACTIVE_FLG | CHAR(1) | NOT NULL | No | No |
| USER_PROFILE | BEG_DATE | DATE | NOT NULL | No | No |
| USER_PROFILE | END_DATE | DATE | NULL | No | No |
| USER_PROFILE | USER_INITIALS | CHAR(3) | NOT NULL | No | No |
| USER_PROFILE | ROLE_ID | VARCHAR2(20) | NOT NULL | No | No |
| USER_PROFILE | DMS_USER_ID | VARCHAR2(20) | NULL | No | No |
| USER_PROFILE | SUSPEND_FLG | CHAR(1) | NULL | No | No |
| USER_PROFILE | LAST_LOGON_DATE | DATE | NULL | No | No |
| USER_PROFILE | UNSUCCESSFUL_LOGON_COUNT | NUMBER | NULL | No | No |
| USER_PROFILE | PASSWORD | VARCHAR2(20) | NOT NULL | No | No |
| USER_PROFILE | COUNTERMAN_NUM | VARCHAR2(20) | NULL | No | No |
| ADDRESS | ADR_ID | NUMBER | NOT NULL | Yes | No |
| ADDRESS | ADR_ADRT_ID | NUMBER | NOT NULL | No | Yes |
| ADDRESS | ADR_COMPANY_ID | NUMBER | NOT NULL | No | No |
| ADDRESS | ADR_CT_CODE | VARCHAR2(4) | NOT NULL | No | Yes |
| ADDRESS | ADR_STREET_1 | VARCHAR2(40) | NULL | No | No |
| ADDRESS | ADR_STREET_2 | VARCHAR2(40) | NULL | No | No |
| ADDRESS | ADR_CITY | VARCHAR2(40) | NULL | No | No |
| ADDRESS | ADR_STATE | VARCHAR2(20) | NULL | No | No |
| ADDRESS | ADR_COUNTRY | VARCHAR2(20) | NULL | No | No |
| ADDRESS | ADR_POSTAL_CODE | VARCHAR2(11) | NULL | No | No |
| ADDRESS | ADR_COUNTY | VARCHAR2(30) | NULL | No | No |
| ADDRESS | ADR_STATUS | CHAR(1) | NOT NULL | No | No |
| ADDRESS_TYPE | ADRT_ID | NUMBER | NOT NULL | Yes | No |
| ADDRESS_TYPE | ADRT_TYPE | VARCHAR2(20) | NOT NULL | No | No |
| ADMINISTRATIVE_1 | ID | NUMBER | NOT NULL | Yes | No |
| ADMINISTRATIVE_1 | ENVELOPE_ID | NUMBER | NULL | No | Yes |
| ADMINISTRATIVE_1 | INS_CO_ID | VARCHAR2(5) | NULL | No | No |
| ADMINISTRATIVE_1 | INS_CO_NM | VARCHAR2(35) | NULL | No | No |
| ADMINISTRATIVE_1 | INS_ADDR1 | VARCHAR2(40) | NULL | No | No |
| ADMINISTRATIVE_1 | INS_ADDR2 | VARCHAR2(40) | NULL | No | No |
| ADMINISTRATIVE_1 | INS_CITY | VARCHAR2(30) | NULL | No | No |
| ADMINISTRATIVE_1 | INS_ST | VARCHAR2(2) | NULL | No | No |
| ADMINISTRATIVE_1 | INS_ZIP | VARCHAR2(11) | NULL | No | No |
| ADMINISTRATIVE_1 | INS_CTRY | VARCHAR2(3) | NULL | No | No |
| ADMINISTRATIVE_1 | INS_PH1 | VARCHAR2(10) | NULL | No | No |
| ADMINISTRATIVE_1 | INS_PH1X | VARCHAR2(8) | NULL | No | No |
| ADMINISTRATIVE_1 | INS_PH2 | VARCHAR2(10) | NULL | No | No |
| ADMINISTRATIVE_1 | INS_PH2X | VARCHAR2(8) | NULL | No | No |
| ADMINISTRATIVE_1 | INS_FAX | VARCHAR2(10) | NULL | No | No |
| ADMINISTRATIVE_1 | INS_FAXX | VARCHAR2(8) | NULL | No | No |
| ADMINISTRATIVE_1 | INS_CT_LN | VARCHAR2(35) | NULL | No | No |
| ADMINISTRATIVE_1 | INS_CT_FN | VARCHAR2(35) | NULL | No | No |
| ADMINISTRATIVE_1 | INS_TITLE | VARCHAR2(35) | NULL | No | No |
| ADMINISTRATIVE_1 | INS_CT_PH | VARCHAR2(10) | NULL | No | No |
| ADMINISTRATIVE_1 | INS_CT_PHX | VARCHAR2(8) | NULL | No | No |
| ADMINISTRATIVE_1 | INS_EA | VARCHAR2(80) | NULL | No | No |
| ADMINISTRATIVE_1 | INS_MEMO | VARCHAR2(100) | NULL | No | No |
| ADMINISTRATIVE_1 | POLICY_NO | VARCHAR2(30) | NULL | No | No |
| ADMINISTRATIVE_1 | DED_AMT | NUMBER(22,2) | NULL | No | No |
| ADMINISTRATIVE_1 | DED_STATUS | VARCHAR2(2) | NULL | No | No |
| ADMINISTRATIVE_1 | ASGN_NO | VARCHAR2(25) | NULL | No | No |
| ADMINISTRATIVE_1 | ASGN_DATE | DATE | NULL | No | No |
| ADMINISTRATIVE_1 | ASGN_TYPE | VARCHAR2(1) | NULL | No | No |
| ADMINISTRATIVE_1 | CLM_NO | VARCHAR2(30) | NULL | No | No |
| ADMINISTRATIVE_1 | CLM_OFC_ID | VARCHAR2(5) | NULL | No | No |
| ADMINISTRATIVE_1 | CLM_OFC_NM | VARCHAR2(35) | NULL | No | No |
| ADMINISTRATIVE_1 | CLM_ADDR1 | VARCHAR2(40) | NULL | No | No |
| ADMINISTRATIVE_1 | CLM_ADDR2 | VARCHAR2(40) | NULL | No | No |
| ADMINISTRATIVE_1 | CLM_CITY | VARCHAR2(30) | NULL | No | No |
| ADMINISTRATIVE_1 | CLM_ST | VARCHAR2(2) | NULL | No | No |
| ADMINISTRATIVE_1 | CLM_ZIP | VARCHAR2(11) | NULL | No | No |
| ADMINISTRATIVE_1 | CLM_CTRY | VARCHAR2(3) | NULL | No | No |
| ADMINISTRATIVE_1 | CLM_PH1 | VARCHAR2(10) | NULL | No | No |
| ADMINISTRATIVE_1 | CLM_PH1X | VARCHAR2(8) | NULL | No | No |
| ADMINISTRATIVE_1 | CLM_PH2 | VARCHAR2(10) | NULL | No | No |
| ADMINISTRATIVE_1 | CLM_PH2X | VARCHAR2(8) | NULL | No | No |
| ADMINISTRATIVE_1 | CLM_FAX | VARCHAR2(10) | NULL | No | No |
| ADMINISTRATIVE_1 | CLM_FAXX | VARCHAR2(8) | NULL | No | No |
| ADMINISTRATIVE_1 | CLM_CT_LN | VARCHAR2(35) | NULL | No | No |
| ADMINISTRATIVE_1 | CLM_CT_FN | VARCHAR2(35) | NULL | No | No |
| ADMINISTRATIVE_1 | CLM_TITLE | VARCHAR2(35) | NULL | No | No |
| ADMINISTRATIVE_1 | CLM_CT_PH | VARCHAR2(10) | NULL | No | No |
| ADMINISTRATIVE_1 | CLM_CT_PHX | VARCHAR2(8) | NULL | No | No |
| ADMINISTRATIVE_1 | CLM_EA | VARCHAR2(80) | NULL | No | No |
| ADMINISTRATIVE_1 | PAYEE_NMS | VARCHAR2(85) | NULL | No | No |
| ADMINISTRATIVE_1 | PAY_TYPE | VARCHAR2(2) | NULL | No | No |
| ADMINISTRATIVE_1 | PAY_DATE | DATE | NULL | No | No |
| ADMINISTRATIVE_1 | PAY_CHKNM | VARCHAR2(16) | NULL | No | No |
| ADMINISTRATIVE_1 | PAY_AMT | NUMBER(22,2) | NULL | No | No |
| ADMINISTRATIVE_1 | PAY_MEMO | VARCHAR2(100) | NULL | No | No |
| ADMINISTRATIVE_1 | AGT_CO_ID | VARCHAR2(5) | NULL | No | No |
| ADMINISTRATIVE_1 | AGT_CO_NM | VARCHAR2(35) | NULL | No | No |
| ADMINISTRATIVE_1 | AGT_ADDR1 | VARCHAR2(40) | NULL | No | No |
| ADMINISTRATIVE_1 | AGT_ADDR2 | VARCHAR2(40) | NULL | No | No |
| ADMINISTRATIVE_1 | AGT_CITY | VARCHAR2(30) | NULL | No | No |
| ADMINISTRATIVE_1 | AGT_ST | VARCHAR2(2) | NULL | No | No |
| ADMINISTRATIVE_1 | AGT_ZIP | VARCHAR2(11) | NULL | No | No |
| ADMINISTRATIVE_1 | AGT_CTRY | VARCHAR2(3) | NULL | No | No |
| ADMINISTRATIVE_1 | AGT_PH1 | VARCHAR2(10) | NULL | No | No |
| ADMINISTRATIVE_1 | AGT_PH1X | VARCHAR2(8) | NULL | No | No |
| ADMINISTRATIVE_1 | AGT_PH2 | VARCHAR2(10) | NULL | No | No |
| ADMINISTRATIVE_1 | AGT_PH2X | VARCHAR2(8) | NULL | No | No |
| ADMINISTRATIVE_1 | AGT_FAX | VARCHAR2(10) | NULL | No | No |
| ADMINISTRATIVE_1 | AGT_FAX | VARCHAR2(8) | NULL | No | No |
| ADMINISTRATIVE_1 | AGT_CT_LN | VARCHAR2(35) | NULL | No | No |
| ADMINISTRATIVE_1 | AGT_CT_FN | VARCHAR2(35) | NULL | No | No |
| ADMINISTRATIVE_1 | AGT_CT_PH | VARCHAR2(10) | NULL | No | No |
| ADMINISTRATIVE_1 | AGT_CT_PHX | VARCHAR2(8) | NULL | No | No |
| ADMINISTRATIVE_1 | AGT_EA | VARCHAR2(80) | NULL | No | No |
| ADMINISTRATIVE_1 | AGT_LIC_NO | VARCHAR2(30) | NULL | No | No |
| ADMINISTRATIVE_1 | LOSS_DATE | DATE | NULL | No | No |
| ADMINISTRATIVE_1 | LOSS_CAT | VARCHAR2(1) | NULL | No | No |
| ADMINISTRATIVE_1 | LOSS_TYPE | VARCHAR2(7) | NULL | No | No |
| ADMINISTRATIVE_1 | LOSS_DESC | VARCHAR2(38) | NULL | No | No |
| ADMINISTRATIVE_1 | THEFT_IND | CHAR(1) | NULL | No | No |
| ADMINISTRATIVE_1 | CAT_NO | VARCHAR2(30) | NULL | No | No |
| ADMINISTRATIVE_1 | TLOS_IND | CHAR(1) | NULL | No | No |
| ADMINISTRATIVE_1 | LOSS_MEMO | VARCHAR2(100) | NULL | No | No |
| ADMINISTRATIVE_1 | CUST_PR | VARCHAR2(1) | NULL | No | No |
| ADMINISTRATIVE_1 | INSD_LN | VARCHAR2(35) | NULL | No | No |
| ADMINISTRATIVE_1 | INSD_FN | VARCHAR2(35) | NULL | No | No |
| ADMINISTRATIVE_1 | INSD_TITLE | VARCHAR2(2) | NULL | No | No |
| ADMINISTRATIVE_1 | INSD_CO_NM | VARCHAR2(35) | NULL | No | No |
| ADMINISTRATIVE_1 | INSD_ADDR1 | VARCHAR2(40) | NULL | No | No |
| ADMINISTRATIVE_1 | INSD_ADDR2 | VARCHAR2(40) | NULL | No | No |
| ADMINISTRATIVE_1 | INSD_CITY | VARCHAR2(30) | NULL | No | No |
| ADMINISTRATIVE_1 | INSD_ST | VARCHAR2(2) | NULL | No | No |
| ADMINISTRATIVE_1 | INSD_ZIP | VARCHAR2(11) | NULL | No | No |
| ADMINISTRATIVE_1 | INSD_CTRY | VARCHAR2(3) | NULL | No | No |
| ADMINISTRATIVE_1 | INSD_PH1 | VARCHAR2(10) | NULL | No | No |
| ADMINISTRATIVE_1 | INSD_PH1X | VARCHAR2(8) | NULL | No | No |
| ADMINISTRATIVE_1 | INSD_PH2 | VARCHAR2(10) | NULL | No | No |
| ADMINISTRATIVE_1 | INSD_PH2X | VARCHAR2(8) | NULL | No | No |
| ADMINISTRATIVE_1 | INSD_FAX | VARCHAR2(10) | NULL | No | No |
| ADMINISTRATIVE_1 | INSD_FAXX | VARCHAR2(8) | NULL | No | No |
| ADMINISTRATIVE_1 | INSD_EA | VARCHAR2(80) | NULL | No | No |
| ADMINISTRATIVE_1 | OWNR_LN | VARCHAR2(35) | NULL | No | No |
| ADMINISTRATIVE_1 | OWNR_FN | VARCHAR2(35) | NULL | No | No |
| ADMINISTRATIVE_1 | OWNR_TITLE | VARCHAR2(2) | NULL | No | No |
| ADMINISTRATIVE_1 | OWNR_CO_NM | VARCHAR2(35) | NULL | No | No |
| ADMINISTRATIVE_1 | OWNR_ADDR1 | VARCHAR2(40) | NULL | No | No |
| ADMINISTRATIVE_1 | OWNR_ADDR2 | VARCHAR2(40) | NULL | No | No |
| ADMINISTRATIVE_1 | OWNR_CITY | VARCHAR2(30) | NULL | No | No |
| ADMINISTRATIVE_1 | OWNR_ST | VARCHAR2(2) | NULL | No | No |
| ADMINISTRATIVE_1 | OWNR_ZIP | VARCHAR2(11) | NULL | No | No |
| ADMINISTRATIVE_1 | OWNR_CTRY | VARCHAR2(3) | NULL | No | No |
| ADMINISTRATIVE_1 | OWNR_PH1 | VARCHAR2(10) | NULL | No | No |
| ADMINISTRATIVE_1 | OWNR_PH1X | VARCHAR2(8) | NULL | No | No |
| ADMINISTRATIVE_1 | OWNR_PH2 | VARCHAR2(10) | NULL | No | No |
| ADMINISTRATIVE_1 | OWNR_PH2X | VARCHAR2(8) | NULL | No | No |
| ADMINISTRATIVE_1 | OWNR_FAX | VARCHAR2(10) | NULL | No | No |
| ADMINISTRATIVE_1 | OWNR_FAXX | VARCHAR2(2) | NULL | No | No |
| ADMINISTRATIVE_1 | OWNR_EA | VARCHAR2(80) | NULL | No | No |
| ADMINISTRATIVE_2 | ID | CHAR(18) | NOT NULL | Yes | No |
| ADMINISTRATIVE_2 | ENVELOPE_ID | NUMBER | NULL | No | Yes |
| ADMINISTRATIVE_2 | CLMT_LN | VARCHAR2(35) | NULL | No | No |
| ADMINISTRATIVE_2 | CLMT_FN | VARCHAR2(35) | NULL | No | No |
| ADMINISTRATIVE_2 | CLMT_TITLE | VARCHAR2(2) | NULL | No | No |
| ADMINISTRATIVE_2 | CLMT_CO_NM | VARCHAR2(35) | NULL | No | No |
| ADMINISTRATIVE_2 | CLMT_ADDR1 | VARCHAR2(40) | NULL | No | No |
| ADMINISTRATIVE_2 | CLMT_ADDR2 | VARCHAR2(40) | NULL | No | No |
| ADMINISTRATIVE_2 | CLMT_CITY | VARCHAR2(30) | NULL | No | No |
| ADMINISTRATIVE_2 | CLMT_ST | VARCHAR2(2) | NULL | No | No |
| ADMINISTRATIVE_2 | CLMT_ZIP | VARCHAR2(11) | NULL | No | No |
| ADMINISTRATIVE_2 | CLMT_CTRY | VARCHAR2(3) | NULL | No | No |
| ADMINISTRATIVE_2 | CLMT_PH1 | VARCHAR2(10) | NULL | No | No |
| ADMINISTRATIVE_2 | CLMT_PH1X | VARCHAR2(8) | NULL | No | No |
| ADMINISTRATIVE_2 | CLMT_PH2 | VARCHAR2(10) | NULL | No | No |
| ADMINISTRATIVE_2 | CLMT_PH2X | VARCHAR2(8) | NULL | No | No |
| ADMINISTRATIVE_2 | CLMT_FAX | VARCHAR2(10) | NULL | No | No |
| ADMINISTRATIVE_2 | CLMT_FAXX | VARCHAR2(8) | NULL | No | No |
| ADMINISTRATIVE_2 | CLMT_EA | VARCHAR2(80) | NULL | No | No |
| ADMINISTRATIVE_2 | EST_CO_ID | VARCHAR2(5) | NULL | No | No |
| ADMINISTRATIVE_2 | EST_CO_NM | VARCHAR2(35) | NULL | No | No |
| ADMINISTRATIVE_2 | EST_ADDR1 | VARCHAR2(40) | NULL | No | No |
| ADMINISTRATIVE_2 | EST_ADDR2 | VARCHAR2(40) | NULL | No | No |
| ADMINISTRATIVE_2 | EST_CITY | VARCHAR2(30) | NULL | No | No |
| ADMINISTRATIVE_2 | EST_ST | VARCHAR2(2) | NULL | No | No |
| ADMINISTRATIVE_2 | EST_ZIP | VARCHAR2(11) | NULL | No | No |
| ADMINISTRATIVE_2 | EST_CTRY | VARCHAR2(3) | NULL | No | No |
| ADMINISTRATIVE_2 | EST_PH1 | VARCHAR2(10) | NULL | No | No |
| ADMINISTRATIVE_2 | EST_PH1X | VARCHAR2(8) | NULL | No | No |
| ADMINISTRATIVE_2 | EST_PH2 | VARCHAR2(10) | NULL | No | No |
| ADMINISTRATIVE_2 | EST_PH2X | VARCHAR2(8) | NULL | No | No |
| ADMINISTRATIVE_2 | EST_FAX | VARCHAR2(10) | NULL | No | No |
| ADMINISTRATIVE_2 | EST_FAXX | VARCHAR2(8) | NULL | No | No |
| ADMINISTRATIVE_2 | EST_CT_LN | VARCHAR2(35) | NULL | No | No |
| ADMINISTRATIVE_2 | EST_CT_FN | VARCHAR2(35) | NULL | No | No |
| ADMINISTRATIVE_2 | EST_EA | VARCHAR2(80) | NULL | No | No |
| ADMINISTRATIVE_2 | EST_LIC_NO | VARCHAR2(30) | NULL | No | No |
| ADMINISTRATIVE_2 | EST_FILENO | VARCHAR2(25) | NULL | No | No |
| ADMINISTRATIVE_2 | INSP_CT_LN | VARCHAR2(35) | NULL | No | No |
| ADMINISTRATIVE_2 | INSP_CT_FN | VARCHAR2(35) | NULL | No | No |
| ADMINISTRATIVE_2 | INSP_ADDR1 | VARCHAR2(40) | NULL | No | No |
| ADMINISTRATIVE_2 | INSP_ADDR2 | VARCHAR2(40) | NULL | No | No |
| ADMINISTRATIVE_2 | INSP_CITY | VARCHAR2(30) | NULL | No | No |
| ADMINISTRATIVE_2 | INSP_ST | VARCHAR2(2) | NULL | No | No |
| ADMINISTRATIVE_2 | INSP_ZIP | VARCHAR2(11) | NULL | No | No |
| ADMINISTRATIVE_2 | INSP_CTRY | VARCHAR2(3) | NULL | No | No |
| ADMINISTRATIVE_2 | INSP_PH1 | VARCHAR2(10) | NULL | No | No |
| ADMINISTRATIVE_2 | INSP_PH1X | VARCHAR2(8) | NULL | No | No |
| ADMINISTRATIVE_2 | INSP_PH2 | VARCHAR2(10) | NULL | No | No |
| ADMINISTRATIVE_2 | INSP_PH2X | VARCHAR2(8) | NULL | No | No |
| ADMINISTRATIVE_2 | INSP_FAX | VARCHAR2(10) | NULL | No | No |
| ADMINISTRATIVE_2 | INSP_FAXX | VARCHAR2(8) | NULL | No | No |
| ADMINISTRATIVE_2 | INSP_EA | VARCHAR2(80) | NULL | No | No |
| ADMINISTRATIVE_2 | INSP_CODE | VARCHAR2(4) | NULL | No | No |
| ADMINISTRATIVE_2 | INSP_DESC | VARCHAR2(40) | NULL | No | No |
| ADMINISTRATIVE_2 | INSP_DATE | VARCHAR2(8) | NULL | No | No |
| ADMINISTRATIVE_2 | INSP_TIME | VARCHAR2(4) | NULL | No | No |
| ADMINISTRATIVE_2 | RF_CO_ID | VARCHAR2(5) | NULL | No | No |
| ADMINISTRATIVE_2 | RF_CO_NM | VARCHAR2(35) | NULL | No | No |
| ADMINISTRATIVE_2 | RF_ADDR1 | VARCHAR2(40) | NULL | No | No |
| ADMINISTRATIVE_2 | RF_ADDR2 | VARCHAR2(40) | NULL | No | No |
| ADMINISTRATIVE_2 | RF_CITY | VARCHAR2(30) | NULL | No | No |
| ADMINISTRATIVE_2 | RF_ST | VARCHAR2(2) | NULL | No | No |
| ADMINISTRATIVE_2 | RF_ZIP | VARCHAR2(11) | NULL | No | No |
| ADMINISTRATIVE_2 | RF_CTRY | VARCHAR2(3) | NULL | No | No |
| ADMINISTRATIVE_2 | RF_PH1 | VARCHAR2(10) | NULL | No | No |
| ADMINISTRATIVE_2 | RF_PH1X | VARCHAR2(8) | NULL | No | No |
| ADMINISTRATIVE_2 | RF_PH2 | VARCHAR2(10) | NULL | No | No |
| ADMINISTRATIVE_2 | RF_PH2X | VARCHAR2(8) | NULL | No | No |
| ADMINISTRATIVE_2 | RF_FAX | VARCHAR2(10) | NULL | No | No |
| ADMINISTRATIVE_2 | RF_FAXX | VARCHAR2(8) | NULL | No | No |
| ADMINISTRATIVE_2 | RF_TAX_ID | VARCHAR2(30) | NULL | No | No |
| ADMINISTRATIVE_2 | RF_LIC_NO | VARCHAR2(30) | NULL | No | No |
| ADMINISTRATIVE_2 | RF_BAR_NO | VARCHAR2(30) | NULL | No | No |
| ADMINISTRATIVE_2 | RF_EA | VARCHAR2(80) | NULL | No | No |
| ADMINISTRATIVE_2 | RF_CT_LN | VARCHAR2(35) | NULL | No | No |
| ADMINISTRATIVE_2 | RF_CT_FN | VARCHAR2(35) | NULL | No | No |
| ADMINISTRATIVE_2 | RO_IN_DATE | DATE | NULL | No | No |
| ADMINISTRATIVE_2 | RO_IN_TIME | VARCHAR2(4) | NULL | No | No |
| ADMINISTRATIVE_2 | RO_AUTH | VARCHAR2(100) | NULL | No | No |
| ADMINISTRATIVE_2 | TAR_DATE | DATE | NULL | No | No |
| ADMINISTRATIVE_2 | TAR_TIME | VARCHAR2(4) | NULL | No | No |
| ADMINISTRATIVE_2 | RO_CMPDATE | DATE | NULL | No | No |
| ADMINISTRATIVE_2 | RO_CMPTIME | VARCHAR2(4) | NULL | No | No |
| ADMINISTRATIVE_2 | DATE_OUT | DATE | NULL | No | No |
| ADMINISTRATIVE_2 | TIME_OUT | VARCHAR2(4) | NULL | No | No |
| ADMINISTRATIVE_2 | RF_ESTIMTR | VARCHAR2(35) | NULL | No | No |
| ADMINISTRATIVE_2 | MKTG_TYPE | VARCHAR2(2) | NULL | No | No |
| ADMINISTRATIVE_2 | MKTG_SRC | VARCHAR2(35) | NULL | No | No |
| ADMINISTRATIVE_2 | LOC_NM | VARCHAR2(35) | NULL | No | No |
| ADMINISTRATIVE_2 | LOC_ADDR1 | VARCHAR2(40) | NULL | No | No |
| ADMINISTRATIVE_2 | LOC_ADDR2 | VARCHAR2(40) | NULL | No | No |
| ADMINISTRATIVE_2 | LOC_CITY | VARCHAR2(30) | NULL | No | No |
| ADMINISTRATIVE_2 | LOC_ST | VARCHAR2(2) | NULL | No | No |
| ADMINISTRATIVE_2 | LOC_ZIP | VARCHAR2(11) | NULL | No | No |
| ADMINISTRATIVE_2 | LOC_CTRY | VARCHAR2(3) | NULL | No | No |
| ADMINISTRATIVE_2 | LOC_PH1 | VARCHAR2(10) | NULL | No | No |
| ADMINISTRATIVE_2 | LOC_PH1X | VARCHAR2(8) | NULL | No | No |
| ADMINISTRATIVE_2 | LOC_PH2 | VARCHAR2(10) | NULL | No | No |
| ADMINISTRATIVE_2 | LOC_PH2X | VARCHAR2(8) | NULL | No | No |
| ADMINISTRATIVE_2 | LOC_FAX | VARCHAR2(10) | NULL | No | No |
| ADMINISTRATIVE_2 | LOC_FAXX | VARCHAR2(8) | NULL | No | No |
| ADMINISTRATIVE_2 | LOC_CT_LN | CHAR(18) | NULL | No | No |
| ADMINISTRATIVE_2 | LOC_CT_FN | VARCHAR2(35) | NULL | No | No |
| ADMINISTRATIVE_2 | LOC_TITLE | VARCHAR2(35) | NULL | No | No |
| ADMINISTRATIVE_2 | LOC_PH | VARCHAR2(10) | NULL | No | No |
| ADMINISTRATIVE_2 | LOC_PHX | VARCHAR2(8) | NULL | No | No |
| ADMINISTRATIVE_2 | LOC_EA | VARCHAR2(80) | NULL | No | No |
| ADVERTISEMENT | AD_ID | NUMBER | NOT NULL | Yes | No |
| ADVERTISEMENT | AD_FILE_NAME | VARCHAR2(100) | NULL | No | No |
| ADVERTISEMENT | AD_TARGET_CD | VARCHAR2(5) | NULL | No | No |
| APPROVAL_STATUS | APST_ID | NUMBER | NOT NULL | Yes | No |
| APPROVAL_STATUS | APST_STATUS | VARCHAR2(25) | NULL | No | No |
| ARA_CONFIG | SUBSCRIBER_ID | NUMBER(10) | NOT NULL | No | No |
| ARA_CONFIG | SUBSCRIBER_TYPE | VARCHAR2(4) | NULL | No | No |
| ARA_CONFIG | CONTRIB_ID | NUMBER(10) | NULL | No | No |
| ARA_CONFIG | PRODUCT_OPTIONS | NUMBER | NOT NULL | No | No |
| ARA_CONFIG | DISPLAY_OPTIONS | NUMBER | NULL | No | No |
| ARA_CONFIG | FORM_NUM | VARCHAR2(10) | NULL | No | No |
| ARA_CONFIG_BK | SUBSCRIBER_ID | NUMBER(10) | NOT NULL | No | No |
| ARA_CONFIG_BK | SUBSCRIBER_TYPE | VARCHAR2(4) | NULL | No | No |
| ARA_CONFIG_BK | CONTRIB_ID | NUMBER(10) | NOT NULL | No | No |
| ARA_CONFIG_BK | PRODUCT_OPTIONS | NUMBER | NOT NULL | No | No |
| ARA_CONFIG_BK | DISPLAY_OPTIONS | NUMBER | NULL | No | No |
| ARA_CONFIG_BK | FORM_NUM | VARCHAR2(10) | NULL | No | No |
| ARA_CONFIG1 | SUBSCRIBER_ID | NUMBER(10) | NOT NULL | No | No |
| ARA_CONFIG1 | SUBSCRIBER_TYPE | VARCHAR2(4) | NULL | No | No |
| ARA_CONFIG1 | CONTRIB_ID | NUMBER(10) | NULL | No | No |
| ARA_CONFIG1 | PRODUCT_OPTIONS | NUMBER | NOT NULL | No | No |
| ARA_CONFIG1 | DISPLAY_OPTIONS | NUMBER | NULL | No | No |
| ARA_CONFIG1 | FORM_NUM | VARCHAR2(10) | NULL | No | No |
| ARA_USER_LOG | COMPANY_ID | NUMBER(10) | NOT NULL | No | No |
| ARA_USER_LOG | COMPANY_TYPE | VARCHAR2(4) | NULL | No | No |
| ARA_USER_LOG | USER_NAME | VARCHAR2(50) | NOT NULL | No | No |
| ARA_USER_LOG | LOG_ON | DATE | NULL | No | No |
| ARA_USER_LOG | LOG_OFF | DATE | NULL | No | No |
| ARA_USER_LOG | FLAG | CHAR(1) | NULL | No | No |
| AUDIT_TRAIL | AUT_ID | NUMBER | NOT NULL | Yes | No |
| AUDIT_TRAIL | AUT_FROM_STATUS_ID | NUMBER | NULL | No | Yes |
| AUDIT_TRAIL | AUT_TO_STATUS_ID | NUMBER | NULL | No | Yes |
| AUDIT_TRAIL | AUT_AUDITOR_NAME | VARCHAR2(50) | NOT NULL | No | No |
| AUDIT_TRAIL | AUT_SUMMARY | VARCHAR2(1000) | NOT NULL | No | No |
| AUDIT_TRAIL | AUT_COMPANY_ID | NUMBER | NOT NULL | No | No |
| AUDIT_TRAIL | AUT_CT_CODE | VARCHAR2(5) | NOT NULL | No | No |
| AUDIT_TRAIL | AUT_OLD_NICKNAME | VARCHAR2(20) | NULL | No | No |
| AUDIT_TRAIL | AUT_NEW_NICKNAME | VARCHAR2(20) | NULL | No | No |
| AUDIT_TRAIL | AUT_OLD_URL | VARCHAR2(80) | NULL | No | No |
| AUDIT_TRAIL | AUT_NEW_URL | VARCHAR2(80) | NULL | No | No |
| AUDIT_TRAIL | AUT_OLD_TAX_ID | VARCHAR2(20) | NULL | No | No |
| AUDIT_TRAIL | AUT_NEW_TAX_ID | VARCHAR2(20) | NULL | No | No |
| AUDIT_TRAIL | AUT_OLD_BUSINESS_LICENSE | VARCHAR2(20) | NULL | No | No |
| AUDIT_TRAIL | AUT_NEW_BUSINESS_LICENSE | VARCHAR2(20) | NULL | No | No |
| AUDIT_TRAIL | AUT_OLD_WHOLESALE_LICENSE | VARCHAR2(20) | NULL | No | No |
| AUDIT_TRAIL | AUT_NEW_WHOLESALE_LICENSE | VARCHAR2(20) | NULL | No | No |
| AUDIT_TRAIL | AUT_OLD_MONTHLY_VOLUME | NUMBER | NULL | No | No |
| AUDIT_TRAIL | AUT_NEW_MONTHLY_VOLUME | NUMBER | NULL | No | No |
| AUDIT_TRAIL | AUT_OLD_NETWORK | CHAR(1) | NULL | No | No |
| AUDIT_TRAIL | AUT_NEW_NETWORK | CHAR(1) | NULL | No | No |
| AUDIT_TRAIL | AUT_OLD_WARRANTIES | VARCHAR2(100) | NULL | No | No |
| AUDIT_TRAIL | AUT_NEW_WARRANTIES | VARCHAR2(100) | NULL | No | No |
| AUDIT_TRAIL | AUT_OLD_RETURN_POLICY | VARCHAR2(1000) | NULL | No | No |
| AUDIT_TRAIL | AUT_NEW_RETURN_POLICY | VARCHAR2(1000) | NULL | No | No |
| AUDIT_TRAIL | AUT_NETWORK_FLAG | CHAR(1) | NULL | No | No |
| AUDIT_TRAIL | AUT_NEW_NETWORK_FLAG | CHAR(1) | NULL | No | No |
| AUDIT_TRAIL | AUT_OLD_MK_ID | NUMBER | NULL | No | No |
| AUDIT_TRAIL | AUT_NEW_MK_ID | NUMBER | NULL | No | No |
| AUDIT_TRAIL | AUT_PT_ID | NUMBER | NULL | No | No |
| AUDIT_TRAIL | AUT_NEW_PT_ID | NUMBER | NULL | No | No |
| AUDIT_TRAIL | AUT_PART_TYPE_OTHER | VARCHAR2(100) | NULL | No | No |
| AUDIT_TRAIL | AUT_NEW_PART_TYPE_OTHER | VARCHAR2(100) | NULL | No | No |
| AUDIT_TRAIL | AUT_OLD_ALL_MAKE_FLAG | CHAR(1) | NULL | No | No |
| AUDIT_TRAIL | AUT_NEW_ALL_MAKE_FLAG | CHAR(1) | NULL | No | No |
| AUDIT_TRAIL | AUT_OLD_MAKE_OTHER_FLAG | CHAR(1) | NULL | No | No |
| AUDIT_TRAIL | OLD_NEW_MAKE_OTHER_FLAG | CHAR(1) | NULL | No | No |
| AUDIT_TRAIL | AUT_OLD_MAKE_OTHER | VARCHAR2(100) | NULL | No | No |
| AUDIT_TRAIL | AUT_NEW_MAKE_OTHER | VARCHAR2(100) | NULL | No | No |
| AUDIT_TRAIL | AUT_OLD_WEB_DISCOUNT_FLAG | CHAR(1) | NULL | No | No |
| AUDIT_TRAIL | AUT_NEW_WEB_DISCOUNT_FLAG | CHAR(1) | NULL | No | No |
| AUDIT_TRAIL | AUT_OLD_WEB_DISCOUNT | VARCHAR2(100) | NULL | No | No |
| AUDIT_TRAIL | AUT_NEW_WEB_DISCOUNT | VARCHAR2(100) | NULL | No | No |
| AUDIT_TRAIL | AUT_OLD_DESCRIPTION | VARCHAR2(1000) | NULL | No | No |
| AUDIT_TRAIL | AUT_NEW_DESCRIPTION | VARCHAR2(1000) | NULL | No | No |
| AUDIT_TRAIL | AUT_OLD_CONTACT_FIRST_NAME | VARCHAR2(50) | NULL | No | No |
| AUDIT_TRAIL | AUT_NEW_CONTACT_FIRST_NAME | VARCHAR2(50) | NULL | No | No |
| AUDIT_TRAIL | AUT_OLD_CONTACT_LAST_NAME | VARCHAR2(50) | NULL | No | No |
| AUDIT_TRAIL | AUT_NEW_CONTACT_LAST_NAME | VARCHAR2(50) | NULL | No | No |
| AUDIT_TRAIL | AUT_OLD_LOGO | BLOB | NULL | No | No |
| AUDIT_TRAIL | AUT_NEW_LOGO | BLOB | NULL | No | No |
| BODY_SHOP | BS_ID | NUMBER | NOT NULL | Yes | No |
| BODY_SHOP | BS_APST_ID | NUMBER | NULL | No | Yes |
| BODY_SHOP | BS_COMPANY_NAME | VARCHAR2(50) | NULL | No | No |
| BODY_SHOP | BS_NICK_NAME | VARCHAR2(20) | NULL | No | No |
| BODY_SHOP | BS_INF_LOCNUM | VARCHAR2(9) | NULL | No | No |
| BODY_SHOP | BS_REGISTERED_FLAG | CHAR(1) | NULL | No | No |
| BODY_SHOP | BS_ESP_FLAG | CHAR(1) | NULL | No | No |
| BODY_SHOP | BS_ABS_SEND_FLAG | CHAR(1) | NULL | No | No |
| BODY_SHOP | BS_ABS_EDIT_VENDOR_FLAG | CHAR(1) | NULL | No | No |
| BODY_SHOP_APPOINTMENT | BSAPPT_ID | NUMBER | NOT NULL | Yes | No |
| BODY_SHOP_APPOINTMENT | BS_ID | NUMBER | NOT NULL | No | Yes |
| BODY_SHOP_APPOINTMENT | El_ID | NUMBER | NULL | No | Yes |
| BODY_SHOP_APPOINTMENT | CUST_FIRST_NAME | VARCHAR2(35) | NULL | No | No |
| BODY_SHOP_APPOINTMENT | CUST_LAST_NAME | VARCHAR2(35) | NULL | No | No |
| BODY_SHOP_APPOINTMENT | CUST_EMAIL | VARCHAR2(80) | NULL | No | No |
| BODY_SHOP_APPOINTMENT | CUST_HOME_PHONE | VARCHAR2(40) | NULL | No | No |
| BODY_SHOP_APPOINTMENT | CUST_WORK_PHONE | VARCHAR2(40) | NULL | No | No |
| BODY_SHOP_APPOINTMENT | CUST_STREET_ADDR1 | VARCHAR2(40) | NULL | No | No |
| BODY_SHOP_APPOINTMENT | CUST_STREET_ADDR2 | VARCHAR2(40) | NULL | No | No |
| BODY_SHOP_APPOINTMENT | CUST_CITY | VARCHAR2(40) | NULL | No | No |
| BODY_SHOP_APPOINTMENT | CUST_STATE | VARCHAR2(20) | NULL | No | No |
| BODY_SHOP_APPOINTMENT | CUST_ZIP | VARCHAR2(11) | NULL | No | No |
| BODY_SHOP_APPOINTMENT | CUST_COUNTRY | VARCHAR2(20) | NULL | No | No |
| BODY_SHOP_APPOINTMENT | BEST_CONTACT_WAY | VARCHAR2(15) | NULL | No | No |
| BODY_SHOP_APPOINTMENT | BEST_CONTACT_TIME | VARCHAR2(80) | NULL | No | No |
| BODY_SHOP_APPOINTMENT | APPT_DAY | NUMBER(2) | NULL | No | No |
| BODY_SHOP_APPOINTMENT | APPT_MONTH | NUMBER(2) | NULL | No | No |
| BODY_SHOP_APPOINTMENT | APPT_YEAR | NUMBER(4) | NULL | No | No |
| BODY_SHOP_APPOINTMENT | APPT_TIME | VARCHAR2(10) | NULL | No | No |
| BODY_SHOP_APPOINTMENT | RESCHEDULE_PREF | VARCHAR2(15) | NULL | No | No |
| BODY_SHOP_APPOINTMENT | RENTAL_NEEDED | CHAR(1) | NULL | No | No |
| BODY_SHOP_APPOINTMENT | VEH_YEAR | VARCHAR2(4) | NULL | No | No |
| BODY_SHOP_APPOINTMENT | VEH_MAKE | VARCHAR2(20) | NULL | No | No |
| BODY_SHOP_APPOINTMENT | VEH_MODEL | VARCHAR2(50) | NULL | No | No |
| BODY_SHOP_APPOINTMENT | VEH_VIN | VARCHAR2(25) | NULL | No | No |
| BODY_SHOP_APPOINTMENT | VEH_DRIVEABLE | CHAR(1) | NULL | No | No |
| BODY_SHOP_APPOINTMENT | INS_PROVIDER | VARCHAR2(35) | NULL | No | No |
| BODY_SHOP_APPOINTMENT | INS_CLAIM_NO | VARCHAR2(30) | NULL | No | No |
| BODY_SHOP_APPOINTMENT | INS_REP | VARCHAR2(40) | NULL | No | No |
| BODY_SHOP_APPOINTMENT | INS_REP_PHONE | VARCHAR2(40) | NULL | No | No |
| BODY_SHOP_APPOINTMENT | INS_DEDUCTABLE | VARCHAR2(10) | NULL | No | No |
| BODY_SHOP_APPOINTMENT | TOW_NEEDED | CHAR(1) | NULL | No | No |
| BODY_SHOP_APPOINTMENT | TOW_FROM_ADDR1 | VARCHAR2(40) | NULL | No | No |
| BODY_SHOP_APPOINTMENT | TOW_FROM_ADDR2 | VARCHAR2(40) | NULL | No | No |
| BODY_SHOP_APPOINTMENT | TOW_FROM_CITY | VARCHAR2(40) | NULL | No | No |
| BODY_SHOP_APPOINTMENT | TOW_FROM_STATE | VARCHAR2(20) | NULL | No | No |
| BODY_SHOP_APPOINTMENT | TOW_FROM_ZIP | VARCHAR2(11) | NULL | No | No |
| BODY_SHOP_APPOINTMENT | COMMENTS | VARCHAR2(1000) | NULL | No | No |
| BODY_SHOP_BACKUP | BS_ID | NUMBER | NOT NULL | No | No |
| BODY_SHOP_BACKUP | BS_APST_ID | NUMBER | NULL | No | No |
| BODY_SHOP_BACKUP | BS_COMPANY_NAME | VARCHAR2(50) | NULL | No | No |
| BODY_SHOP_BACKUP | BS_NICK_NAME | VARCHAR2(20) | NULL | No | No |
| BODY_SHOP_BACKUP | BS_INF_LOCNUM | VARCHAR2(9) | NULL | No | No |
| BODY_SHOP_BACKUP | BS_REGISTERED_FLAG | CHAR(1) | NULL | No | No |
| BODY_SHOP_BACKUP | BS_ESP_FLAG | CHAR(1) | NULL | No | No |
| BODY_SHOP_PREFERENCE | BSP_ID | NUMBER | NOT NULL | Yes | No |
| BODY_SHOP_PREFERENCE | BSP_NAME | VARCHAR2(50) | NULL | No | No |
| BODY_SHOP_PREFERENCE | BSP_DESCRIPTION | VARCHAR2(300) | NULL | No | No |
| BODY_SHOP_PREFERENCE_PAIR | BSPP_BS_ID | NUMBER | NOT NULL | Yes | Yes |
| BODY_SHOP_PREFERENCE_PAIR | BSPP_BSP_ID | NUMBER | NOT NULL | Yes | Yes |
| BODY_SHOP_PREFERENCE_PAIR | BSPP_VALUE | CHAR(1) | NULL | No | No |
| BODY_SHOP_PROFILE | BSPR_BS_ID | NUMBER | NOT NULL | No | Yes |
| BODY_SHOP_PROFILE | BSPR_DISCOUNT_TEXT | VARCHAR2(4000) | NULL | No | No |
| BODY_SHOP_PROFILE | BSPR_WEB_DISCOUNT_FLAG | CHAR(1) | NULL | No | No |
| BODY_SHOP_PROFILE | BSPR_INFO_TEXT | VARCHAR2(4000) | NULL | No | No |
| BODY_SHOP_PROFILE | BSPR_DELIVERY_PREFERENCE_TEXT | VARCHAR2(4000) | NULL | No | No |
| BODY_SHOP_PROFILE | BSPR_DELIVERY_TIME_FROM | VARCHAR2(20) | NULL | No | No |
| BODY_SHOP_PROFILE | BSPR_DELIVERY_TIME_TO | VARCHAR2(20) | NULL | No | No |
| BODY_SHOP_PROFILE | BSPR_URL | VARCHAR2(100) | NULL | No | No |
| BODY_SHOP_PROFILE | BSPR_DEALERSHIP_ASSOCIATION | CHAR(1) | NULL | No | No |
| BODY_SHOP_PROFILE | BSPR_DEALERSHIPS | VARCHAR2(100) | NULL | No | No |
| BODY_SHOP_PROFILE | BSPR_OTHER_INSURANCE_COMPANIES | VARCHAR2(100) | NULL | No | No |
| BODY_SHOP_PROFILE | BSPR_OTHER_CERTIFICATIONS | VARCHAR2(100) | NULL | No | No |
| BODY_SHOP_PROFILE | BSPR_OTHER_MAKES | VARCHAR2(100) | NULL | No | No |
| BODY_SHOP_PROFILE | BSPR_YEARS_IN_BUSINESS | NUMBER | NULL | No | No |
| BODY_SHOP_PROFILE | BSPR_SCHEDULING | CHAR(1) | NULL | No | No |
| BODY_SHOP_PROFILE | BSPR_WEEKDAY_OPENING_HOUR | VARCHAR2(20) | NULL | No | No |
| BODY_SHOP_PROFILE | BSPR_WEEKDAY_CLOSING_HOUR | VARCHAR2(20) | NULL | No | No |
| BODY_SHOP_PROFILE | BSPR_SATURDAY_OPENING_HOUR | VARCHAR2(20) | NULL | No | No |
| BODY_SHOP_PROFILE | BSPR_SATURDAY_CLOSING_HOUR | VARCHAR2(20) | NULL | No | No |
| BODY_SHOP_PROFILE | BSPR_SUNDAY_OPENING_HOUR | VARCHAR2(20) | NULL | No | No |
| BODY_SHOP_PROFILE | BSPR_SUNDAY_CLOSING_HOUR | VARCHAR2(20) | NULL | No | No |
| BODY_SHOP_PROFILE | BSPR_SPECIAL_HOURS | VARCHAR2(75) | NULL | No | No |
| BODY_SHOP_PROFILE | BSPR_ALL_MAKES | CHAR(1) | NULL | No | No |
| BODY_SHOP_PROFILE | BSPR_OTHER_SERVICES | VARCHAR2(100) | NULL | No | No |
| BODY_SHOP_PROFILE | BSPR_OTHER_PAINT_TYPE | VARCHAR2(100) | NULL | No | No |
| BODY_SHOP_PROFILE | BSPR_OTHER_EQUIPMENT | VARCHAR2(100) | NULL | No | No |
| BODY_SHOP_PROFILE | BSPR_OTHER_ALIGNMENT | VARCHAR2(100) | NULL | No | No |
| BODY_SHOP_PROFILE | BSPR_TAX_ID | VARCHAR2(20) | NULL | No | No |
| BODY_SHOP_PROFILE | BSPR_RESELLER_LICENSE | VARCHAR2(100) | NULL | No | No |
| BODY_SHOP_PROFILE | BSPR_STANDARD_DISCOUNT | NUMBER | NULL | No | No |
| BODY_SHOP_PROFILE | BSPR_MONTHLY_VOLUME | VARCHAR2(50) | NULL | No | No |
| BODY_SHOP_PROFILE | BSPR_WARRANTIES | VARCHAR2(250) | NULL | No | No |
| BODY_SHOP_PROFILE | BSPR_WEB_DISCOUNT_TEXT | VARCHAR2(4000) | NULL | No | No |
| BODY_SHOP_PROFILE | BSPR_COMPANY_NAME | VARCHAR2(100) | NULL | No | No |
| BODY_SHOP_PROFILE | BSPR_WEB_DISPLAY | NUMBER | NULL | No | No |
| BODY_SHOP_PROFILE | BSPR_WEB_NAVIGATION | NUMBER | NULL | No | No |
| BODY_SHOP_PROFILE | BSPR_PAGE_MODIFIED | NUMBER | NULL | No | No |
| BODY_SHOP_PROFILE | BSPR_SCHED_EMAIL | VARCHAR2(100) | NULL | No | No |
| BODY_SHOP_PROFILE | BSPR_SHOP_EMAIL | VARCHAR2(100) | NULL | No | No |
| BODY_SHOP_PROFILE | BSPR_STATUS | CHAR(1) | NOT NULL | No | No |
| BODY_SHOP_PROFILE | BSPR_OTHER_PAINT_BOOTH | VARCHAR2(100) | NULL | No | No |
| BODY_SHOP_PROFILE | BSPR_HAS_STATEMENT_1 | CHAR(1) | NULL | No | No |
| BODY_SHOP_PROFILE | BSPR_HAS_STATEMENT_2 | CHAR(1) | NULL | No | No |
| BODY_SHOP_PROFILE | BSPR_HAS_WARRANTY | CHAR(1) | NULL | No | No |
| BODY_SHOP_PROFILE | BSPR_HAS_BEFORE_PIC_1 | CHAR(1) | NULL | No | No |
| BODY_SHOP_PROFILE | BSPR_HAS_AFTER_PIC_1 | CHAR(1) | NULL | No | No |
| BODY_SHOP_PROFILE | BSPR_HAS_BEFORE_PIC_2 | CHAR(1) | NULL | No | No |
| BODY_SHOP_PROFILE | BSPR_HAS_AFTER_PIC_2 | CHAR(1) | NULL | No | No |
| BODY_SHOP_PROFILE | BSPR_HAS_SAFETY_COUPON | CHAR(1) | NULL | No | No |
| BODY_SHOP_PROFILE | BSPR_HAS_WASH_COUPON | CHAR(1) | NULL | No | No |
| BODY_SHOP_PROFILE | BSPR_HAS_RENTAL_COUPON | CHAR(1) | NULL | No | No |
| BODY_SHOP_PROFILE | BSPR_HAS_TOWING_COUPON | CHAR(1) | NULL | No | No |
| BODY_SHOP_PROFILE | BSPR_HAS_LIMITATIONS | CHAR(1) | NULL | No | No |
| BODY_SHOP_PROFILE | BSPR_HAS_MAIN_PIC | CHAR(1) | NULL | No | No |
| BODY_SHOP_PROFILE | BSPR_HAS_RENTAL_SERVICES | CHAR(1) | NULL | No | No |
| BODY_SHOP_PROFILE | BSPR_HAS_TOWING_SERVICES | CHAR(1) | NULL | No | No |
| BODY_SHOP_PROFILE | BSPR_HAS_SHUTTLE_SERVICE | CHAR(1) | NULL | No | No |
| BODY_SHOP_PROFILE | BSPR_HAS_VEHICLE_PICKUP | CHAR(1) | NULL | No | No |
| BODY_SHOP_PROFILE | BSPR_HAS_LOANER_CAR | CHAR(1) | NULL | No | No |
| BODY_SHOP_PROFILE | BSPR_HAS_PICKUP_HOURS | CHAR(1) | NULL | No | No |
| BODY_SHOP_PROFILE | BSPR_HAS_VEHICLE_STORAGE | CHAR(1) | NULL | No | No |
| BODY_SHOP_PROFILE | BSPR_HAS_MECHANICAL | CHAR(1) | NULL | No | No |
| BODY_SHOP_PROFILE | BSPR_HAS_THEFT_SERVICES | CHAR(1) | NULL | No | No |
| BODY_SHOP_PROFILE | BSPR_HAS_ONLINE_SCHEDULING | CHAR(1) | NULL | No | No |
| BODY_SHOP_PROFILE | BSPR_HAS_TEAM_PIC | CHAR(1) | NULL | No | No |
| BODY_SHOP_PROFILE | BSPR_HAS_LOGO_PIC | CHAR(1) | NULL | No | No |
| BODY_SHOP_PROFILE | BSPR_HAS_CSI | CHAR(1) | NULL | No | No |
| BODY_SHOP_PROFILE | BSPR_HAS_VEHICLE_STATUS | CHAR(1) | NULL | No | No |
| BODY_SHOP_PROFILE | BSPR_AUTOCHEX_ID | NUMBER | NULL | No | No |
| BODY_SHOP_PROFILE | BSPR_CREATED_ON | DATE | NULL | No | No |
| BODY_SHOP_PROFILE | BSPR_UPDATED_ON | DATE | NULL | No | No |
| BODY_SHOP_SPECIALTIES | BSS_MK_ID | NUMBER | NOT NULL | No | Yes |
| BODY_SHOP_SPECIALTIES | BSS_BS_ID | NUMBER | NOT NULL | No | Yes |
| BODY_SHOP_SPECIALTIES | BSS_STATUS | CHAR(1) | NOT NULL | No | No |
| BODY_SHOP_TECHNICAL_ENV | BSTE_ID | NUMBER | NOT NULL | No | No |
| BODY_SHOP_TECHNICAL_ENV | BSTE_BS_ID | NUMBER | NULL | No | No |
| BODY_SHOP_TECHNICAL_ENV | BSTE_COMPUTER_NUM_ID | NUMBER | NULL | No | No |
| BODY_SHOP_TECHNICAL_ENV | BSTE_BROWSER_TYPE_ID | NUMBER | NULL | No | No |
| BODY_SHOP_TECHNICAL_ENV | BSTE_NETWORKED | CHAR(1) | NULL | No | No |
| BODY_SHOP_TECHNICAL_ENV | BSTE_OS_ID | NUMBER | NULL | No | No |
| BODY_SHOP_TECHNICAL_ENV | BSTE_MODEM_SPEED_ID | NUMBER | NULL | No | No |
| BODY_SHOP_TECHNICAL_ENV | BSTE_EST_SYS_OTHER_FLAG | CHAR(1) | NULL | No | No |
| BODY_SHOP_TECHNICAL_ENV | BSTE_EST_SYS_OTHER_TEXT | VARCHAR2(50) | NULL | No | No |
| BODY_SHOP_TECHNICAL_ENV | BSTE_MGMT_SW_OTHER_FLAG | CHAR(1) | NULL | No | No |
| BODY_SHOP_TECHNICAL_ENV | BSTE_MGMT_SW_OTHER_TEXT | VARCHAR2(50) | NULL | No | No |
| BODY_SHOP_VALUE_PAIR | BSVP_BS_ID | NUMBER | NOT NULL | No | Yes |
| BODY_SHOP_VALUE_PAIR | BSVP_VAL_ID | NUMBER | NOT NULL | No | Yes |
| BODY_SHOP_VALUE_PAIR | BSVP_STATUS | CHAR(1) | NOT NULL | No | No |
| BS_IC_ASSOCIATION | BSIC_IC_ID | NUMBER | NOT NULL | No | Yes |
| BS_IC_ASSOCIATION | BSIC_BS_ID | NUMBER | NOT NULL | No | Yes |
| BS_IC_ASSOCIATION | BSIC_NAME | VARCHAR2(20) | NULL | No | No |
| BS_IC_ASSOCIATION | BSIC_DESCRIPTION | VARCHAR2(50) | NULL | No | No |
| BS_IC_ASSOCIATION | BSIC_STATUS | CHAR(1) | NOT NULL | No | No |
| BSAPPT_DAMAGE | BSAPPT_ID | NUMBER | NOT NULL | Yes | Yes |
| BSAPPT_DAMAGE | DAMAGE_CODE | CHAR(6) | NOT NULL | Yes | Yes |
| CAM_CAT | CAM_ITEMID | VARCHAR2(50) | NULL | No | No |
| CAM_CAT | CAM_CATEGORY | VARCHAR2(50) | NULL | No | No |
| CAM_CAT | CAM_TYPE | VARCHAR2(50) | NULL | No | No |
| CAM_CAT | CAM_ITEM | VARCHAR2(50) | NULL | No | No |
| CAM_CUSTOMER | CAM_COMPANYID | VARCHAR2(50) | NULL | No | No |
| CAM_CUSTOMER | CAM_TERRITORYID | VARCHAR2(50) | NULL | No | No |
| CAM_CUSTOMER | CAM_ITEMID | VARCHAR2(50) | NULL | No | No |
| CAM_EMPLOYEE | CAM_EMPLOYEEID | VARCHAR2(50) | NULL | No | No |
| CAM_EMPLOYEE | CAM_NAME | VARCHAR2(50) | NULL | No | No |
| CAM_EMPLOYEE | CAM_EMAIL | VARCHAR2(50) | NULL | No | No |
| CAM_EMPLOYEE | CAM_PHONE | VARCHAR2(50) | NULL | No | No |
| CAM_EMPLOYEE | CAM_FAX | VARCHAR2(50) | NULL | No | No |
| CAM_EMPLOYEE | CAM_PAGER | VARCHAR2(50) | NULL | No | No |
| CAM_SHOP | CAM_COMPANYID | VARCHAR2(50) | NULL | No | No |
| CAM_SHOP | CAM_TERRITORYID | VARCHAR2(50) | NULL | No | No |
| CAM_SHOP | CAM_NAME | VARCHAR2(50) | NULL | No | No |
| CAM_SHOP | CAM_CITY | VARCHAR2(50) | NULL | No | No |
| CAM_SHOP | CAM_POSTALCODE | VARCHAR2(50) | NULL | No | No |
| CAM_SHOP | CAM_ADDR1 | VARCHAR2(50) | NULL | No | No |
| CAM_SHOP | CAM_ADDR2 | VARCHAR2(50) | NULL | No | No |
| CAM_SHOP | CAM_COUNTY | VARCHAR2(50) | NULL | No | No |
| CAM_SHOP | CAM_PROVINCE | VARCHAR2(50) | NULL | No | No |
| CAM_SHOP | CAM_COUNTRY | VARCHAR2(50) | NULL | No | No |
| CAM_SHOP | CAM_TYPE | VARCHAR2(50) | NULL | No | No |
| CAM_SHOP | CAM_PHONEAREA | VARCHAR2(50) | NULL | No | No |
| CAM_SHOP | CAM_PHONE | VARCHAR2(50) | NULL | No | No |
| CAM_SHOP | CAM_FAXAREA | VARCHAR2(50) | NULL | No | No |
| CAM_SHOP | CAM_FAX | VARCHAR2(50) | NULL | No | No |
| CAM_SHOP | CAM_SHOPRATING | VARCHAR2(50) | NULL | No | No |
| CAM_SHOP | CAM_EMAIL | VARCHAR2(50) | NULL | No | No |
| CAM_SHOP | CAM_HOMEPAGE | VARCHAR2(256) | NULL | No | No |
| CAM_SHOP | CAM_INGCONTROLNUMBER | VARCHAR2(50) | NULL | No | No |
| CAM_SHOP | CAM_DELETED | NUMBER | NULL | No | No |
| CAM_SHOPSUPPLIER | CAM_COMPANYID | VARCHAR2(50) | NULL | No | No |
| CAM_SHOPSUPPLIER | CAM_ITEMID | VARCHAR2(50) | NULL | No | No |
| CAM_SHOPSUPPLIER | CAM_SUPPLIERID | VARCHAR2(50) | NULL | No | No |
| CAM_SHOPSUPPLIER | CAM_DISCOUNT | VARCHAR2(50) | NULL | No | No |
| CAM_SHOPSUPPLIER | CAM_VOLUME | VARCHAR2(50) | NULL | No | No |
| CAM_SHOPSUPPLIER | CAM_LEVEL | VARCHAR2(50) | NULL | No | No |
| CAM_SHOPSUPPLIER | CAM_INFODATE | DATE | NULL | No | No |
| CAM_SHOPSUPPLIER | CAM_COMMENTS | VARCHAR2(2000) | NULL | No | No |
| CAM_SHOPSUPPLIER | CAM_EMPLOYEEID | VARCHAR2(50) | NULL | No | No |
| CAM_SHOPSUPPLIER | CAM_SID | VARCHAR2(50) | NULL | No | No |
| CAM_SHOPSUPPLIER_TEST | CAM_COMPANYID | VARCHAR2(50) | NULL | No | No |
| CAM_SHOPSUPPLIER_TEST | CAM_ITEMID | VARCHAR2(50) | NULL | No | No |
| CAM_SHOPSUPPLIER_TEST | CAM_SUPPLIERID | VARCHAR2(50) | NULL | No | No |
| CAM_SHOPSUPPLIER_TEST | CAM_DISCOUNT | VARCHAR2(50) | NULL | No | No |
| CAM_SHOPSUPPLIER_TEST | CAM_VOLUME | VARCHAR2(50) | NULL | No | No |
| CAM_SHOPSUPPLIER_TEST | CAM_LEVEL | VARCHAR2(50) | NULL | No | No |
| CAM_SHOPSUPPLIER_TEST | CAM_INFODATE | VARCHAR2(20) | NULL | No | No |
| CAM_SHOPSUPPLIER_TEST | CAM_COMMENTS | VARCHAR2(2000) | NULL | No | No |
| CAM_SHOPSUPPLIER_TEST | CAM_EMPLOYEEID | VARCHAR2(50) | NULL | No | No |
| CAM_SHOPSUPPLIER_TEST | CAM_SD | VARCHAR2(50) | NULL | No | No |
| CAM_TERRITORY | CAM_TERRITORYID | VARCHAR2(50) | NULL | No | No |
| CAM_TERRITORY | CAM_COUNTRY | VARCHAR2(50) | NULL | No | No |
| CAM_TERRITORY | CAM_ZONE | VARCHAR2(50) | NULL | No | No |
| CAM_TERRITORY | CAM_MARKET | VARCHAR2(50) | NULL | No | No |
| CAM_TOUCH | CAM_TOUCHID | VARCHAR2(50) | NULL | No | No |
| CAM_TOUCH | CAM_COMPANYID | VARCHAR2(50) | NULL | No | No |
| CAM_TOUCH | CAM_DATE | DATE | NULL | No | No |
| CAM_TOUCH | CAM_TIME | DATE | NULL | No | No |
| CAM_TOUCH | CAM_TYPE | VARCHAR2(50) | NULL | No | No |
| CAM_TOUCH | CAM_CONTACT | VARCHAR2(50) | NULL | No | No |
| CAM_TOUCH | CAM_ITEMID | VARCHAR2(50) | NULL | No | No |
| CAM_TOUCH | CAM_SHOPID | VARCHAR2(50) | NULL | No | No |
| CAM_TOUCH | CAM_EMPLOYEEID | VARCHAR2(50) | NULL | No | No |
| CAM_TOUCH | CAM_COMMENTS | VARCHAR2(1000) | NULL | No | No |
| CAM_TOUCH_TEST | CAM_TOUCHID | VARCHAR2(50) | NULL | No | No |
| CAM_TOUCH_TEST | CAM_COMPANYID | VARCHAR2(50) | NULL | No | No |
| CAM_TOUCH_TEST | CAM_DATE | VARCHAR2(20) | NULL | No | No |
| CAM_TOUCH_TEST | CAM_TIME | VARCHAR2(20) | NULL | No | No |
| CAM_TOUCH_TEST | CAM_TYPE | VARCHAR2(50) | NULL | No | No |
| CAM_TOUCH_TEST | CAM_CONTACT | VARCHAR2(50) | NULL | No | No |
| CAM_TOUCH_TEST | CAM_ITEMID | VARCHAR2(50) | NULL | No | No |
| CAM_TOUCH_TEST | CAM_SHOPID | VARCHAR2(50) | NULL | No | No |
| CAM_TOUCH_TEST | CAM_EMPLOYEEID | VARCHAR2(50) | NULL | No | No |
| CAM_TOUCH_TEST | CAM_COMMENTS | VARCHAR2(1000) | NULL | No | No |
| CAM_VENDOR | CAM_COMPANYID | VARCHAR2(50) | NULL | No | No |
| CAM_VENDOR | CAM_TERRITORYID | VARCHAR2(50) | NULL | No | No |
| CAM_VENDOR | CAM_NAME | VARCHAR2(50) | NULL | No | No |
| CAM_VENDOR | CAM_CITY | VARCHAR2(50) | NULL | No | No |
| CAM_VENDOR | CAM_POSTALCODE | VARCHAR2(50) | NULL | No | No |
| CAM_VENDOR | CAM_ADDR1 | VARCHAR2(50) | NULL | No | No |
| CAM_VENDOR | CAM_ADDR2 | VARCHAR2(50) | NULL | No | No |
| CAM_VENDOR | CAM_COUNTY | VARCHAR2(50) | NULL | No | No |
| CAM_VENDOR | CAM_PROVINCE | VARCHAR2(50) | NULL | No | No |
| CAM_VENDOR | CAM_COUNTRY | VARCHAR2(50) | NULL | No | No |
| CAM_VENDOR | CAM_TYPE | VARCHAR2(50) | NULL | No | No |
| CAM_VENDOR | CAM_PHONEAREA | VARCHAR2(50) | NULL | No | No |
| CAM_VENDOR | CAM_PHONE | VARCHAR2(50) | NULL | No | No |
| CAM_VENDOR | CAM_FAXAREA | VARCHAR2(50) | NULL | No | No |
| CAM_VENDOR | CAM_FAX | VARCHAR2(50) | NULL | No | No |
| CAM_VENDOR | CAM_SHOPRATING | VARCHAR2(50) | NULL | No | No |
| CAM_VENDOR | CAM_EMAIL | VARCHAR2(50) | NULL | No | No |
| CAM_VENDOR | CAM_HOMEPAGE | VARCHAR2(256) | NULL | No | No |
| CAM_VENDOR | CAM_INGCONTROLNUMBER | VARCHAR2(50) | NULL | No | No |
| CAM_VENDOR | CAM_DELETED | NUMBER | NULL | No | No |
| CAM_VENDOR | CAM_PV_ID | NUMBER | NULL | No | No |
| CARSTATION | CAR_ID | NUMBER | NOT NULL | Yes | No |
| CARSTATION | CAR_BRANCH_NAME | VARCHAR2(30) | NULL | No | No |
| CARSTATION_IMAGE | IMG_ID | NUMBER | NOT NULL | Yes | No |
| CARSTATION_IMAGE | IMG_COMPANY_ID | NUMBER | NULL | No | No |
| CARSTATION_IMAGE | IMG_CT_CODE | VARCHAR2(4) | NULL | No | Yes |
| CARSTATION_IMAGE | IMG_FILE_NAME | VARCHAR2(255) | NULL | No | No |
| CARSTATION_IMAGE | IMG_IMAGE | LONG RAW | NULL | No | No |
| CARSTATION_IMAGE | IMG_IMGT_ID | NUMBER | NULL | No | Yes |
| CARSTATION_ORDER | OR_ID | NUMBER | NOT NULL | Yes | No |
| CARSTATION_ORDER | OR_BS_ID | NUMBER | NULL | No | Yes |
| CARSTATION_ORDER | OR_IC_ID | NUMBER | NULL | No | Yes |
| CARSTATION_ORDER | OR_VI_ID | NUMBER | NULL | No | Yes |
| CARSTATION_ORDER | OR_ENVELOPE_ID | NUMBER | NULL | No | Yes |
| CARSTATION_ORDER | OR_USR_ID | NUMBER | NOT NULL | No | Yes |
| CARSTATION_ORDER | OR_DRP_ID | NUMBER | NULL | No | Yes |
| CARSTATION_ORDER | OR_UPLOAD_DATE | DATE | NULL | No | No |
| CARSTATION_ORDER | OR_COMMENTS | VARCHAR2(100) | NULL | No | No |
| CARSTATION_ORDER | OR_ESTIMATE_DATE | DATE | NULL | No | No |
| CARSTATION_ORDER | OR_CUSTOMER_FIRST_NAME | VARCHAR2(35) | NULL | No | No |
| CARSTATION_ORDER | OR_CUSTOMER_LAST_NAME | VARCHAR2(35) | NULL | No | No |
| CARSTATION_ORDER | OR_RO_NUMBER | VARCHAR2(20) | NULL | No | No |
| CARSTATION_ORDER | OR_ESTIMATOR_FIRST_NAME | VARCHAR2(35) | NULL | No | No |
| CARSTATION_ORDER | OR_ESTIMATOR_LAST_NAME | VARCHAR2(35) | NULL | No | No |
| CARSTATION_ORDER | OR_OPEN_FLAG | CHAR(1) | NULL | No | No |
| CARSTATION_ORDER | OR_SUPPLEMENT_NUMBER | NUMBER(2) | NULL | No | No |
| CARSTATION_ORDER | OR_BODY_SHOP_FLAG | CHAR(1) | NULL | No | No |
| CARSTATION_ORDER | OR_PARTS_ID | NUMBER | NULL | No | No |
| CARSTATION_ORDER | UNQFILE_ID | VARCHAR2(8) | NULL | No | No |
| CARSTATION_ORDER | OR_OH_ID | NUMBER | NULL | No | No |
| CARSTATION_USER | USR_ID | NUMBER | NOT NULL | Yes | No |
| CARSTATION_USER | USR_COMPANY_ID | NUMBER | NOT NULL | No | No |
| CARSTATION_USER | USR_CT_CODE | VARCHAR2(4) | NOT NULL | No | Yes |
| CARSTATION_USER | USR_USRR_CODE | VARCHAR2(4) | NOT NULL | No | Yes |
| CARSTATION_USER | USR_FIRST_NAME | VARCHAR2(35) | NULL | No | No |
| CARSTATION_USER | USR_LAST_NAME | VARCHAR2(35) | NULL | No | No |
| CARSTATION_USER | USR_SOCIAL_TITLE | VARCHAR2(35) | NULL | No | No |
| CARSTATION_USER | USR_USER_NAME | VARCHAR2(50) | NULL | No | No |
| CARSTATION_USER | USR_PASSWORD | VARCHAR2(20) | NULL | No | No |
| CATALOG | CATL_ID | NUMBER | NOT NULL | Yes | No |
| CATALOG | CATL_PT_ID | NUMBER | NULL | No | No |
| CATALOG | CATL_NAME | VARCHAR2(50) | NULL | No | No |
| CATALOG_MAKE_MAP | CMM_ID | NUMBER | NOT NULL | Yes | No |
| CATALOG_MAKE_MAP | CMM_ST_ID | NUMBER | NULL | No | No |
| CATALOG_MAKE_MAP | CMM_SM_ID | NUMBER | NULL | No | No |
| CATALOG_MAKE_MAP | CMM_MK_ID | NUMBER | NULL | No | No |
| CATALOG_MAKE_VENDOR | CMV_PV_ID | NUMBER | NULL | No | No |
| CATALOG_MAKE_VENDOR | CMV_CATL_ID | NUMBER | NULL | No | No |
| CATALOG_MAKE_VENDOR | CMV_SM_ID | NUMBER | NULL | No | No |
| CATALOG_MAKE_VENDOR | CMV_VENDOR_PREF | NUMBER | NULL | No | No |
| CITIES | CITY_ID | NUMBER | NOT NULL | Yes | No |
| CITIES | CITY_NAME | VARCHAR2(28) | NOT NULL | No | No |
| CITIES | STATE_ID | NUMBER | NOT NULL | No | Yes |
| COBRAND_COMPANY | CC_ID | NUMBER | NULL | No | No |
| COBRAND_COMPANY | CC_COMPANY_NAME | VARCHAR2(50) | NULL | No | No |
| COBRAND_COMPANY | CC_SHORT_NAME | VARCHAR2(20) | NULL | No | No |
| COBRAND_COMPANY | CC_NICK_NAME | VARCHAR2(20) | NULL | No | No |
| COBRAND_COMPANY_TO_BODY_SHOP | CCBS_CC_ID | NUMBER | NULL | No | No |
| COBRAND_COMPANY_TO_BODY_SHOP | CCBS_SL_ID | NUMBER | NULL | No | No |
| COBRAND_COMPANY_TO_BODY_SHOP | CCBS_ORIGIN_ID | VARCHAR2(20) | NULL | No | No |
| COMPANY_TYPE | CT_CODE | VARCHAR2(4) | NOT NULL | Yes | No |
| COMPANY_TYPE | CT_NAME | VARCHAR2(20) | NOT NULL | No | No |
| CONTACT | CN_ID | NUMBER | NOT NULL | Yes | No |
| CONTACT | CN_CNT_ID | NUMBER | NOT NULL | No | Yes |
| CONTACT | CN_COMPANY_ID | NUMBER | NOT NULL | No | No |
| CONTACT | CN_CT_CODE | VARCHAR2(4) | NOT NULL | No | Yes |
| CONTACT | CN_FIRST_NAME | VARCHAR2(50) | NULL | No | No |
| CONTACT | CN_LAST_NAME | VARCHAR2(50) | NULL | No | No |
| CONTACT | CN_STATUS | CHAR(1) | NOT NULL | No | No |
| CONTACT_TYPE | CNT_ID | NUMBER | NOT NULL | Yes | No |
| CONTACT_TYPE | CNT_TYPE | VARCHAR2(20) | NOT NULL | No | No |
| CONTENT | CON_DESCRIPTIVE_CODE | VARCHAR2(25) | NOT NULL | Yes | No |
| CONTENT | CON_TEXT | VARCHAR2(4000) | NULL | No | No |
| CONTENT | CON_COMMENTS | VARCHAR2(1000) | NULL | No | No |
| CONTENT | CON_TITLE | VARCHR2(50) | NULL | No | No |
| CONTRIBUTOR | ARA_ID | NUMBER(10) | NOT NULL | No | No |
| CONTRIBUTOR | CONTRIBUTOR_ACTIVE | NUMBER(1) | NOT NULL | No | No |
| CONTRIBUTOR | MEMBER_ID | VARCHAR2(10) | NOT NULL | No | No |
| CONTRIBUTOR | ACCOUNT_ID | VARCHAR2(4) | NOT NULL | No | No |
| CONTRIBUTOR | MEMBER_SYSTEM_ID | NUMBER(1) | NOT NULL | No | No |
| CONTRIBUTOR | CONTRIBUTOR_NAME | VARCHAR2(50) | NULL | No | No |
| CONTRIBUTOR | CONTACT1_FIRST_NAME | VARCHAR2(25) | NULL | No | No |
| CONTRIBUTOR | CONTACT1_LAST_NAME | VARCHAR2(25) | NULL | No | No |
| CONTRIBUTOR | CONTACT2_FIRST_NAME | VARCHAR2(25) | NULL | No | No |
| CONTRIBUTOR | CONTACT2_LAST_NAME | VARCHAR2(25) | NULL | No | No |
| CONTRIBUTOR | ADDRESS1 | VARCHAR2(30) | NULL | No | No |
| CONTRIBUTOR | ADDRESS2 | VARCHAR2(30) | NULL | No | No |
| CONTRIBUTOR | CITY | VARCHAR2(25) | NULL | No | No |
| CONTRIBUTOR | STATE | CHAR(2) | NULL | No | No |
| CONTRIBUTOR | ZIP_CODE | VARCHAR2(10) | NULL | No | No |
| CONTRIBUTOR | COUNTRY | VARCHAR2(25) | NULL | No | No |
| CONTRIBUTOR | TOLL_FREE_PHONE | VARCHAR2(11) | NULL | No | No |
| CONTRIBUTOR | LOCAL_PHONE | VARCHAR2(11) | NULL | No | No |
| CONTRIBUTOR | FAX_PHONE | VARCHAR2(11) | NULL | No | No |
| CONTRIBUTOR | PRICE_FLAG | CHAR(1) | NOT NULL | No | No |
| CONTRIBUTOR | GOLD_SEAL_CERTIFIED | NUMBER(1) | NOT NULL | No | No |
| CONTRIBUTOR | CAR_CERTIFIED | NUMBER(1) | NOT NULL | No | No |
| CONTRIBUTOR | CAR_STATUS | VARCHAR2(3) | NULL | No | No |
| CONTRIBUTOR | LATITUDE | NUMBER(7,4) | NULL | No | No |
| CONTRIBUTOR | LONGITUDE | NUMBER(8,4) | NULL | No | No |
| CONTRIBUTOR | E_MAIL | VARCHAR2(50) | NULL | No | No |
| CONTRIBUTOR | WWW_ADDRESS | VARCHAR2(50) | NULL | No | No |
| CONTRIBUTOR_BACKUP | ARA_ID | NUMBER(10) | NOT NULL | No | No |
| CONTRIBUTOR_BACKUP | CONTRIBUTOR_ACTIVE | NUMBER(1) | NOT NULL | No | No |
| CONTRIBUTOR_BACKUP | MEMBER_ID | VARCHAR2(10) | NOT NULL | No | No |
| CONTRIBUTOR_BACKUP | ACCOUNT_ID | VARCHAR2(4) | NOT NULL | No | No |
| CONTRIBUTOR_BACKUP | MEMBER_SYSTEM_ID | NUMBER(1) | NOT NULL | No | No |
| CONTRIBUTOR_BACKUP | CONTRIBUTOR_NAME | VARCHAR2(50) | NULL | No | No |
| CONTRIBUTOR_BACKUP | CONTACT1_FIRST_NAME | VARCHAR2(25) | NULL | No | No |
| CONTRIBUTOR_BACKUP | CONTACT1_LAST_NAME | VARCHAR2(25) | NULL | No | No |
| CONTRIBUTOR_BACKUP | CONTACT2_FIRST_NAME | VARCHAR2(25) | NULL | No | No |
| CONTRIBUTOR_BACKUP | CONTACT2_LAST_NAME | VARCHAR2(25) | NULL | No | No |
| CONTRIBUTOR_BACKUP | ADDRESS1 | VARCHAR2(30) | NULL | No | No |
| CONTRIBUTOR_BACKUP | ADDRESS2 | VARCHAR2(30) | NULL | No | No |
| CONTRIBUTOR_BACKUP | CITY | VARCHAR2(25) | NULL | No | No |
| CONTRIBUTOR_BACKUP | STATE | CHAR2(2) | NULL | No | No |
| CONTRIBUTOR_BACKUP | ZIP_CODE | VARCHAR2(10) | NULL | No | No |
| CONTRIBUTOR_BACKUP | COUNTRY | VARCHAR2(25) | NULL | No | No |
| CONTRIBUTOR_BACKUP | TOLL_FREE_PHONE | VARCHAR2(11) | NULL | No | No |
| CONTRIBUTOR_BACKUP | LOCAL_PHONE | VARCHAR2(11) | NULL | No | No |
| CONTRIBUTOR_BACKUP | FAX_PHONE | VARCHAR2(11) | NULL | No | No |
| CONTRIBUTOR_BACKUP | PRICE_FLAG | CHAR(1) | NOT NULL | No | No |
| CONTRIBUTOR_BACKUP | GOLD_SEAL_CERTIFIED | NUMBER(1) | NOT NULL | No | No |
| CONTRIBUTOR_BACKUP | CAR_CERTIFIED | NUMBER(1) | NOT NULL | No | No |
| CONTRIBUTOR_BACKUP | CAR_STATUS | VARCHAR2(3) | NULL | No | No |
| CONTRIBUTOR_BACKUP | LATITUDE | NUMBER(7,4) | NULL | No | No |
| CONTRIBUTOR_BACKUP | LONGITUDE | NUMBER(8,4) | NULL | No | No |
| CONTRIBUTOR_BACKUP | E_MAIL | VARCHAR2(50) | NULL | No | No |
| CONTRIBUTOR_BACKUP | WWW_ADDRESS | VARCHAR2(50) | NULL | No | No |
| COUNTIES | COUNTY_ID | NUMBER | NOT NULL | Yes | No |
| COUNTIES | COUNTY_CODE | VARCHAR2(5) | NULL | No | No |
| COUNTIES | COUNTY_NAME | VARCHAR2(25) | NOT NULL | No | No |
| COUNTIES | STATE_ID | NUMBER | NOT NULL | No | Yes |
| COUNTRIES | COUNTRY_ID | NUMBER | NOT NULL | Yes | No |
| COUNTRIES | COUNTRY_NAME | VARCHAR2(20) | NOT NULL | No | No |
| CSI | BS_ID | NUMBER | NULL | No | No |
| CSI | MONTH | DATE | NULL | No | No |
| CSI | NUM_INTERVIEWS | NUMBER(12,4) | NULL | No | No |
| CSI | SHOP_QUALITY | NUMBER(12,4) | NULL | No | No |
| CSI | SHOP_SERVICE | NUMBER(12,4) | NULL | No | No |
| CSI | REFER_SHOP | NUMBER(12,4) | NULL | No | No |
| CSI | ON_TIME | NUMBER(12,4) | NULL | No | No |
| CSI | INSURANCE_SERVICE | NUMBER(12,4) | NULL | No | No |
| CSI | REFER_INSURER | NUMBER(12,4) | NULL | No | No |
| DAY_OF_WEEK | DOW_ID | NUMBER | NOT NULL | No | No |
| DAY_OF_WEEK | DOW_NAME | VARCHAR2(20) | NULL | No | No |
| DEALER_FRANCHISE | DF_COMPANY_ID | VARCHAR2(20) | NULL | No | No |
| DEALER_FRANCHISE | DF_ITEM_ID | NUMBER | NULL | No | No |
| DEALER_FRANCHISE | DF_DATE_MODIFIED | DATE | NULL | No | No |
| DEALER_FRANCHISE_TEST | DF_COMPANY_ID | VARCHAR2(20) | NULL | No | No |
| DEALER_FRANCHISE_TEST | DF_ITEM_ID | NUMBER | NULL | No | No |
| DEALER_FRANCHISE_TEST | DF_DATE_MODIFIED | VARCHAR2(30) | NULL | No | No |
| DETAIL | ID | NUMBER | NOT NULL | Yes | No |
| DETAIL | ENVELOPE ID | NUMBER | NULL | No | Yes |
| DETAIL | DELETED | CHAR(1) | NULL | No | No |
| DETAIL | LINE_NO | NUMBER | NULL | No | No |
| DETAIL | LINE_IND | VARCHAR2(3) | NULL | No | No |
| DETAIL | LINE_REF | NUMBER | NULL | No | No |
| DETAIL | TRAN_CODE | VARCHAR2(1) | NULL | No | No |
| DETAIL | DB_REF | VARCHAR2(7) | NULL | No | No |
| DETAIL | UNQ_SEQ | VARCHAR2(4) | NULL | No | No |
| DETAIL | WHO_PAYS | VARCHAR2(2) | NULL | No | No |
| DETAIL | LINE_DESC | VARCHAR2(40) | NULL | No | No |
| DETAIL | PART_TYPE | VARCHAR2(4) | NULL | No | No |
| DETAIL | PART_DES_J | CHAR(1) | NULL | No | No |
| DETAIL | GLASS_FLAG | CHAR(1) | NULL | No | No |
| DETAIL | OEM_PARTNO | VARCHAR2(25) | NULL | No | No |
| DETAIL | PRICE_INC | CHAR(1) | NULL | No | No |
| DETAIL | ALT_PART_I | CHAR(1) | NULL | No | No |
| DETAIL | TAX_PART | CHAR(1) | NULL | No | No |
| DETAIL | DB_PRICE | NUMBER(22,2) | NULL | No | No |
| DETAIL | ACT_PRICE | NUMBER(22,2) | NULL | No | No |
| DETAIL | PRICE_J | CHAR(1) | NULL | No | No |
| DETAIL | CERT_PART | CHAR(1) | NULL | No | No |
| DETAIL | PART_QTY | NUMBER | NULL | No | No |
| DETAIL | ALT_CO_ID | VARCHAR2(20) | NULL | No | No |
| DETAIL | ALT_PARTNO | VARCHAR2(25) | NULL | No | No |
| DETAIL | ALT_OVERRD | CHAR(1) | NULL | No | No |
| DETAIL | ALT_PARTM | VARCHAR2(45) | NULL | No | No |
| DETAIL | PRT_DSMK_P | NUMBER(22,2) | NULL | No | No |
| DETAIL | PRT_DSMK_M | NUMBER(22,2) | NULL | No | No |
| DETAIL | MOD_LBR_TY | VARCHAR2(4) | NULL | No | No |
| DETAIL | DB_HRS | NUMBER(22,1) | NULL | No | No |
| DETAIL | MOD_LB_HRS | NUMBER(22,1) | NULL | No | No |
| DETAIL | LBR_INC | CHAR(1) | NULL | No | No |
| DETAIL | LBR_OP | VARCHAR2(4) | NULL | No | No |
| DETAIL | LBR_HRS_J | CHAR(1) | NULL | No | No |
| DETAIL | LBR_TYP_J | CHAR(1) | NULL | No | No |
| DETAIL | LBR_OP_J | CHAR(1) | NULL | No | No |
| DETAIL | PAINT_STG | NUMBER | NULL | No | No |
| DETAIL | PAINT_TONE | NUMBER | NULL | No | No |
| DETAIL | LBR_TAX | CHAR(1) | NULL | No | No |
| DETAIL | LBR_AMT | NUMBER(22,2) | NULL | No | No |
| DETAIL | MISC_AMT | NUMBER(22,2) | NULL | No | No |
| DETAIL | MISC_SUBLT | CHAR(1) | NULL | No | No |
| DETAIL | MISC_TAX | CHAR(1) | NULL | No | No |
| DETAIL | BETT_TYPE | VARCHAR2(4) | NULL | No | No |
| DETAIL | BETT_PCTG | NUMBER(22,4) | NULL | No | No |
| DETAIL | BETT_AMT | NUMBER(22,2) | NULL | No | No |
| DETAIL | BETT_TAX | CHAR(1) | NULL | No | No |
| DETAIL_BKUP | ID | NUMBER | NOT NULL | No | No |
| DETAIL_BKUP | ENVELOPE_ID | NUMBER | NULL | No | No |
| DETAIL_BKUP | DELETED | CHAR(1) | NULL | No | No |
| DETAIL_BKUP | LINE_NO | NUMBER | NULL | No | No |
| DETAIL_BKUP | LINE_IND | VARCHAR2(3) | NULL | No | No |
| DETAIL_BKUP | LINE_REF | NUMBER | NULL | No | No |
| DETAIL_BKUP | TRAN_CODE | VARCHAR2(1) | NULL | No | No |
| DETAIL_BKUP | DB_REF | VARCHAR2(7) | NULL | No | No |
| DETAIL_BKUP | UNQ_SEQ | VARCHAR2(4) | NULL | No | No |
| DETAIL_BKUP | WHO_PAYS | VARCHAR2(2) | NULL | No | No |
| DETAIL_BKUP | LINE_DESC | VARCHAR2(40) | NULL | No | No |
| DETAIL_BKUP | PART_TYPE | VARCHAR2(4) | NULL | No | No |
| DETAIL_BKUP | PART_DES_J | CHAR(1) | NULL | No | No |
| DETAIL_BKUP | GLASS_FLAG | CHAR(1) | NULL | No | No |
| DETAIL_BKUP | OEM_PARTNO | VARCHAR2(25) | NULL | No | No |
| DETAIL_BKUP | PRICE_INC | CHAR(1) | NULL | No | No |
| DETAIL_BKUP | ALT_PART_I | CHAR(1) | NULL | No | No |
| DETAIL_BKUP | TAX_PART | CHAR(1) | NULL | No | No |
| DETAIL_BKUP | DB_PRICE | NUMBER(22,2) | NULL | No | No |
| DETAIL_BKUP | ACT_PRICE | NUMBER(22,2) | NULL | No | No |
| DETAIL_BKUP | PRICE_J | CHAR(1) | NULL | No | No |
| DETAIL_BKUP | CERT_PART | CHAR(1) | NULL | No | No |
| DETAIL_BKUP | PART_QTY | NUMBER | NULL | No | No |
| DETAIL_BKUP | ALT_CO_ID | VARCHAR2(20) | NULL | No | No |
| DETAIL_BKUP | ALT_PARTNO | VARCHAR2(25) | NULL | No | No |
| DETAIL_BKUP | ALT_OVERRD | CHAR(1) | NULL | No | No |
| DETAIL_BKUP | ALT_PARTM | VARCHAR2(45) | NULL | No | No |
| DETAIL_BKUP | PRT_DSMK_P | NUMBER(22,2) | NULL | No | No |
| DETAIL_BKUP | PRT_DSMK_M | NUMBER(22,2) | NULL | No | No |
| DETAIL_BKUP | MOD_LBR_TY | VARCHAR2(4) | NULL | No | No |
| DETAIL_BKUP | DB_HRS | NUMBER(22,1) | NULL | No | No |
| DETAIL_BKUP | MOD_LB_HRS | NUMBER(22,1) | NULL | No | No |
| DETAIL_BKUP | LBR_INC | CHAR(1) | NULL | No | No |
| DETAIL_BKUP | LBR_OP | VARCHAR2(4) | NULL | No | No |
| DETAIL_BKUP | LBR_HRS_J | CHAR(1) | NULL | No | No |
| DETAIL_BKUP | LBR_TYP_J | CHAR(1) | NULL | No | No |
| DETAIL_BKUP | LBR_OP_J | CHAR(1) | NULL | No | No |
| DETAIL_BKUP | PAINT_STG | NUMBER | NULL | No | No |
| DETAIL_BKUP | PAINT_TONE | NUMBER | NULL | No | No |
| DETAIL_BKUP | LBR_TAX | CHAR(1) | NULL | No | No |
| DETAIL_BKUP | LBR_AMT | NUMBER(22,2) | NULL | No | No |
| DETAIL_BKUP | MISC_AMT | NUMBER(22,2) | NULL | No | No |
| DETAIL_BKUP | MISC_SUBLT | CHAR(1) | NULL | No | No |
| DETAIL_BKUP | MISC_TAX | CHAR(1) | NULL | No | No |
| DETAIL_BKUP | BETT_TYPE | VARCHAR2(4) | NULL | No | No |
| DETAIL_BKUP | BETT_PCTG | NUMBER(22,4) | NULL | No | No |
| DETAIL_BKUP | BETT_AMT | NUMBER(22,2) | NULL | No | No |
| DETAIL_BKUP | BETT_TAX | CHAR(1) | NULL | No | No |
| DRP_GUIDELINE | DRP_ID | NUMBER | NOT NULL | Yes | No |
| DRP_GUIDELINE | DRP_PROGRAM | VARCHAR2(50) | NULL | No | No |
| DRP_GUIDELINE | DRP_TEXT | VARCHAR2(2000) | NULL | No | No |
| DRP_GUIDELINE | DRP_DISPLAY_NAME | VARCHAR2(30) | NULL | No | No |
| DRP_GUIDELINE | DRP_NAME | VARCHAR2(20) | NULL | No | No |
| DRP_GUIDELINE | DRP_IC_ID | NUMBER | NULL | No | No |
| EMAIL_ADDRESS | EA_ID | NUMBER | NOT NULL | Yes | No |
| EMAIL_ADDRESS | EA_EAT_ID | NUMBER | NOT NULL | No | Yes |
| EMAIL_ADDRESS | EA_CT_CODE | VARCHAR2(4) | NOT NULL | No | Yes |
| EMAIL_ADDRESS | EA_COMPANY_ID | NUMBER | NOT NULL | No | No |
| EMAIL_ADDRESS | EA_ADDRESS | VARCHAR2(80) | NULL | No | No |
| EMAIL_ADDRESS_TYPE | EAT_ID | NUMBER | NOT NULL | Yes | No |
| EMAIL_ADDRESS_TYPE | EAT_TYPE | VARCHAR2(20) | NOT NULL | No | No |
| EMAIL_INFO | EI_ID | NUMBER | NOT NULL | Yes | No |
| EMAIL_INFO | EI_SUBJECT | VARCHAR2(150) | NULL | No | No |
| EMAIL_INFO | EI_BODY | VARCHAR2(4000) | NULL | No | No |
| EMAIL_INFO | EI_SEND_DATE | DATE | NULL | No | No |
| EMAIL_INFO | EI_FROM_ADDRESS | VARCHAR2(80) | NULL | No | No |
| EMAIL_INFO | EI_TO_ADDRESS | VARCHAR2(80) | NULL | No | No |
| EMAIL_INFO | EI_USR_TO_ID | NUMBER | NULL | No | Yes |
| EMAIL_STORAGE | ESTO_ID | NUMBER | NOT NULL | Yes | No |
| EMAIL_STORAGE | ESTO_NAME | VARCHAR2(20) | NULL | No | No |
| EMAIL_STORAGE | ESTO_SUBJECT | VARCHAR2(100) | NULL | No | No |
| EMAIL_STORAGE | ESTO_TEXT | VARCHAR2(1000) | NULL | No | No |
| ENVELOPE | ID | NUMBER | NOT NULL | Yes | No |
| ENVELOPE | BODY_SHOP_ID | NUMBER | NULL | No | Yes |
| ENVELOPE | EST_SYSTEM | CHAR(1) | NULL | No | No |
| ENVELOPE | SW_VERSION | VARCHAR2(10) | NULL | No | No |
| ENVELOPE | DB_VERSION | VARCHAR2(12) | NULL | No | No |
| ENVELOPE | DB_DATE | DATE | NULL | No | No |
| ENVELOPE | UNQFILE_ID | VARCHAR2(8) | NULL | No | No |
| ENVELOPE | RO_ID | VARCHAR2(8) | NULL | No | No |
| ENVELOPE | ESTFILE_ID | VARCHAR2(38) | NULL | No | No |
| ENVELOPE | SUPP_NO | VARCHAR2(3) | NULL | No | No |
| ENVELOPE | EST_CTRY | VARCHAR2(3) | NULL | No | No |
| ENVELOPE | TOP_SECRET | VARCHAR2(80) | NULL | No | No |
| ENVELOPE | H_TRANS_ID | VARCHAR2(9) | NULL | No | No |
| ENVELOPE | H_CTRL_NO | VARCHAR2(9) | NULL | No | No |
| ENVELOPE | TRANS_TYPE | VARCHAR2(1) | NULL | No | No |
| ENVELOPE | STATUS | CHAR(1) | NULL | No | No |
| ENVELOPE | CREATE_DT | DATE | NULL | No | No |
| ENVELOPE | CREATE_TM | VARCHAR2(15) | NULL | No | No |
| ENVELOPE | TRANSMT_DT | DATE | NULL | No | No |
| ENVELOPE | TRANSMT_TM | VARCHAR2(6) | NULL | No | No |
| ENVELOPE | INCL_ADMIN | CHAR(1) | NULL | No | No |
| ENVELOPE | INCL_VEH | CHAR(1) | NULL | No | No |
| ENVELOPE | INCL_EST | CHAR(1) | NULL | No | No |
| ENVELOPE | INCL_PROFL | CHAR(1) | NULL | No | No |
| ENVELOPE | INCL_TOTAL | CHAR(1) | NULL | No | No |
| ENVELOPE | INCL_VENDR | CHAR(1) | NULL | No | No |
| ENVELOPE | EMS_VER | VARCHAR2(5) | NULL | No | No |
| EVENT | EV_ID | NUMBER | NOT NULL | Yes | No |
| EVENT | EV_DESCRIPTION | VARCHAR2(250) | NULL | No | No |
| HELP | HP_DESCRIPTIVE_CODE | VARCHAR2(50) | NOT NULL | No | No |
| HELP | HP_TITLE | VARCHAR2(50) | NOT NULL | No | No |
| HELP | HP_TEXT | VARCHAR2(4000) | NOT NULL | No | No |
| HELP | HP_HPL_CODE | VARCHAR2(4) | NULL | No | Yes |
| HELP | HP_COMMENTS | VARCHAR2(100) | NULL | No | No |
| HELP_LEVEL | HPL_CODE | VARCHAR2(4) | NOT NULL | Yes | No |
| HELP_LEVEL | HPL_LEVEL | VARCHAR2(20) | NULL | No | No |
| HELP_OLD | HP_DESCRIPTIVE_CODE | VARCHAR2(50) | NOT NULL | No | No |
| HELP_OLD | HP_TITLE | VARCHAR2(50) | NOT NULL | No | No |
| HELP_OLD | HP_TEXT | VARCHAR2(4000) | NOT NULL | No | No |
| HELP_OLD | HP_HPL_CODE | VARCHAR2(4) | NULL | No | Yes |
| HELP_OLD | HP_COMMENTS | VARCHAR2(100) | NULL | No | No |
| IC_PREFERENCE_PAIR | ICPP_ID | NUMBER | NOT NULL | Yes | No |
| IC_PREFERENCE_PAIR | ICPP_IC_ID | NUMBER | NOT NULL | No | Yes |
| IC_PREFERENCE_PAIR | ICPP_ICP_ID | NUMBER | NOT NULL | No | Yes |
| IC_PREFERENCE_PAIR | ICPP_VALUE | VARCHAR2(20) | NULL | No | No |
| IMAGE_TYPE | IMGT_ID | NUMBER | NOT NULL | Yes | No |
| IMAGE_TYPE | IMGT_TYPE | VARCHAR2(20) | NULL | No | No |
| INFOUSA | LOCNUM | VARCHAR2(9) | NOT NULL | No | No |
| INFOUSA | CONAME | VARCHAR2(30) | NULL | No | No |
| INFOUSA | ADDR | VARCHAR2(30) | NULL | No | No |
| INFOUSA | CITY | VARCHAR2(16) | NULL | No | No |
| INFOUSA | STATE | VARCHAR2(2) | NULL | No | No |
| INFOUSA | ZIP | VARCHAR2(5) | NULL | No | No |
| INFOUSA | ZIP4 | VARCHAR2(4) | NULL | No | No |
| INFOUSA | CUSTOM01 | VARCHAR2(3) | NULL | No | No |
| INFOUSA | CUSTOM02 | VARCHAR2(4) | NULL | No | No |
| INFOUSA | PHONE | VARCHAR2(10) | NULL | No | No |
| INFOUSA | LASTNM | VARCHAR2(14) | NULL | No | No |
| INFOUSA | FRSTNM | VARCHAR2(11) | NULL | No | No |
| INFOUSA | PROTTL | VARCHAR2(3) | NULL | No | No |
| INFOUSA | PRMSIC | VARCHAR2(6) | NULL | No | No |
| INFOUSA | SSIC1 | VARCHAR2(6) | NULL | No | No |
| INFOUSA | SSIC2 | VARCHAR2(6) | NULL | No | No |
| INFOUSA | SSIC3 | VARCHAR2(6) | NULL | No | No |
| INFOUSA | SSIC4 | VARCHAR2(6) | NULL | No | No |
| INFOUSA | FRNCOD | VARCHAR2(6) | NULL | No | No |
| INFOUSA | ISCODE | VARCHAR2(1) | NULL | No | No |
| INFOUSA | SALVOL | VARCHAR2(1) | NULL | No | No |
| INFOUSA | YELVOL | VARCHAR2(5) | NULL | No | No |
| INFOUSA | LATITUDE | VARCHAR2(9) | NOT NULL | No | No |
| INFOUSA | LONGITUDE | VARCHAR2(9) | NOT NULL | No | No |
| INFOUSA | CENSUS | VARCHAR2(6) | NULL | No | No |
| INFOUSA | BLOCK | VARCHAR2(1) | NULL | No | No |
| INFOUSA | MATCH | VARCHAR2(1) | NULL | No | No |
| INSURANCE_COMPANY | IC_ID | NUMBER | NOT NULL | Yes | No |
| INSURANCE_COMPANY | IC_APST_ID | NUMBER | NULL | No | Yes |
| INSURANCE_COMPANY | IC_COMPANY_NAME | VARCHAR2(50) | NULL | No | No |
| INSURANCE_COMPANY | IC_NICK_NAME | VARCHAR2(20) | NULL | No | No |
| INSURANCE_COMPANY | IC_LICENSE_NUMBER | VARCHAR2(20) | NULL | No | No |
| INSURANCE_COMPANY | IC_COMPANY_ID_CODE | VARCHAR2(20) | NULL | No | No |
| INSURANCE_COMPANY | IC_REGISTERED | CHAR(1) | NULL | No | No |
| INSURANCE_COMPANY | IC_DISPLAY_IN_UI | CHAR(1) | NULL | No | No |
| INSURANCE_COMPANY_PREFERENCE | ICP_IC_ID | NUMBER | NOT NULL | Yes | No |
| INSURANCE_COMPANY_PREFERENCE | ICP_NAME | VARCHAR2(20) | NULL | No | No |
| INSURANCE_COMPANY_PREFERENCE | ICP_DESCRIPTION | VARCHAR2(50) | NULL | No | No |
| INSURANCE_COMPANY_PREFERENCE | ICP_VALUE | CHAR(1) | NULL | No | No |
| INSURANCE_COMPANY_STAGING | IC_ID | NUMBER | NOT NULL | No | No |
| INSURANCE_COMPANY_STAGING | IC_COMPANY_NAME | VARCHAR2(50) | NULL | No | No |
| INSURANCE_COMPANY_STAGING | IC_NICK_NAME | VARCHAR2(20) | NULL | No | No |
| INSURANCE_COMPANY_STAGING | IC_LICENSE_NUMBER | VARCHAR2(20) | NULL | No | No |
| INSURANCE_COMPANY_STAGING | IC_COMPANY_ID_CODE | VARCHAR2(20) | NULL | No | No |
| INSURANCE_COMPANY_STAGING | IC_REGISTERED | CHAR(1) | NULL | No | No |
| INSURANCE_COMPANY_STAGING | IC_DISPLAY_IN_UI | CHAR(1) | NULL | No | No |
| INTERCHANGE_NOTE | PART_TYPE | CHAR(3) | NOT NULL | No | No |
| INTERCHANGE_NOTE | INTERCHANGE_ID | VARCHAR2(8) | NOT NULL | No | No |
| INTERCHANGE_NOTE | NOTE_NUMBER | NUMBER(5) | NOT NULL | No | No |
| INTERCHANGE_NOTE | HEADING | NUMBER(5) | NOT NULL | No | No |
| INTERCHANGE_NOTE | DESCRIPTION | VARCHAR2(255) | NOT NULL | No | No |
| INTERCHANGE_NOTE | SEQ_NO | NUMBER | NOT NULL | No | No |
| INTERCHANGE_PART | PART_TYPE | CHAR(3) | NOT NULL | No | No |
| INTERCHANGE_PART | INTERCHANGE_ID | VARCHAR2(8) | NOT NULL | No | No |
| INTERCHANGE_PART | INTERCHANGE_MODEL | VARCHAR2(30) | NOT NULL | No | No |
| INTERCHANGE_PART | YEAR | NUMBER(4) | NOT NULL | No | No |
| INTERCHANGE_PART | SIDE | CHAR(1) | NOT NULL | No | No |
| INTERCHANGE_PART | YEAR_RANGE | VARCHAR2(5) | NOT NULL | No | No |
| INTERCHANGE_PART | DESCRIPTION | VARCHAR2(255) | NULL | No | No |
| INTERCHANGE_PART | SEQ_NO | NUMBER | NOT NULL | No | No |
| MAKE | MK_ID | NUMBER | NOT NULL | Yes | No |
| MAKE | MK_NAME | VARCHAR2(20) | NULL | No | No |
| MAKE | MK_DISPLAY_NAME | VARCHAR2(20) | NULL | No | No |
| MAKE | MK_CHOICE_PARTS_MFG_ID | VARCHAR2(2) | NULL | No | No |
| MAKE_ALIAS | MK_ID | NUMBER | NOT NULL | No | Yes |
| MAKE_ALIAS | MK_ALIAS_NAME | VARCHAR2(25) | NOT NULL | No | No |
| MODEL_XREF | M_ROW$$ | VARCHAR2(18) | NULL | No | No |
| MODEL_XREF | MID | NUMBER(10) | NOT NULL | No | No |
| MODEL_XREF | MAKE | VARCHAR2(30) | NOT NULL | No | No |
| MODEL_XREF | MODEL | VARCHAR2(30) | NOT NULL | No | No |
| MODEL_XREF | INTERCHANGE_MODEL | VARCHAR2(30) | NOT NULL | No | No |
| MODEL_XREF | INVENTORY_MODEL | VARCHAR2(9) | NOT NULL | No | No |
| MODEL_YEAR_XREF | M_ROW$$ | VARCHAR2(18) | NULL | No | No |
| MODEL_YEAR_XREF | MID | NUMBER(10) | NOT NULL | No | No |
| MODEL_YEAR_XREF | MODEL | VARCHAR2(9) | NOT NULL | No | No |
| MODEL_YEAR_XREF | YEAR | NUMBER(4) | NOT NULL | No | No |
| MSAS | MSA_ID | NUMBER | NOT NULL | Yes | No |
| MSAS | MSA_CODE | VARCHAR2(5) | NULL | No | No |
| MSAS | MSA_NAME | VARCHAR2(60) | NOT NULL | No | No |
| NON_OEM_SUPPLIER | ID | NUMBER | NOT NULL | Yes | No |
| NON_OEM_SUPPLIER | ENVELOPE_ID | NUMBER | NULL | No | Yes |
| NON_OEM_SUPPLIER | VND_CO_ID | VARCHAR2(5) | NULL | No | No |
| NON_OEM_SUPPLIER | VND_CO_NM | VARCHAR2(35) | NULL | No | No |
| NON_OEM_SUPPLIER | VND_ADDR1 | VARCHAR2(40) | NULL | No | No |
| NON_OEM_SUPPLIER | VND_ADDR2 | VARCHAR2(40) | NULL | No | No |
| NON_OEM_SUPPLIER | VND_CITY | VARCHAR2(30) | NULL | No | No |
| NON_OEM_SUPPLIER | VND_STATE | VARCHAR2(2) | NULL | No | No |
| NON_OEM_SUPPLIER | VND_ZIP | VARCHAR2(11) | NULL | No | No |
| NON_OEM_SUPPLIER | VND_CTRY | VARCHAR2(3) | NULL | No | No |
| NON_OEM_SUPPLIER | VND_PH1 | VARCHAR2(10) | NULL | No | No |
| NON_OEM_SUPPLIER | VND_PH1X | VARCHAR2(8) | NULL | No | No |
| NON_OEM_SUPPLIER | VND_PH2 | VARCHAR2(10) | NULL | No | No |
| NON_OEM_SUPPLIER | VND_PH2X | VARCHAR2(8) | NULL | No | No |
| NON_OEM_SUPPLIER | VND_FAX | VARCHAR2(10) | NULL | No | No |
| NON_OEM_SUPPLIER | VND_FAXX | VARCHAR2(8) | NULL | No | No |
| NON_OEM_SUPPLIER | VND_CT_LN | VARCHAR2(35) | NULL | No | No |
| NON_OEM_SUPPLIER | VND_CT_FN | VARCHAR2(35) | NULL | No | No |
| NON_OEM_SUPPLIER | VND_CT_TITLE | VARCHAR2(35) | NULL | No | No |
| NON_OEM_SUPPLIER | VND_CT_PH | VARCHAR2(10) | NULL | No | No |
| NON_OEM_SUPPLIER | VND_CT_PHX | VARCHAR2(8) | NULL | No | No |
| NON_OEM_SUPPLIER | VND_EA | VARCHAR2(80) | NULL | No | No |
| NON_OEM_SUPPLIER | VND_TAX_ID | VARCHAR2(30) | NULL | No | No |
| OLD_PARTS_VENDOR_SPECIALTY | PVS_ID | NUMBER | NOT NULL | No | No |
| OLD_PARTS_VENDOR_SPECIALTY | PVS_PV_ID | NUMBER | NULL | No | No |
| OLD_PARTS_VENDOR_SPECIALTY | PVS_PT_ID | NUMBER | NULL | No | No |
| OLD_PARTS_VENDOR_SPECIALTY | PVS_MK_ID | NUMBER | NULL | No | No |
| OLD_RELATIONSHIP | RL_MK_ID | NUMBER | NULL | No | No |
| OLD_RELATIONSHIP | RL_PT_ID | NUMBER | NULL | No | No |
| OLD_RELATIONSHIP | RL_PV_ID | NUMBER | NULL | No | No |
| OLD_RELATIONSHIP | RL_BS_ID | NUMBER | NULL | No | No |
| OLD_RELATIONSHIP | RL_RLT_ID | VARCHAR2(4) | NOT NULL | No | No |
| OLD_RELATIONSHIP | RL_DISCOUNT_AMOUNT | NUMBER(2,2) | NULL | No | No |
| OLD_RELATIONSHIP | RL_SPECIAL_DISCOUNT | CHAR(1) | NULL | No | No |
| OLD_RELATIONSHIP | RL_COUNT | NUMBER | NULL | No | No |
| OLD_STATE_HISTORY | SH_ID | NUMBER | NOT NULL | No | No |
| OLD_STATE_HISTORY | SH_ST_ID | NUMBER | NULL | No | No |
| OLD_STATE_HISTORY | SH_PT_ID | NUMBER | NULL | No | No |
| OLD_STATE_HISTORY | SH_PLI_ID | NUMBER | NULL | No | No |
| OLD_STATE_HISTORY | SH_PV_ID | NUMBER | NULL | No | No |
| OLD_STATE_HISTORY | SH_CREATION_DATE | DATE | NULL | No | No |
| OLD_STATE_HISTORY | SH_COMMENT | VARCHAR2(100) | NULL | No | No |
| OLD_STATE_HISTORY | SH_QUOTE_PRICE | NUMBER(22,2) | NULL | No | No |
| OLD_STATE_HISTORY | SH_FINAL_PRICE | NUMBER(22,2) | NULL | No | No |
| OLD_STATE_HISTORY | SH_ESTIMATION_LIST_PRICE | NUMBER(22,2) | NULL | No | No |
| OLD_STATE_HISTORY | SH_RESTOCKING_FEE | NUMBER(22,2) | NULL | No | No |
| OLD_STATE_HISTORY | SH_RETURN_AMOUNT | NUMBER(22,2) | NULL | No | No |
| OLD_STATE_HISTORY | SH_QUANTITY | NUMBER | NULL | No | No |
| OLD_STATE_HISTORY | SH_DISCOUNT_AMOUNT | NUMBER(22,2) | NULL | No | No |
| OLD_STATE_HISTORY | SH_EXPECTED_FULFILLMENT_DATE | DATE | NULL | No | No |
| OLD_STATE_HISTORY | SH_REQUESTED_DATE | DATE | NULL | No | No |
| OLD_STATE_HISTORY | SH_CAPA_FLAG | CHAR(1) | NULL | No | No |
| OLD_STATE_HISTORY | SH_CUT_OFF_TIME | DATE | NULL | No | No |
| OLD_STATE_HISTORY | SH_TRACKING_NUMBER | VARCHAR2(20) | NULL | No | No |
| OLD_STATE_HISTORY | SH_EV_ID | NUMBER | NULL | No | No |
| OLD_STATE_HISTORY | SH_CLEANUP_HOURS | NUMBER | NULL | No | No |
| ORDER_HISTORY | OH_ID | NUMBER | NOT NULL | Yes | No |
| ORDER_HISTORY | OH_OR_ID | NUMBER | NULL | No | Yes |
| ORDER_HISTORY | OH_STATUS_DATE | DATE | NULL | No | No |
| ORDER_HISTORY | OH_OHS_ID | VARCHAR2(8) | NULL | No | No |
| PART_CODES | PART_CODE | CHAR(3) | NOT NULL | No | No |
| PART_CODES | PART_DESCRIPTION | VARCHAR2(50) | NULL | No | No |
| PART_LINE_ITEM | PLI_ID | NUMBER | NOT NULL | Yes | No |
| PART_LINE_ITEM | PLI_PVO_ID | NUMBER | NULL | No | Yes |
| PART_LINE_ITEM | PLI_DETAIL_LINE_ID | NUMBER | NULL | No | Yes |
| PART_LINE_ITEM | PLI_OR_ID | NUMBER | NULL | No | Yes |
| PART_LINE_ITEM | PLI_COMMENTS | VARCHAR2(100) | NULL | No | No |
| PART_LINE_ITEM | PLI_CURRENT_STATE | NUMBER | NULL | No | No |
| PART_LINE_ITEM | PLI_PART_NUMBER | VARCHAR2(50) | NULL | No | No |
| PART_LINE_ITEM | PLI_PART_DESCRIPTION | VARCHAR2(1024) | NULL | No | No |
| PART_LINE_ITEM | PLI_SUPPLEMENT_NUMBER | NUMBER(2) | NULL | No | No |
| PART_LINE_ITEM | PLI_BODY_SHOP_FLAG | CHAR(1) | NULL | No | No |
| PART_LINE_ITEM | PLI_LINE_NUMBER | VARCHAR2(10) | NULL | No | No |
| PART_LINE_ITEM | PLI_CATL_ID | NUMBER | NULL | No | No |
| PART_LINE_ITEM | UNQ_SEQ | VARCHAR2(4) | NULL | No | No |
| PART_LINE_ITEM | PLI_CHOICE_PARTS_ORDER_ID | NUMBER | NULL | No | No |
| PART_LINE_ITEM_SHIPMENT_INFO | PLIS_ID | NUMBER | NOT NULL | Yes | No |
| PART_LINE_ITEM_SHIPMENT_INFO | PLIS_SHIP_ID | NUMBER | NULL | No | Yes |
| PART_LINE_ITEM_SHIPMENT_INFO | PLIS_PLI_ID | NUMBER | NULL | No | Yes |
| PART_LINE_ITEM_SHIPMENT_INFO | PLIS_ACTUAL_SHIP_DATE | DATE | NULL | No | No |
| PART_LINE_ITEM_SHIPMENT_INFO | PLIS_ACTUAL_DELIVERY_DATE | DATE | NULL | No | No |
| PART_LINE_ITEM_SHIPMENT_INFO | PLIS_SHIPMENT_METHOD | VARCHAR2(20) | NULL | No | No |
| PART_REBATE_HISTORY | PRH_PLI_ID | NUMBER | NOT NULL | Yes | Yes |
| PART_REBATE_HISTORY | PRH_STATE | CHAR(1) | NOT NULL | Yes | No |
| PART_REBATE_HISTORY | PRH_CREATION_DATE | DATE | NULL | No | No |
| PART_TYPE | PT_ID | NUMBER | NOT NULL | Yes | No |
| PART_TYPE | PT_NAME | VARCHAR2(20) | NULL | No | No |
| PART_TYPE | PT_DISPLAY_NAME | VARCHAR2(20) | NULL | No | No |
| PART_TYPE_CODE_XREF | PART_TYPE | CHAR(3) | NOT NULL | No | No |
| PART_TYPE_CODE_XREF | PART_CODE | CHAR(3) | NOT NULL | No | No |
| PART_TYPE_CODE_XREF | SEQ_NO | NUMBER | NOT NULL | No | No |
| PART_TYPES | PART_TYPE | CHAR(3) | NOT NULL | No | No |
| PART_TYPES | PART_DESCRIPTION | VARCHAR2(50) | NULL | No | No |
| PARTS_USAGE_ANALYSIS | PUA_BS_ID | NUMBER | NULL | No | No |
| PARTS_USAGE_ANALYSIS | PUA_IC_ID | NUMBER | NULL | No | No |
| PARTS_USAGE_ANALYSIS | PUA_DRP_ID | NUMBER | NULL | No | No |
| PARTS_USAGE_ANALYSIS | PUA_OR_ID | NUMBER | NULL | No | No |
| PARTS_USAGE_ANALYSIS | PUA_CLAIM_NO | VARCHAR2(30) | NULL | No | No |
| PARTS_USAGE_ANALYSIS | PUA_CREATION_DATE | DATE | NULL | No | No |
| PARTS_USAGE_ANALYSIS | PUA_TOTAL_PARTS_COST | NUMBER(22,2) | NULL | No | No |
| PARTS_USAGE_ANALYSIS | PUA_TOTAL_COST_OEM | NUMBER(22,2) | NULL | No | No |
| PARTS_USAGE_ANALYSIS | PUA_TOTAL_COST_AM | NUMBER(22,2) | NULL | No | No |
| PARTS_USAGE_ANALYSIS | PUA_TOTAL_COST_LKQ | NUMBER(22,2) | NULL | No | No |
| PARTS_USAGE_ANALYSIS | PUA_TOTAL_PARTS_USED | NUMBER | NULL | No | No |
| PARTS_USAGE_ANALYSIS | PUA_TOTAL_USED_OEM | NUMBER | NULL | No | No |
| PARTS_USAGE_ANALYSIS | PUA_TOTAL_USED_AM | NUMBER | NULL | No | No |
| PARTS_USAGE_ANALYSIS | PUA_TOTAL_USED_LKQ | NUMBER | NULL | No | No |
| PARTS_USAGE_ANALYSIS | PUA_TOTAL_PARTS_LIST | NUMBER(38,2) | NULL | No | No |
| PARTS_USAGE_ANALYSIS | PUA_LIST_COST_OEM | NUMBER(38,2) | NULL | No | No |
| PARTS_USAGE_ANALYSIS | PUA_LIST_COST_AM | NUMBER(38,2) | NULL | No | No |
| PARTS_USAGE_ANALYSIS | PUA_LIST_COST_LKQ | NUMBER(38,2) | NULL | No | No |
| PARTS_VENDOR | PV_ID | NUMBER | NOT NULL | Yes | No |
| PARTS_VENDOR | PV_APST_ID | NUMBER | NULL | No | Yes |
| PARTS_VENDOR | PV_COMPANY_NAME | VARCHAR2(50) | NULL | No | No |
| PARTS_VENDOR | PV_NICKNAME | VARCHAR2(50) | NULL | No | No |
| PARTS_VENDOR | PV_CHOICE_PARTS_INTEGRATED_DMS | CHAR(1) | NULL | No | No |
| PARTS_VENDOR | PV_CHOICE_PARTS_DEALER_ID | VARCHAR2(7) | NULL | No | No |
| PARTS_VENDOR_INSURANCE_COMPANY | INSURANCE_COMPANY_ID | NUMBER | NOT NULL | Yes | Yes |
| PARTS_VENDOR_INSURANCE_COMPANY | PARTS_VENDOR_ID | NUMBER | NOT NULL | Yes | Yes |
| PARTS_VENDOR_OPERATING_HOUR | PVOH_ID | NUMBER | NOT NULL | No | No |
| PARTS_VENDOR_OPERATING_HOUR | PVOH_PV_ID | NUMBER | NULL | No | No |
| PARTS_VENDOR_OPERATING_HOUR | PVOH_DOW_ID | NUMBER | NULL | No | No |
| PARTS_VENDOR_OPERATING_HOUR | PVOH_SHOP_CLOSED | CHAR(1) | NULL | No | No |
| PARTS_VENDOR_OPERATING_HOUR | PVOH_OPEN_TIME | VARCHAR2(10) | NULL | No | No |
| PARTS_VENDOR_OPERATING_HOUR | PVOH_CLOSE_TIME | VARCHAR2(10) | NULL | No | No |
| PARTS_VENDOR_ORDER | PVO_ID | NUMBER | NOT NULL | Yes | No |
| PARTS_VENDOR_ORDER | PVO_VI_ID | NUMBER | NULL | No | Yes |
| PARTS_VENDOR_ORDER | PVO_BS_ID | NUMBER | NULL | No | Yes |
| PARTS_VENDOR_ORDER | PVO_OR_ID | NUMBER | NULL | No | Yes |
| PARTS_VENDOR_ORDER | PVO_PV_ID | NUMBER | NULL | No | Yes |
| PARTS_VENDOR_ORDER | PVO_CREATION_DATE | DATE | NULL | No | No |
| PARTS_VENDOR_ORDER | PVO_TOTAL_PARTS | NUMBER | NULL | No | No |
| PARTS_VENDOR_ORDER | PVO_TOTAL_PRICE | NUMBER(22,2) | NULL | No | No |
| PARTS_VENDOR_ORDER | PVO_CUTOFF_DATE | DATE | NULL | No | No |
| PARTS_VENDOR_ORDER | PVO_OPEN_FLAG | CHAR(1) | NULL | No | No |
| PARTS_VENDOR_ORDER | PVO_QUOTE_FLAG | CHAR(1) | NULL | No | No |
| PARTS_VENDOR_ORDER | PVO_RETURN_FLAG | CHAR(1) | NULL | No | No |
| PARTS_VENDOR_ORDER | PVO_ORDER_FLAG | CHAR(1) | NULL | No | No |
| PARTS_VENDOR_ORDER_HISTORY | PVOH_PVO_ID | NUMBER | NULL | No | No |
| PARTS_VENDOR_ORDER_HISTORY | PVOH_STATE | CHAR(1) | NULL | No | No |
| PARTS_VENDOR_ORDER_HISTORY | PVOH_CREATION_DATE | DATE | NULL | No | No |
| PARTS_VENDOR_PREFERENCE | PVP_ID | NUMBER | NOT NULL | Yes | No |
| PARTS_VENDOR_PREFERENCE | PVP_NAME | VARCHAR2(20) | NULL | No | No |
| PARTS_VENDOR_PREFERENCE | PVP_DESCRIPTION | VARCHAR2(50) | NULL | No | No |
| PARTS_VENDOR_PREFERENCE_PAIR | PVPP_ID | NUMBER | NOT NULL | Yes | No |
| PARTS_VENDOR_PREFERENCE_PAIR | PVPP_PVP_ID | NUMBER | NULL | No | Yes |
| PARTS_VENDOR_PREFERENCE_PAIR | PVPP_PV_ID | NUMBER | NULL | No | Yes |
| PARTS_VENDOR_PREFERENCE_PAIR | PVPP_VALUE | CHAR(1) | NULL | No | No |
| PARTS_VENDOR_PROFILE | PVPR_PV_ID | NUMBER | NULL | No | Yes |
| PARTS_VENDOR_PROFILE | PVPR_MONTHLY_VOLUME | VARCHAR2(100) | NULL | No | No |
| PARTS_VENDOR_PROFILE | PVPR_WARRANTIES | VARCHAR2(1000) | NULL | No | No |
| PARTS_VENDOR_PROFILE | PVPR_RETURN_POLICY | VARCHAR2(1000) | NULL | No | No |
| PARTS_VENDOR_PROFILE | PVPR_WEB_DISCOUNT_FLAG | CHAR(1) | NULL | No | No |
| PARTS_VENDOR_PROFILE | PVPR_PT_ID | NUMBER | NULL | No | No |
| PARTS_VENDOR_PROFILE | PVPR_PART_TYPE_OTHER | VARCHAR2(100) | NULL | No | No |
| PARTS_VENDOR_PROFILE | PVPR_ALL_MAKE_FLAG | CHAR(1) | NULL | No | No |
| PARTS_VENDOR_PROFILE | PVPR_MAKE_OTHER_FLAG | CHAR(1) | NULL | No | No |
| PARTS_VENDOR_PROFILE | PVPR_MAKE_OTHER | VARCHAR2(100) | NULL | No | No |
| PARTS_VENDOR_PROFILE | PVPR_STANDARD_DISCOUNT | NUMBER(2,2) | NULL | No | No |
| PARTS_VENDOR_PROFILE | PVPR_TAX_ID | VARCHAR2(20) | NULL | No | No |
| PARTS_VENDOR_PROFILE | PVPR_DESCRIPTION | VARCHAR2(1000) | NULL | No | No |
| PARTS_VENDOR_PROFILE | PVPR_URL | VARCHAR2(80) | NULL | No | No |
| PARTS_VENDOR_PROFILE | PVPR_WEB_DISCOUNT_TEXT | VARCHAR2(100) | NULL | No | No |
| PARTS_VENDOR_PROFILE | PVPR_WHOLESALE_LICENSE | VARCHAR2(20) | NULL | No | No |
| PARTS_VENDOR_PROFILE | PVPR_STATUS | CHAR(1) | NOT NULL | No | No |
| PARTS_VENDOR_PROFILE | PVPR_COMPANY_NAME | VARCHAR2(50) | NULL | No | No |
| PARTS_VENDOR_PROFILE | PVPR_SHOP_EMAIL | VARCHAR2(100) | NULL | No | No |
| PARTS_VENDOR_PROFILE | PVPR_WANT_EMAIL | CHAR(1) | NULL | No | No |
| PARTS_VENDOR_PROFILE | PVPR_WANT_SOUND | CHAR(1) | NULL | No | No |
| PARTS_VENDOR_PROFILE | PVPR_CREATED_ON | DATE | NULL | No | No |
| PARTS_VENDOR_PROFILE | PVPR_UPDATED_ON | DATE | NULL | No | No |
| PARTS_VENDOR_SERVICE_REGION | PVSR_PV_ID | NUMBER | NOT NULL | Yes | No |
| PARTS_VENDOR_SERVICE_REGION | PVSR_SRCT_ID | NUMBER | NOT NULL | Yes | No |
| PARTS_VENDOR_SPECIALTY | PVS_ID | NUMBER | NOT NULL | Yes | No |
| PARTS_VENDOR_SPECIALTY | PVS_PV_ID | NUMBER | NULL | No | Yes |
| PARTS_VENDOR_SPECIALTY | PVS_PT_ID | NUMBER | NULL | No | Yes |
| PARTS_VENDOR_SPECIALTY | PVS_MK_ID | NUMBER | NULL | No | Yes |
| PARTS_VENDOR_STAGING | PV_ID | NUMBER | NOT NULL | Yes | No |
| PARTS_VENDOR_STAGING | PV_URL | VARCHAR2(100) | NULL | No | No |
| PARTS_VENDOR_STAGING | PV_WARRANTIES | VARCHAR2(100) | NULL | No | No |
| PARTS_VENDOR_STAGING | PV_RETURN_POLICY | VARCHAR2(1000) | NULL | No | No |
| PARTS_VENDOR_STAGING | PV_WEB_DISCOUNT_FLAG | CHAR(1) | NULL | No | No |
| PARTS_VENDOR_STAGING | PV_PART_TYPE_OTHER | VARCHAR2(100) | NULL | No | No |
| PARTS_VENDOR_STAGING | PV_ALL_MAKE_FLAG | CHAR(1) | NULL | No | No |
| PARTS_VENDOR_STAGING | PV_MAKE_OTHER_FLAG | CHAR(1) | NULL | No | No |
| PARTS_VENDOR_STAGING | PV_MAKE_OTHER | VARCHAR2(100) | NULL | No | No |
| PARTS_VENDOR_STAGING | PV_DESCRIPTION | VARCHAR2(1000) | NULL | No | No |
| PARTS_VENDOR_STAGING | PV_CONTACT_FIRST_NAME | VARCHAR2(50) | NULL | No | No |
| PARTS_VENDOR_STAGING | PV_CONTACT_LAST_NAME | VARCHAR2(50) | NULL | No | No |
| PARTS_VENDOR_STAGING | PV_WEB_DISCOUNT_TEXT | VARCHAR2(1000) | NULL | No | No |
| PARTS_VENDOR_TECHNICAL_ENV | PVTE_ID | NUMBER | NULL | No | No |
| PARTS_VENDOR_TECHNICAL_ENV | PVTE_PV_ID | NUMBER | NULL | No | No |
| PARTS_VENDOR_TECHNICAL_ENV | PVTE_COMPUTER_NUM_ID | NUMBER | NULL | No | No |
| PARTS_VENDOR_TECHNICAL_ENV | PVTE_BROWSER_TYPE_ID | NUMBER | NULL | No | No |
| PARTS_VENDOR_TECHNICAL_ENV | PVTE_NETWORKED | CHAR(1) | NULL | No | No |
| PARTS_VENDOR_TECHNICAL_ENV | PVTE_OS_ID | NUMBER | NULL | No | No |
| PARTS_VENDOR_TECHNICAL_ENV | PVTE_MODEM_SPEED_ID | NUMBER | NULL | No | No |
| PARTS_VENDOR_TECHNICAL_ENV | PVTE_MGMT_SW_ID | NUMBER | NULL | No | No |
| PARTS_VENDOR_TECHNICAL_ENV | PVTE_MGMT_SW_OTHER_TEXT | VARCHAR2(50) | NULL | No | No |
| PARTS_VENDOR_VALUE_PAIR | PVVP_PV_ID | NUMBER | NOT NULL | Yes | Yes |
| PARTS_VENDOR_VALUE_PAIR | PVVP_VAL_ID | NUMBER | NOT NULL | Yes | No |
| PAYMENT_INVOICE | PIN_ID | NUMBER | NOT NULL | Yes | No |
| PAYMENT_INVOICE | PIN_BS_ID | NUMBER | NULL | No | Yes |
| PAYMENT_INVOICE | PIN_PV_ID | NUMBER | NULL | No | Yes |
| PAYMENT_INVOICE | PIN_PVO_ID | NUMBER | NULL | No | Yes |
| PAYMENT_INVOICE | PIN_CREATION_DATE | DATE | NULL | No | No |
| PAYMENT_INVOICE | PIN_TOTAL_PARTS | NUMBER | NULL | No | No |
| PAYMENT_INVOICE | PIN_TOTAL_PRICE | NUMBER(22,2) | NULL | No | No |
| PAYMENT_INVOICE | PIN_TRACKING_NUMBER | VARCHAR2(20) | NULL | No | No |
| PAYMENT_INVOICE | PIN_PURCHASE_ORDER_NUMBER | VARCHAR2(20) | NULL | No | No |
| PAYMENT_INVOICE | PIN_SHIPPING_CHARGES | NUMBER(22,2) | NULL | No | No |
| PAYMENT_INVOICE | PIN_EXTRA_CHARGES | NUMBER(22,2) | NULL | No | No |
| PAYMENT_INVOICE_ISSUED | PINI_PIN_ID | NUMBER | NOT NULL | Yes | Yes |
| PAYMENT_INVOICE_ISSUED | PINI_PLI_ID | NUMBER | NOT NULL | Yes | Yes |
| PAYMENT_INVOICE_ISSUED | PINI_RESTOCKING_FEE | NUMBER(22,2) | NULL | No | No |
| PHONE_NUMBER | PN_ID | NUMBER | NOT NULL | Yes | No |
| PHONE_NUMBER | PN_PNT_ID | NUMBER | NOT NULL | No | Yes |
| PHONE_NUMBER | PN_CT_CODE | VARCHAR2(4) | NOT NULL | No | Yes |
| PHONE_NUMBER | PN_COMPANY_ID | NUMBER | NOT NULL | No | No |
| PHONE_NUMBER | PN_AREA_CODE | VARCHAR2(3) | NULL | No | No |
| PHONE_NUMBER | PN_NUMBER | VARCHAR2(10) | NULL | No | No |
| PHONE_NUMBER | PN_EXTENSION | VARCHAR2(8) | NULL | No | No |
| PHONE_NUMBER | PN_STATUS | CHAR(1) | NOT NULL | No | No |
| PHONE_NUMBER_TYPE | PNT_ID | NUMBER | NOT NULL | Yes | No |
| PHONE_NUMBER_TYPE | PNT_TYPE | VARCHAR2(20) | NOT NULL | No | No |
| PLAN_TABLE | STATEMENT_ID | VARCHAR2(30) | NULL | No | No |
| PLAN_TABLE | TIMESTAMP | DATE | NULL | No | No |
| PLAN_TABLE | ARKS | VARCHAR2(80) | NULL | No | No |
| PLAN_TABLE | OPERATION | VARCHAR2(30) | NULL | No | No |
| PLAN_TABLE | OPTIONS | VARCHAR2(30) | NULL | No | No |
| PLAN_TABLE | OBJECT_NODE | VARCHAR2(128) | NULL | No | No |
| PLAN_TABLE | OBJECT_OWNER | VARCHAR2(30) | NULL | No | No |
| PLAN_TABLE | OBJECT_NAME | VARCHAR2(30) | NULL | No | No |
| PLAN_TABLE | OBJECT_INSTANCE | NUMBER | NULL | No | No |
| PLAN_TABLE | OBJECT_TYPE | VARCHAR2(30) | NULL | No | No |
| PLAN_TABLE | OPTIMIZER | VARCHAR2(255) | NULL | No | No |
| PLAN_TABLE | SEARCH_COLUMNS | NUMBER | NULL | No | No |
| PLAN_TABLE | ID | NUMBER | NULL | No | No |
| PLAN_TABLE | PARENT_ID | NUMBER | NULL | No | No |
| PLAN_TABLE | POSITION | NUMBER | NULL | No | No |
| PLAN_TABLE | COST | NUMBER | NULL | No | No |
| PLAN_TABLE | CARDINALITY | NUMBER | NULL | No | No |
| PLAN_TABLE | BYTES | NUMBER | NULL | No | No |
| PLAN_TABLE | OTHER_TAG | VARCHAR2(255) | NULL | No | No |
| PLAN_TABLE | PARTITION_START | VARCHAR2(255) | NULL | No | No |
| PLAN_TABLE | PARTITION_STOP | VARCHAR2(255) | NULL | No | No |
| PLAN_TABLE | PARTITION_ID | NUMBER | NULL | No | No |
| PLAN_TABLE | OTHER | LONG | NULL | No | No |
| PLAN_TABLE | DISTRIBUTION | VARCHAR2(30) | NULL | No | No |
| PLPG_CONFIG | MAKE | VARCHAR2(50) | NULL | No | No |
| PLPG_CONFIG | MODEL | VARCHAR2(50) | NULL | No | No |
| PLPG_CONFIG | YEAR | NUMBER(4) | NULL | No | No |
| PLPG_CONFIG | SERVICE | NUMBER(9) | NULL | No | No |
| PRICE_RELATION | CONTRIB_ID | NUMBER(10) | NOT NULL | No | No |
| PRICE_RELATION | SUBSCRIBER_ID | NUMBER(10) | NOT NULL | No | No |
| PRICE_RELATION | SUBSCRIBER_TYPE | CHAR(2) | NULL | No | No |
| PRICE_RELATION | PRICE_FLAG | CHAR(1) | NOT NULL | No | No |
| PRICE_RELATION | PRICE_ADJUST | NUMBER(5,4) | NULL | No | No |
| PRODUCTS | COMPANY_ID | NUMBER(10) | NOT NULL | Yes | No |
| PRODUCTS | COMPANY_TYPE | VARCHAR2(4) | NULL | No | No |
| PRODUCTS | PRODUCT | VARCHAR2(50) | NOT NULL | No | No |
| PRODUCTS | NUM_USERS | NUMBER(10) | NULL | No | No |
| PRODUCTS | ACTIVE | CHAR(1) | NULL | No | No |
| PRODUCTS | SUBSCRIPTION_TYPE | CHAR(1) | NULL | No | No |
| PRODUCTS | START_DATE | NUMBER | NULL | No | No |
| PRODUCTS | TERMS_AGREED | CHAR(1) | NOT NULL | No | No |
| PROFILE_1 | ID | NUMBER | NOT NULL | Yes | No |
| PROFILE_1 | ENVELOPE_ID | NUMBER | NULL | No | Yes |
| PROFILE_1 | ID_PRO_NAM | VARCHAR2(40) | NULL | No | No |
| PROFILE_1 | TAX_PRETHR | NUMBER(22,4) | NULL | No | No |
| PROFILE_1 | TAX_THRAMT | NUMBER(22,2) | NULL | No | No |
| PROFILE_1 | TAX_PSTTHR | NUMBER(22,4) | NULL | No | No |
| PROFILE_1 | TAX_TOW_IN | CHAR(1) | NULL | No | No |
| PROFILE_1 | TAX_TOW_RT | NUMBER(22,4) | NULL | No | No |
| PROFILE_1 | TAX_STR_IN | CHAR(1) | NULL | No | No |
| PROFILE_1 | TAX_STR_RT | NUMBER(22,4) | NULL | No | No |
| PROFILE_1 | TAX_SUB_IN | CHAR(1) | NULL | No | No |
| PROFILE_1 | TAX_SUB_RT | NUMBER(22,4) | NULL | No | No |
| PROFILE_1 | TAX_BTR_IN | CHAR(1) | NULL | No | No |
| PROFILE_1 | TAX_LBR_RT | NUMBER(22,4) | NULL | No | No |
| PROFILE_1 | TAX_GST_RT | NUMBER(22,4) | NULL | No | No |
| PROFILE_1 | TAX_GST_IN | CHAR(1) | NULL | No | No |
| PROFILE_1 | ADJ_G_DISC | NUMBER(22,4) | NULL | No | No |
| PROFILE_1 | ADJ_TOWDIS | NUMBER(22,4) | NULL | No | No |
| PROFILE_1 | ADJ_STRDIS | NUMBER(22,4) | NULL | No | No |
| PROFILE_1 | ADJ_BTR_IN | CHAR(1) | NULL | No | No |
| PROFILE_1 | TAX_PREDIS | NUMBER(22,2) | NULL | No | No |
| PROFILE_2 | ID | NUMBER | NOT NULL | Yes | No |
| PROFILE_2 | ENVELOPE_ID | NUMBER | NULL | No | Yes |
| PROFILE_2 | PRT_TYPE | VARCHAR2(4) | NULL | No | No |
| PROFILE_2 | PRT_TAX_IN | CHAR(1) | NULL | No | No |
| PROFILE_2 | PRT_TAX_RT | NUMBER(22,4) | NULL | No | No |
| PROFILE_2 | PRT_MKUPP | NUMBER(8,4) | NULL | No | No |
| PROFILE_2 | PRT_MKTYP | CHAR(1) | NULL | No | No |
| PROFILE_2 | PRT_DISCP | NUMBER(8,4) | NULL | No | No |
| PROFILE_2 | PRT_TX_TY1 | VARCHAR2(2) | NULL | No | No |
| PROFILE_2 | PRT_TX_IN1 | VARCHAR2(1) | NULL | No | No |
| PROFILE_2 | PRT_TX_TY2 | VARCHAR2(2) | NULL | No | No |
| PROFILE_2 | PRT_TX_IN2 | VARCHAR2(1) | NULL | No | No |
| PROFILE_2 | PRT_TX_TY3 | VARCHAR2(2) | NULL | No | No |
| PROFILE_2 | PRT_TX_IN3 | VARCHAR2(1) | NULL | No | No |
| PROFILE_2 | PRT_TX_TY4 | VARCHAR2(2) | NULL | No | No |
| PROFILE_2 | PRT_TX_IN4 | VARCHAR2(1) | NULL | No | No |
| PROFILE_2 | PRT_TX_TY5 | VARCHAR2(2) | NULL | No | No |
| PROFILE_2 | PRT_TX_IN5 | VARCHAR2(1) | NULL | No | No |
| PROFILE_3 | ID | NUMBER | NOT NULL | Yes | No |
| PROFILE_3 | ENVELOPE_ID | NUMBER | NULL | No | Yes |
| PROFILE_3 | LBR_TYPE | VARCHAR2(4) | NULL | No | No |
| PROFILE_3 | LBR_DESC | VARCHAR2(20) | NULL | No | No |
| PROFILE_3 | LBR_RATE | NUMBER(5,2) | NULL | No | No |
| PROFILE_3 | LBR_TAX_IN | CHAR(1) | NULL | No | No |
| PROFILE_3 | LBR_TAXP | NUMBER(8,4) | NULL | No | No |
| PROFILE_3 | LBR_ADJP | NUMBER(8,4) | NULL | No | No |
| PROFILE_3 | LBR_TX_TY1 | CHAR(2) | NULL | No | No |
| PROFILE_3 | LBR_TX_IN1 | VARCHAR2(1) | NULL | No | No |
| PROFILE_3 | LBR_TX_TY2 | VARCHAR2(2) | NULL | No | No |
| PROFILE_3 | LBR_TX_IN2 | VARCHAR2(1) | NULL | No | No |
| PROFILE_3 | LBR_TX_TY3 | VARCHAR2(2) | NULL | No | No |
| PROFILE_3 | LBR_TX_IN3 | VARCHAR2(1) | NULL | No | No |
| PROFILE_3 | LBR_TX_TY4 | VARCHAR2(2) | NULL | No | No |
| PROFILE_3 | LBR_TX_IN4 | VARCHAR2(1) | NULL | No | No |
| PROFILE_3 | LBR_TX_TY5 | VARCHAR2(2) | NULL | No | No |
| PROFILE_3 | LBR_TX_IN5 | VARCHAR2(1) | NULL | No | No |
| PROFILE_4 | ID | NUMBER | NOT NULL | Yes | No |
| PROFILE_4 | ENVELOPE_ID | NUMBER | NULL | No | Yes |
| PROFILE_4 | MATL_TYPE | VARCHAR2(4) | NULL | No | No |
| PROFILE_4 | CAL_CODE | VARCHAR2(1) | NULL | No | No |
| PROFILE_4 | CAL_DESC | VARCHAR2(20) | NULL | No | No |
| PROFILE_4 | CAL_MAXDLR | NUMBER(9,2) | NULL | No | No |
| PROFILE_4 | CAL_PRIP | NUMBER(8,4) | NULL | No | No |
| PROFILE_4 | CAL_SECP | NUMBER(8,4) | NULL | No | No |
| PROFILE_4 | MAT_CALP | NUMBER(8,4) | NULL | No | No |
| PROFILE_4 | CAL_PRETHR | NUMBER(8,4) | NULL | No | No |
| PROFILE_4 | CAL_PSTTHR | NUMBER(8,4) | NULL | No | No |
| PROFILE_4 | CAL_THRAMT | NUMBER(7,2) | NULL | No | No |
| PROFILE_4 | CAL_LBRMIN | NUMBER(4,1) | NULL | No | No |
| PROFILE_4 | CAL_LBRMAX | NUMBER(4,1) | NULL | No | No |
| PROFILE_4 | CAL_LBRRTE | NUMBER(5,2) | NULL | No | No |
| PROFILE_4 | CAL_OPCODE | VARCHAR2(48) | NULL | No | No |
| PROFILE_4 | TAX_IND | CHAR(1) | NULL | No | No |
| PROFILE_4 | MAT_TAXP | NUMBER(8,4) | NULL | No | No |
| PROFILE_4 | MAT_ADJP | NUMBER(8,4) | NULL | No | No |
| PROFILE_4 | MAT_TX_TY1 | VARCHAR2(2) | NULL | No | No |
| PROFILE_4 | MAT_TX_IN1 | VARCHAR2(1) | NULL | No | No |
| PROFILE_4 | MAT_TX_TY2 | VARCHAR2(2) | NULL | No | No |
| PROFILE_4 | MAT_TX_IN2 | VARCHAR2(1) | NULL | No | No |
| PROFILE_4 | MAT_TX_TY3 | VARCHAR2(2) | NULL | No | No |
| PROFILE_4 | MAT_TX_IN3 | VARCHAR2(1) | NULL | No | No |
| PROFILE_4 | MAT_TX_TY4 | VARCHAR2(2) | NULL | No | No |
| PROFILE_4 | MAT_TX_IN4 | VARCHAR2(1) | NULL | No | No |
| PROFILE_4 | MAT_TX_TY5 | VARCHAR2(2) | NULL | No | No |
| PROFILE_4 | MAT_TX_IN5 | VARCHAR2(1) | NULL | No | No |
| PROFILE_5 | ID | NUMBER | NOT NULL | Yes | No |
| PROFILE_5 | ENVELOPE_ID | NUMBER | NULL | No | Yes |
| PROFILE_5 | TAX_TYPE1 | VARCHAR2(2) | NULL | No | No |
| PROFILE_5 | TY1_TIER1 | NUMBER | NULL | No | No |
| PROFILE_5 | TY1_THRES1 | NUMBER | NULL | No | No |
| PROFILE_5 | TY1_RATE1 | NUMBER | NULL | No | No |
| PROFILE_5 | TY1_SUR1 | NUMBER | NULL | No | No |
| PROFILE_5 | TY1_TIER2 | NUMBER | NULL | No | No |
| PROFILE_5 | TY1_THRES2 | NUMBER | NULL | No | No |
| PROFILE_5 | TY1_RATE2 | NUMBER | NULL | No | No |
| PROFILE_5 | TY1_SUR2 | NUMBER | NULL | No | No |
| PROFILE_5 | TY1_TIER3 | NUMBER | NULL | No | No |
| PROFILE_5 | TY1_THRES3 | NUMBER | NULL | No | No |
| PROFILE_5 | TY1_RATE3 | NUMBER | NULL | No | No |
| PROFILE_5 | TY1_SUR3 | NUMBER | NULL | No | No |
| PROFILE_5 | TY1_TIER4 | NUMBER | NULL | No | No |
| PROFILE_5 | TY1_THRES4 | NUMBER | NULL | No | No |
| PROFILE_5 | TY1_RATE4 | NUMBER | NULL | No | No |
| PROFILE_5 | TY1_SUR4 | NUMBER | NULL | No | No |
| PROFILE_5 | TY1_TIER5 | NUMBER | NULL | No | No |
| PROFILE_5 | TY1_THRES5 | NUMBER | NULL | No | No |
| PROFILE_5 | TY1_RATE5 | NUMBER | NULL | No | No |
| PROFILE_5 | TY1_SUR5 | NUMBER | NULL | No | No |
| PROFILE_5 | TAX_TYPE2 | VARCHAR2(2) | NULL | No | No |
| PROFILE_5 | TY2_TIER1 | NUMBER | NULL | No | No |
| PROFILE_5 | TY2_THRES1 | NUMBER | NULL | No | No |
| PROFILE_5 | TY2_RATE1 | NUMBER | NULL | No | No |
| PROFILE_5 | TY2_SUR1 | NUMBER | NULL | No | No |
| PROFILE_5 | TY2_TIER2 | NUMBER | NULL | No | No |
| PROFILE_5 | TY2_THRES2 | NUMBER | NULL | No | No |
| PROFILE_5 | TY2_RATE2 | NUMBER | NULL | No | No |
| PROFILE_5 | TY2_SUR2 | NUMBER | NULL | No | No |
| PROFILE_5 | TY2_TIER3 | NUMBER | NULL | No | No |
| PROFILE_5 | TY2_THRES3 | NUMBER | NULL | No | No |
| PROFILE_5 | TY2_RATE3 | NUMBER | NULL | No | No |
| PROFILE_5 | TY2_SUR3 | NUMBER | NULL | No | No |
| PROFILE_5 | TY2_TIER4 | NUMBER | NULL | No | No |
| PROFILE_5 | TY2_THRES4 | NUMBER | NULL | No | No |
| PROFILE_5 | TY2_RATE4 | NUMBER | NULL | No | No |
| PROFILE_5 | TY2_SUR4 | NUMBER | NULL | No | No |
| PROFILE_5 | TY2_TIERS | NUMBER | NULL | No | No |
| PROFILE_5 | TY2_THRES5 | NUMBER | NULL | No | No |
| PROFILE_5 | TY2_RATE5 | NUMBER | NULL | No | No |
| PROFILE_5 | TY2_SUR5 | NUMBER | NULL | No | No |
| PROFILE_5 | TAX_TYPE3 | VARCHAR2(2) | NULL | No | No |
| PROFILE_5 | TY3_TIER1 | NUMBER | NULL | No | No |
| PROFILE_5 | TY3_THRES1 | NUMBER | NULL | No | No |
| PROFILE_5 | TY3_RATE1 | NUMBER | NULL | No | No |
| PROFILE_5 | TY3_SUR1 | NUMBER | NULL | No | No |
| PROFILE_5 | TY3_TIER2 | NUMBER | NULL | No | No |
| PROFILE_5 | TY3_THRES2 | NUMBER | NULL | No | No |
| PROFILE_5 | TY3_RATE2 | NUMBER | NULL | No | No |
| PROFILE_5 | TY3_SUR2 | NUMBER | NULL | No | No |
| PROFILE_5 | TY3_TIER3 | NUMBER | NULL | No | No |
| PROFILE_5 | TY3_THRES3 | NUMBER | NULL | No | No |
| PROFILE_5 | TY3_RATE3 | NUMBER | NULL | No | No |
| PROFILE_5 | TY3_SUR3 | NUMBER | NULL | No | No |
| PROFILE_5 | TY3_TIER4 | NUMBER | NULL | No | No |
| PROFILE_5 | TY3_THRES4 | NUMBER | NULL | No | No |
| PROFILE_5 | TY3_RATE4 | NUMBER | NULL | No | No |
| PROFILE_5 | TY3_SUR4 | NUMBER | NULL | No | No |
| PROFILE_5 | TY3_TIER5 | NUMBER | NULL | No | No |
| PROFILE_5 | TY3_THRES5 | NUMBER | NULL | No | No |
| PROFILE_5 | TY3_RATE5 | NUMBER | NULL | No | No |
| PROFILE_5 | TY3_SUR5 | NUMBER | NULL | No | No |
| PROFILE_5 | TAX_TYPE4 | VARCHAR2(2) | NULL | No | No |
| PROFILE_5 | TY4_TIER1 | NUMBER | NULL | No | No |
| PROFILE_5 | TY4_THRES1 | NUMBER | NULL | No | No |
| PROFILE_5 | TY4_RATE1 | NUMBER | NULL | No | No |
| PROFILE_5 | TY4_SUR1 | NUMBER | NULL | No | No |
| PROFILE_5 | TY4_TIER2 | NUMBER | NULL | No | No |
| PROFILE_5 | TY4_THRES2 | NUMBER | NULL | No | No |
| PROFILE_5 | TY4_RATE2 | NUMBER | NULL | No | No |
| PROFILE_5 | TY4_SUR2 | NUMBER | NULL | No | No |
| PROFILE_5 | TY4_TIER3 | NUMBER | NULL | No | No |
| PROFILE_5 | TY4_THRES3 | NUMBER | NULL | No | No |
| PROFILE_5 | TY4_RATE3 | NUMBER | NULL | No | No |
| PROFILE_5 | TY4_SUR3 | NUMBER | NULL | No | No |
| PROFILE_5 | TY4_TIER4 | NUMBER | NULL | No | No |
| PROFILE_5 | TY4_THRES4 | NUMBER | NULL | No | No |
| PROFILE_5 | TY4_RATE4 | NUMBER | NULL | No | No |
| PROFILE_5 | TY4_SUR4 | NUMBER | NULL | No | No |
| PROFILE_5 | TY4_TIER5 | NUMBER | NULL | No | No |
| PROFILE_5 | TY4_THRES5 | NUMBER | NULL | No | No |
| PROFILE_5 | TY4_RATE5 | NUMBER | NULL | No | No |
| PROFILE_5 | TY4_SUR5 | NUMBER | NULL | No | No |
| PROFILE_5 | TAX_TYPE5 | VARCHAR2(2) | NULL | No | No |
| PROFILE_5 | TY5_TIER1 | NUMBER | NULL | No | No |
| PROFILE_5 | TY5_THRES1 | NUMBER | NULL | No | No |
| PROFILE_5 | TY5_RATE1 | NUMBER | NULL | No | No |
| PROFILE_5 | TY5_SUR1 | NUMBER | NULL | No | No |
| PROFILE_5 | TY5_TIER2 | NUMBER | NULL | No | No |
| PROFILE_5 | TY5_THRES2 | NUMBER | NULL | No | No |
| PROFILE_5 | TY5_RATE2 | NUMBER | NULL | No | No |
| PROFILE_5 | TY5_SUR2 | NUMBER | NULL | No | No |
| PROFILE_5 | TY5_TIER3 | NUMBER | NULL | No | No |
| PROFILE_5 | TY5_THRES3 | NUMBER | NULL | No | No |
| PROFILE_5 | TY5_RATE3 | NUMBER | NULL | No | No |
| PROFILE_5 | TY5_SUR3 | NUMBER | NULL | No | No |
| PROFILE_5 | TY5_TIER4 | NUMBER | NULL | No | No |
| PROFILE_5 | TY5_THRES4 | NUMBER | NULL | No | No |
| PROFILE_5 | TY5_RATE4 | NUMBER | NULL | No | No |
| PROFILE_5 | TY5_SUR4 | NUMBER | NULL | No | No |
| PROFILE_5 | TY5_TIER5 | NUMBER | NULL | No | No |
| PROFILE_5 | TY5_THRES5 | NUMBER | NULL | No | No |
| PROFILE_5 | TY5_RATE5 | NUMBER | NULL | No | No |
| PROFILE_5 | TY5_SUR5 | NUMBER | NULL | No | No |
| PROFILE_5 | TAX_TYPE6 | VARCHAR2(2) | NULL | No | No |
| PROFILE_5 | TY6_TIER1 | NUMBER | NULL | No | No |
| PROFILE_5 | TY6_THRES1 | NUMBER | NULL | No | No |
| PROFILE_5 | TY6_RATE1 | NUMBER | NULL | No | No |
| PROFILE_5 | TY6_SUR1 | NUMBER | NULL | No | No |
| PROFILE_5 | TY6_TIER2 | NUMBER | NULL | No | No |
| PROFILE_5 | TY6_THRES2 | NUMBER | NULL | No | No |
| PROFILE_5 | TY6_RATE2 | NUMBER | NULL | No | No |
| PROFILE_5 | TY6_SUR2 | NUMBER | NULL | No | No |
| PROFILE_5 | TY6_TIER3 | NUMBER | NULL | No | No |
| PROFILE_5 | TY6_THRES3 | NUMBER | NULL | No | No |
| PROFILE_5 | TY6_RATE3 | NUMBER | NULL | No | No |
| PROFILE_5 | TY6_SUR3 | NUMBER | NULL | No | No |
| PROFILE_5 | TY6_TIER4 | NUMBER | NULL | No | No |
| PROFILE_5 | TY6_THRES4 | NUMBER | NULL | No | No |
| PROFILE_5 | TY6_RATE4 | NUMBER | NULL | No | No |
| PROFILE_5 | TY6_SUR4 | NUMBER | NULL | No | No |
| PROFILE_5 | TY6_TIER5 | NUMBER | NULL | No | No |
| PROFILE_5 | TY6_THRES5 | NUMBER | NULL | No | No |
| PROFILE_5 | TY6_RATE5 | NUMBER | NULL | No | No |
| PROFILE_5 | TY6_SUR5 | NUMBER | NULL | No | No |
| PROFILE_6 | ID | NUMBER | NOT NULL | Yes | No |
| PROFILE_6 | ENVELOPE_ID | NUMBER | NULL | No | Yes |
| PROFILE_6 | TX_TOW_TY | VARCHAR2(4) | NULL | No | No |
| PROFILE_6 | TOW_T_TY1 | VARCHAR2(2) | NULL | No | No |
| PROFILE_6 | TOW_T_IN1 | VARCHAR2(1) | NULL | No | No |
| PROFILE_6 | TOW_T_TY2 | VARCHAR2(2) | NULL | No | No |
| PROFILE_6 | TOW_T_IN2 | VARCHAR2(1) | NULL | No | No |
| PROFILE_6 | TOW_T_TY3 | VARCHAR2(2) | NULL | No | No |
| PROFILE_6 | TOW_T_IN3 | VARCHAR2(1) | NULL | No | No |
| PROFILE_6 | TOW_T_TY4 | VARCHAR2(2) | NULL | No | No |
| PROFILE_6 | TOW_T_IN4 | VARCHAR2(1) | NULL | No | No |
| PROFILE_6 | TOW_T_TY5 | VARCHAR2(2) | NULL | No | No |
| PROFILE_6 | TOW_T_IN5 | VARCHAR2(1) | NULL | No | No |
| PROFILE_6 | TOW_T_TY6 | VARCHAR2(2) | NULL | No | No |
| PROFILE_6 | TOW_T_IN6 | VARCHAR2(1) | NULL | No | No |
| PROFILE_6 | TX_STOR_TY | VARCHAR2(4) | NULL | No | No |
| PROFILE_6 | STOR_T_TY1 | VARCHAR2(2) | NULL | No | No |
| PROFILE_6 | STOR_T_IN1 | VARCHAR2(1) | NULL | No | No |
| PROFILE_6 | STOR_T_TY2 | VARCHAR2(2) | NULL | No | No |
| PROFILE_6 | STOR_T_IN2 | VARCHAR2(1) | NULL | No | No |
| PROFILE_6 | STOR_T_TY3 | VARCHAR2(2) | NULL | No | No |
| PROFILE_6 | STOR_T_IN3 | VARCHAR2(1) | NULL | No | No |
| PROFILE_6 | STOR_T_TY4 | VARCHAR2(2) | NULL | No | No |
| PROFILE_6 | STOR_T_IN4 | VARCHAR2(1) | NULL | No | No |
| PROFILE_6 | STOR_T_TY5 | VARCHAR2(2) | NULL | No | No |
| PROFILE_6 | STOR_T_IN5 | VARCHAR2(1) | NULL | No | No |
| PROFILE_6 | STOR_T_TY6 | VARCHAR2(2) | NULL | No | No |
| PROFILE_6 | STOR_T_IN6 | VARCHAR2(1) | NULL | No | No |
| PROPERTY | COMPANY_ID | NUMBER(10) | NOT NULL | No | No |
| PROPERTY | CT_CODE | CHAR(2) | NULL | No | No |
| PROPERTY | STATUS | CHAR(1) | NOT NULL | No | No |
| PROPERTY | ATTR_KEY | VARCHAR2(32) | NOT NULL | No | No |
| PROPERTY | ATTR_VALUE | VARCHAR2(512) | NULL | No | No |
| PROPERTY_PAIR | COMPANY_ID | NUMBER(10) | NOT NULL | No | No |
| PROPERTY_PAIR | CT_CODE | CHAR(2) | NULL | No | No |
| PROPERTY_PAIR | STATUS | CHAR(1) | NOT NULL | No | No |
| PROPERTY_PAIR | ATTR_KEY | VARCHAR2(32) | NOT NULL | No | No |
| PROPERTY_PAIR | ATTR_VALUE1 | VARCHAR2(512) | NULL | No | No |
| PROPERTY_PAIR | ATTR_VALUE2 | VARCHAR2(512) | NULL | No | No |
| PURCHASING_ACTIVITY_FUL | PAF_PV_ID | NUMBER | NULL | No | No |
| PURCHASING_ACTIVITY_FUL | PAF_BS_ID | NUMBER | NULL | No | No |
| PURCHASING_ACTIVITY_FUL | PAF_IC_ID | NUMBER | NULL | No | No |
| PURCHASING_ACTIVITY_FUL | PAF_PLI_ID | NUMBER | NULL | No | No |
| PURCHASING_ACTIVITY_FUL | PAF_MK_ID | NUMBER | NULL | No | No |
| PURCHASING_ACTIVITY_FUL | PAF_PT_ID | NUMBER | NULL | No | No |
| PURCHASING_ACTIVITY_FUL | PAF_SH_FINAL_PRICE | NUMBER(38,2) | NULL | No | No |
| PURCHASING_ACTIVITY_FUL | PAF_SH_CREATION_DATE | DATE | NULL | No | No |
| PURCHASING_ACTIVITY_FUL | PAF_SH_EST_PRICE | NUMBER(38,2) | NULL | No | No |
| PURCHASING_ACTIVITY_REQ | PAR_PV_ID | NUMBER | NULL | No | No |
| PURCHASING_ACTIVITY_REQ | PAR_BS_ID | NUMBER | NULL | No | No |
| PURCHASING_ACTIVITY_REQ | PAR_IC_ID | NUMBER | NULL | No | No |
| PURCHASING_ACTIVITY_REQ | PAR_PLI_ID | NUMBER | NULL | No | No |
| PURCHASING_ACTIVITY_REQ | PAR_MK_ID | NUMBER | NULL | No | No |
| PURCHASING_ACTIVITY_REQ | PAR_PT_ID | NUMBER | NULL | No | No |
| PURCHASING_ACTIVITY_REQ | PAR_SH_FINAL_PRICE | NUMBER(38,2) | NULL | No | No |
| PURCHASING_ACTIVITY_REQ | PAR_SH_CREATION_DATE | DATE | NULL | No | No |
| PURCHASING_ACTIVITY_REQ | PAR_FULFILLED_FLAG | VARCHAR2(1) | NULL | No | No |
| RELATIONSHIP | RL_MK_ID | NUMBER | NULL | No | No |
| RELATIONSHIP | RL_PT_ID | NUMBER | NULL | No | No |
| RELATIONSHIP | RL_PV_ID | NUMBER | NULL | No | No |
| RELATIONSHIP | RL_BS_ID | NUMBER | NULL | No | No |
| RELATIONSHIP | RL_RLT_ID | VARCHAR2(4) | NOT NULL | No | No |
| RELATIONSHIP | RL_DISCOUNT_AMOUNT | NUMBER(2,2) | NULL | No | No |
| RELATIONSHIP | RL_SPECIAL_DISCOUNT | CHAR(1) | NULL | No | No |
| RELATIONSHIP | RL_VSA_ID | NUMBER | NULL | No | No |
| RELATIONSHIP_BKUP | RL_MK_ID | NUMBER | NULL | No | No |
| RELATIONSHIP_BKUP | RL_PT_ID | NUMBER | NULL | No | No |
| RELATIONSHIP_BKUP | RL_PV_ID | NUMBER | NULL | No | No |
| RELATIONSHIP_BKUP | RL_BS_ID | NUMBER | NULL | No | No |
| RELATIONSHIP_BKUP | RL_RLT_ID | VARCHAR2(4) | NOT NULL | No | No |
| RELATIONSHIP_BKUP | RL_DISCOUNT_AMOUNT | NUMBER(2,2) | NULL | No | No |
| RELATIONSHIP_BKUP | RL_SPECIAL_DISCOUNT | CHAR(1) | NULL | No | No |
| RELATIONSHIP_BKUP | RL_VSA_ID | NUMBER | NULL | No | No |
| RELATIONSHIP_TYPE | RLT_CODE | VARCHAR2(4) | NOT NULL | Yes | No |
| RELATIONSHIP_TYPE | RLT_NAME | VARCHAR2(20) | NULL | No | No |
| REPORT_APR01 | CURR_DATE | DATE | NULL | No | No |
| REPORT_APR01 | BUY_CNT | NUMBER | NULL | No | No |
| REPORT_APR01 | UNIQUE_BUYERS | NUMBER | NULL | No | No |
| REPORT_APR01 | SELL_CNT | NUMBER | NULL | No | No |
| REPORT_APR01 | UNIQUE_SELLERS | NUMBER | NULL | No | No |
| REPORT_APR01 | PEND_CNT | NUMBER | NULL | No | No |
| REPORT_APR01 | CONF_CNT | NUMBER | NULL | No | No |
| REPORT_APR01 | DELTA_MIN_MIN | NUMBER | NULL | No | No |
| REPORT_APR01 | DELTA_AVG_HRS | NUMBER | NULL | No | No |
| REPORT_APR01 | DELTA_MAX_HRS | NUMBER | NULL | No | No |
| REPORT_AUG01 | CURR_DATE | DATE | NULL | No | No |
| REPORT_AUG01 | BUY_CNT | NUMBER | NULL | No | No |
| REPORT_AUG01 | UNIQUE_BUYERS | NUMBER | NULL | No | No |
| REPORT_AUG01 | SELL_CNT | NUMBER | NULL | No | No |
| REPORT_AUG01 | UNIQUE_SELLERS | NUMBER | NULL | No | No |
| REPORT_AUG01 | PEND_CNT | NUMBER | NULL | No | No |
| REPORT_AUG01 | CONF_CNT | NUMBER | NULL | No | No |
| REPORT_AUG01 | DELTA_MIN_MIN | NUMBER | NULL | No | No |
| REPORT_AUG01 | DELTA_AVG_HRS | NUMBER | NULL | No | No |
| REPORT_AUG01 | DELTA_MAX_HRS | NUMBER | NULL | No | No |
| REPORT_DEC00 | CURR_DATE | DATE | NULL | No | No |
| REPORT_DEC00 | BUY_CNT | NUMBER | NULL | No | No |
| REPORT_DEC00 | UNIQUE_BUYERS | NUMBER | NULL | No | No |
| REPORT_DEC00 | SELL_CNT | NUMBER | NULL | No | No |
| REPORT_DEC00 | UNIQUE_SELLERS | NUMBER | NULL | No | No |
| REPORT_DEC00 | PEND_CNT | NUMBER | NULL | No | No |
| REPORT_DEC00 | CONF_CNT | NUMBER | NULL | No | No |
| REPORT_DEC00 | DELTA_MIN | NUMBER | NULL | No | No |
| REPORT_DEC00 | DELTA_AVG | NUMBER | NULL | No | No |
| REPORT_DEC00 | DELTA_MAX | NUMBER | NULL | No | No |
| REPORT_FEB01 | CURR_DATE | DATE | NULL | No | No |
| REPORT_FEB01 | BUY_CNT | NUMBER | NULL | No | No |
| REPORT_FEB01 | UNIQUE_BUYERS | NUMBER | NULL | No | No |
| REPORT_FEB01 | SELL_CNT | NUMBER | NULL | No | No |
| REPORT_FEB01 | UNIQUE_SELLERS | NUMBER | NULL | No | No |
| REPORT_FEB01 | PEND_CNT | NUMBER | NULL | No | No |
| REPORT_FEB01 | CONF_CNT | NUMBER | NULL | No | No |
| REPORT_FEB01 | DELTA_MIN_MIN | NUMBER | NULL | No | No |
| REPORT_FEB01 | DELTA_AVG_HRS | NUMBER | NULL | No | No |
| REPORT_FEB01 | DELTA_MAX_HRS | NUMBER | NULL | No | No |
| REPORT_JAN01 | CURR_DATE | DATE | NULL | No | No |
| REPORT_JAN01 | BUY_CNT | NUMBER | NULL | No | No |
| REPORT_JAN01 | UNIQUE_BUYERS | NUMBER | NULL | No | No |
| REPORT_JAN01 | SELL_CNT | NUMBER | NULL | No | No |
| REPORT_JAN01 | UNIQUE_SELLERS | NUMBER | NULL | No | No |
| REPORT_JAN01 | PEND_CNT | NUMBER | NULL | No | No |
| REPORT_JAN01 | CONF_CNT | NUMBER | NULL | No | No |
| REPORT_JAN01 | DELTA_MIN_MIN | NUMBER | NULL | No | No |
| REPORT_JAN01 | DELTA_AVG_HRS | NUMBER | NULL | No | No |
| REPORT_JAN01 | DELTA_MAX_HRS | NUMBER | NULL | No | No |
| REPORT_JUL01 | CURR_DATE | DATE | NULL | No | No |
| REPORT_JUL01 | BUY_CNT | NUMBER | NULL | No | No |
| REPORT_JUL01 | UNIQUE_BUYERS | NUMBER | NULL | No | No |
| REPORT_JUL01 | SELL_CNT | NUMBER | NULL | No | No |
| REPORT_JUL01 | UNIQUE_SELLERS | NUMBER | NULL | No | No |
| REPORT_JUL01 | PEND_CNT | NUMBER | NULL | No | No |
| REPORT_JUL01 | CONF_CNT | NUMBER | NULL | No | No |
| REPORT_JUL01 | DELTA_MIN_MIN | NUMBER | NULL | No | No |
| REPORT_JUL01 | DELTA_AVG_HRS | NUMBER | NULL | No | No |
| REPORT_JUL01 | DELTA_MAX_HRS | NUMBER | NULL | No | No |
| REPORT_JUN01 | CURR_DATE | DATE | NULL | No | No |
| REPORT_JUN01 | BUY_CNT | NUMBER | NULL | No | No |
| REPORT_JUN01 | UNIQUE_BUYERS | NUMBER | NULL | No | No |
| REPORT_JUN01 | SELL_CNT | NUMBER | NULL | No | No |
| REPORT_JUN01 | UNIQUE_SELLERS | NUMBER | NULL | No | No |
| REPORT_JUN01 | PEND_CNT | NUMBER | NULL | No | No |
| REPORT_JUN01 | CONF_CNT | NUMBER | NULL | No | No |
| REPORT_JUN01 | DELTA_MIN_MIN | NUMBER | NULL | No | No |
| REPORT_JUN01 | DELTA_AVG_HRS | NUMBER | NULL | No | No |
| REPORT_JUN01 | DELTA_MAX_HRS | NUMBER | NULL | No | No |
| REPORT_MAR01 | CURR_DATE | DATE | NULL | No | No |
| REPORT_MAR01 | BUY_CNT | NUMBER | NULL | No | No |
| REPORT_MAR01 | UNIQUE_BUYERS | NUMBER | NULL | No | No |
| REPORT_MAR01 | SELL_CNT | NUMBER | NULL | No | No |
| REPORT_MAR01 | UNIQUE_SELLERS | NUMBER | NULL | No | No |
| REPORT_MAR01 | PEND_CNT | NUMBER | NULL | No | No |
| REPORT_MAR01 | CONF_CNT | NUMBER | NULL | No | No |
| REPORT_MAR01 | DELTA_MIN_MIN | NUMBER | NULL | No | No |
| REPORT_MAR01 | DELTA_AVG_HRS | NUMBER | NULL | No | No |
| REPORT_MAR01 | DELTA_MAX_HRS | NUMBER | NULL | No | No |
| REPORT_MAY01 | CURR_DATE | DATE | NULL | No | No |
| REPORT_MAY01 | BUY_CNT | NUMBER | NULL | No | No |
| REPORT_MAY01 | UNIQUE_BUYERS | NUMBER | NULL | No | No |
| REPORT_MAY01 | SELL_CNT | NUMBER | NULL | No | No |
| REPORT_MAY01 | UNIQUE_SELLERS | NUMBER | NULL | No | No |
| REPORT_MAY01 | PEND_CNT | NUMBER | NULL | No | No |
| REPORT_MAY01 | CONF_CNT | NUMBER | NULL | No | No |
| REPORT_MAY01 | DELTA_MIN_MIN | NUMBER | NULL | No | No |
| REPORT_MAY01 | DELTA_AVG_HRS | NUMBER | NULL | No | No |
| REPORT_MAY01 | DELTA_MAX_HRS | NUMBER | NULL | No | No |
| REPORT_NOV00 | CURR_DATE | DATE | NULL | No | No |
| REPORT_NOV00 | BUY_CNT | NUMBER | NULL | No | No |
| REPORT_NOV00 | UNIQUE_BUYERS | NUMBER | NULL | No | No |
| REPORT_NOV00 | SELL_CNT | NUMBER | NULL | No | No |
| REPORT_NOV00 | UNIQUE_SELLERS | NUMBER | NULL | No | No |
| REPORT_NOV00 | PEND_CNT | NUMBER | NULL | No | No |
| REPORT_NOV00 | CONF_CNT | NUMBER | NULL | No | No |
| REPORT_NOV00 | DELTA_MIN | NUMBER | NULL | No | No |
| REPORT_NOV00 | DELTA_AVG | NUMBER | NULL | No | No |
| REPORT_NOV00 | DELTA_MAX | NUMBER | NULL | No | No |
| REPORT_OCT01 | CURR_DATE | DATE | NULL | No | No |
| REPORT_OCT01 | BUY_CNT | NUMBER | NULL | No | No |
| REPORT_OCT01 | UNIQUE_BUYERS | NUMBER | NULL | No | No |
| REPORT_OCT01 | SELL_CNT | NUMBER | NULL | No | No |
| REPORT_OCT01 | UNIQUE_SELLERS | NUMBER | NULL | No | No |
| REPORT_OCT01 | PEND_CNT | NUMBER | NULL | No | No |
| REPORT_OCT01 | CONF_CNT | NUMBER | NULL | No | No |
| REPORT_OCT01 | DELTA_MIN_MIN | NUMBER | NULL | No | No |
| REPORT_OCT01 | DELTA_AVG_HRS | NUMBER | NULL | No | No |
| REPORT_OCT01 | DELTA_MAX_HRS | NUMBER | NULL | No | No |
| REPORT_SEPT01 | CURR_DATE | DATE | NULL | No | No |
| REPORT_SEPT01 | BUY_CNT | NUMBER | NULL | No | No |
| REPORT_SEPT01 | UNIQUE_BUYERS | NUMBER | NULL | No | No |
| REPORT_SEPT01 | SELL_CNT | NUMBER | NULL | No | No |
| REPORT_SEPT01 | UNIQUE_SELLERS | NUMBER | NULL | No | No |
| REPORT_SEPT01 | PEND_CNT | NUMBER | NULL | No | No |
| REPORT_SEPT01 | CONF_CNT | NUMBER | NULL | No | No |
| REPORT_SEPT01 | DELTA_MIN_MIN | NUMBER | NULL | No | No |
| REPORT_SEPT01 | DELTA_AVG_HRS | NUMBER | NULL | No | No |
| REPORT_SEPT01 | DELTA_MAX_HRS | NUMBER | NULL | No | No |
| REPORTS_DISCOUNTS | RD_PV_ID | NUMBER | NULL | No | No |
| REPORTS_DISCOUNTS | RD_BS_ID | NUMBER | NULL | No | No |
| REPORTS_DISCOUNTS | RD_RL_DISCOUNT_AMOUNT | NUMBER(2,2) | NULL | No | No |
| REPORTS_LOAD_STATUS | RLS_LOAD_IN_PROCESS_FLAG | VARCHAR2(1) | NULL | No | No |
| REPORTS_LOAD_STATUS | RLS_LOAD_SUCCESSFUL_FLAG | VARCHAR2(1) | NULL | No | No |
| REPORTS_LOAD_STATUS | RLS_DATE_LAST_LOADED | DATE | NULL | No | No |
| REPORTS_LOAD_STATUS | RLS_LOAD_ERROR_DESCRIPTION | VARCHAR2(1000) | NULL | No | No |
| RETURNS | R_PV_ID | NUMBER | NULL | No | No |
| RETURNS | R_BS_ID | NUMBER | NULL | No | No |
| RETURNS | R_IC_ID | NUMBER | NULL | No | No |
| RETURNS | R_PLI_ID | NUMBER | NULL | No | No |
| RETURNS | R_MK_ID | NUMBER | NULL | No | No |
| RETURNS | R_PT_ID | NUMBER | NULL | No | No |
| RETURNS | R_SH_FINAL_PRICE | NUMBER(38,2) | NULL | No | No |
| RETURNS | R_SH_RESTOCKING_FEE | NUMBER(38,2) | NULL | No | No |
| RETURNS | R_SH_CREATION_DATE | DATE | NULL | No | No |
| RETURNS | R_VAL_ID | NUMBER | NULL | No | No |
| RETURNS | R_SH_EST_PRICE | NUMBER(38,2) | NULL | No | No |
| SCHEDULE | COMPANY_ID | NUMBER(10) | NOT NULL | No | No |
| SCHEDULE | CT_CODE | CHAR(2) | NULL | No | No |
| SCHEDULE | STATUS | CHAR(1) | NOT NULL | No | No |
| SCHEDULE | ATTR_KEY | CHAR(4) | NOT NULL | No | No |
| SCHEDULE | OPEN | NUMBER | NOT NULL | No | No |
| SCHEDULE | CLOSE | NUMBER | NOT NULL | No | No |
| SEARCH_TIER_RELATION | SUBSCRIBER_ID | NUMBER(10) | NOT NULL | No | No |
| SEARCH_TIER_RELATION | SUBSCRIBER_TYPE | CHAR(2) | NULL | No | No |
| SEARCH_TIER_RELATION | RELATION_TIER | CHAR(1) | NOT NULL | No | No |
| SEARCH_TIER_RELATION | CONTRIB_ID | NUMBER(10) | NOT NULL | No | No |
| SERVICE_REGION_CITY | SRCT_ID | NUMBER | NOT NULL | Yes | No |
| SERVICE_REGION_CITY | SRCT_SRC_ID | NUMBER | NULL | No | No |
| SERVICE_REGION_CITY | SRCT_CITY_NAME | VARCHAR2(50) | NULL | No | No |
| SERVICE_REGION_COUNTY | SRC_ID | NUMBER | NOT NULL | Yes | No |
| SERVICE_REGION_COUNTY | SRC_COUNTY_NAME | VARCHAR2(50) | NULL | No | No |
| SHIPMENT_METHOD | SHIP_ID | NUMBER | NOT NULL | Yes | No |
| SHIPMENT_METHOD | SHIP_METHOD | VARCHAR2(20) | NULL | No | No |
| SHOP_LOCATOR | SL_ID | NUMBER | NOT NULL | Yes | No |
| SHOP_LOCATOR | SL_SLT_ID | NUMBER | NULL | No | Yes |
| SHOP_LOCATOR | SL_BS_ID | NUMBER | NULL | No | Yes |
| SHOP_LOCATOR | SL_SHOP_NAME | VARCHAR2(50) | NULL | No | No |
| SHOP_LOCATOR | SL_ADDRESS | VARCHAR2(100) | NULL | No | No |
| SHOP_LOCATOR | SL_CITY | VARCHAR2(30) | NULL | No | No |
| SHOP_LOCATOR | SL_STATE | VARCHAR2(2) | NULL | No | No |
| SHOP_LOCATOR | SL_ZIP | VARCHAR2(11) | NULL | No | No |
| SHOP_LOCATOR | SL_MAIN_PHONE | CHAR(14) | NULL | No | No |
| SHOP_LOCATOR | SL_MAIN_FAX | VARCHAR2(10) | NULL | No | No |
| SHOP_LOCATOR | SL_URL | VARCHAR2(100) | NULL | No | No |
| SHOP_LOCATOR | SL_SPECIALTY | VARCHAR2(200) | NULL | No | No |
| SHOP_LOCATOR | SL_CERTIFICATION | VARCHAR2(200) | NULL | No | No |
| SHOP_LOCATOR | SL_REGISTERED | CHAR(1) | NOT NULL | No | No |
| SHOP_LOCATOR | LATITUDE | NUMBER(9) | NULL | No | No |
| SHOP_LOCATOR | LONGITUDE | NUMBER(9) | NULL | No | No |
| SHOP_LOCATOR | SL_INF_LOCNUM | VARCHAR2(9) | NULL | No | No |
| SHOP_LOCATOR | SL_EMAIL_ADDRESS | VARCHAR2(80) | NULL | No | No |
| SHOP_LOCATOR | SL_ALLOW_SCHEDULING | CHAR(1) | NULL | No | No |
| SHOP_LOCATOR | PROG_REGISTERED | CHAR(1) | NOT NULL | No | No |
| SHOP_LOCATOR | PROG_TOWING | VARCHAR2(72) | NULL | No | No |
| SHOP_LOCATOR | PROG_VALUE_ADDED | VARCHAR2(72) | NULL | No | No |
| SHOP_LOCATOR | DATE_CREATED | DATE | NULL | No | No |
| SHOP_LOCATOR | USER_CREATED | VARCHAR2(35) | NULL | No | No |
| SHOP_LOCATOR | DATE_MODIFIED | DATE | NULL | No | No |
| SHOP_LOCATOR | USER_MODIFIED | VARCHAR2(35) | NULL | No | No |
| SHOP_LOCATOR_BACKUP | SL_ID | NUMBER | NOT NULL | No | No |
| SHOP_LOCATOR_BACKUP | SL_SLT_ID | NUMBER | NULL | No | No |
| SHOP_LOCATOR_BACKUP | SL_BS_ID | NUMBER | NULL | No | No |
| SHOP_LOCATOR_BACKUP | SL_SHOP_NAME | VARCHAR2(50) | NULL | No | No |
| SHOP_LOCATOR_BACKUP | SL_ADDRESS | VARCHAR2(100) | NULL | No | No |
| SHOP_LOCATOR_BACKUP | SL_CITY | VARCHAR2(30) | NULL | No | No |
| SHOP_LOCATOR_BACKUP | SL_STATE | VARCHAR2(2) | NULL | No | No |
| SHOP_LOCATOR_BACKUP | SL_ZIP | VARCHAR2(11) | NULL | No | No |
| SHOP_LOCATOR_BACKUP | SL_MAIN_PHONE | CHAR(14) | NULL | No | No |
| SHOP_LOCATOR_BACKUP | SL_MAIN_FAX | VARCHAR2(10) | NULL | No | No |
| SHOP_LOCATOR_BACKUP | SL_URL | VARCHAR2(100) | NULL | No | No |
| SHOP_LOCATOR_BACKUP | SL_SPECIALTY | VARCHAR2(200) | NULL | No | No |
| SHOP_LOCATOR_BACKUP | SL_CERTIFICATION | VARCHAR2(200) | NULL | No | No |
| SHOP_LOCATOR_BACKUP | SL_REGISTERED | CHAR(1) | NOT NULL | No | No |
| SHOP_LOCATOR_BACKUP | LATITUDE | NUMBER(9) | NULL | No | No |
| SHOP_LOCATOR_BACKUP | LONGITUDE | NUMBER(9) | NULL | No | No |
| SHOP_LOCATOR_BACKUP | SL_INF_LOCNUM | VARCHAR2(9) | NULL | No | No |
| SHOP_LOCATOR_BACKUP | SL_EMAIL_ADDRESS | VARCHAR2(80) | NULL | No | No |
| SHOP_LOCATOR_BACKUP | SL_ALLOW_SCHEDULING | CHAR(1) | NULL | No | No |
| SHOP_LOCATOR_BACKUP | PROG_REGISTERED | CHAR(1) | NOT NULL | No | No |
| SHOP_LOCATOR_BACKUP | PROG_TOWING | VARCHAR2(72) | NULL | No | No |
| SHOP_LOCATOR_BACKUP | PROG_VALUE_ADDED | VARCHAR2(72) | NULL | No | No |
| SHOP_LOCATOR_LOG | SLL_DATE_TIME | DATE | NULL | No | No |
| SHOP_LOCATOR_LOG | SLL_NUMBER_FOUND | NUMBER | NULL | No | No |
| SHOP_LOCATOR_LOG | SLL_CLASS | VARCHAR2(40) | NULL | No | No |
| SHOP_LOCATOR_LOG | SLL_COMPONENT | VARCHAR2(40) | NULL | No | No |
| SHOP_LOCATOR_LOG | SLL_SEARCH_TYPE | VARCHAR2(20) | NULL | No | No |
| SHOP_LOCATOR_LOG | SLL_ADDRESS | VARCHAR2(100) | NULL | No | No |
| SHOP_LOCATOR_LOG | SLL_CITY | VARCHAR2(30) | NULL | No | No |
| SHOP_LOCATOR_LOG | SLL_STATE | VARCHAR2(2) | NULL | No | No |
| SHOP_LOCATOR_LOG | SLL_ZIP | VARCHAR2(11) | NULL | No | No |
| SHOP_LOCATOR_LOG | SLL_PHONE | VARCHAR2(14) | NULL | No | No |
| SHOP_LOCATOR_LOG | SLL_RADIUS | NUMBER | NULL | No | No |
| SHOP_LOCATOR_LOG | SLL_COMPANY_NAME | VARCHAR2(50) | NULL | No | No |
| SHOP_LOCATOR_LOG | SLL_NICK_NAME | VARCHAR2(20) | NULL | No | No |
| SHOP_LOCATOR_TYPE | SLT_ID | NUMBER | NOT NULL | Yes | No |
| SHOP_LOCATOR_TYPE | SLT_TYPE | VARCHAR2(20) | NULL | No | No |
| SIM_CAR_DUMP | COMPANY_STATUS | VARCHAR2(50) | NULL | No | No |
| SIM_CAR_DUMP | COMPANY_ID | NUMBER | NULL | No | No |
| SIM_CAR_DUMP | CT_CODE | VARCHAR2(50) | NULL | No | No |
| SIM_CAR_DUMP | COMPANY_NAME | VARCHAR2(50) | NULL | No | No |
| SIM_CAR_DUMP | FIRST_NAME | VARCHAR2(50) | NULL | No | No |
| SIM_CAR_DUMP | LAST_NAME | VARCHAR2(50) | NULL | No | No |
| SIM_CAR_DUMP | USER_NAME | VARCHAR2(50) | NULL | No | No |
| SIM_CAR_DUMP | STREET1 | VARCHAR2(50) | NULL | No | No |
| SIM_CAR_DUMP | STREET2 | VARCHAR2(50) | NULL | No | No |
| SIM_CAR_DUMP | COUNTRY | VARCHAR2(50) | NULL | No | No |
| SIM_CAR_DUMP | CITY | VARCHAR2(50) | NULL | No | No |
| SIM_CAR_DUMP | STATE | VARCHAR2(50) | NULL | No | No |
| SIM_CAR_DUMP | POSTAL_CODE | VARCHAR2(50) | NULL | No | No |
| SIM_CAR_DUMP | AREA_CODE | VARCHAR2(50) | NULL | No | No |
| SIM_CAR_DUMP | PHONE_NUMBER | VARCHAR2(50) | NULL | No | No |
| SIM_CAR_DUMP | PN_CT_CODE | VARCHAR2(50) | NULL | No | No |
| SQLSRV_MAKE | SM_ID | NUMBER | NOT NULL | Yes | No |
| SQLSRV_MAKE | SM_NAME | VARCHAR2(50) | NULL | No | No |
| SQLSRV_MAKE | SM_DISPLAY_NAME | VARCHAR2(50) | NULL | No | No |
| SQLSRV_TABLENAME | ST_ID | NUMBER | NOT NULL | Yes | No |
| SQLSRV_TABLENAME | ST_TABLENAME | VARCHAR2(50) | NULL | No | No |
| STATE | ST_ID | NUMBER | NOT NULL | Yes | No |
| STATE | ST_NAME | VARCHAR2(50) | NULL | No | No |
| STATE | ST_DESCRIPTION | VARCHAR2(250) | NULL | No | No |
| STATE | ST_DISPLAY | VARCHAR2(50) | NULL | No | No |
| STATE_HISTORY | SH_ID | NUMBER | NOT NULL | Yes | No |
| STATE_HISTORY | SH_ST_ID | NUMBER | NULL | No | Yes |
| STATE_HISTORY | SH_PT_ID | NUMBER | NULL | No | Yes |
| STATE_HISTORY | SH_PLI_ID | NUMBER | NULL | No | Yes |
| STATE_HISTORY | SH_PV_ID | NUMBER | NULL | No | Yes |
| STATE_HISTORY | SH_CREATION_DATE | DATE | NULL | No | No |
| STATE_HISTORY | SH_COMMENT | VARCHAR2(100) | NULL | No | No |
| STATE_HISTORY | SH_QUOTE_PRICE | NUMBER(22,2) | NULL | No | No |
| STATE_HISTORY | SH_FINAL_PRICE | NUMBER(22,2) | NULL | No | No |
| STATE_HISTORY | SH_ESTIMATION_LIST_PRICE | NUMBER(22,2) | NULL | No | No |
| STATE_HISTORY | SH_RESTOCKING_FEE | NUMBER(22,2) | NULL | No | No |
| STATE_HISTORY | SH_RETURN_AMOUNT | NUMBER(22,2) | NULL | No | No |
| STATE_HISTORY | SH_QUANTITY | NUMBER | NULL | No | No |
| STATE_HISTORY | SH_DISCOUNT_AMOUNT | NUMBER(22,2) | NULL | No | No |
| STATE_HISTORY | SH_EXPECTED_FULFILLMENT_DATE | DATE | NULL | No | No |
| STATE_HISTORY | SH_REQUESTED_DATE | DATE | NULL | No | No |
| STATE_HISTORY | SH_CAPA_FLAG | CHAR(1) | NULL | No | No |
| STATE_HISTORY | SH_CUT_OFF_TIME | DATE | NULL | No | No |
| STATE_HISTORY | SH_TRACKING_NUMBER | VARCHAR2(20) | NULL | No | No |
| STATE_HISTORY | SH_EV_ID | NUMBER | NULL | No | Yes |
| STATE_HISTORY | SH_CLEANUP_HOURS | NUMBER | NULL | No | No |
| STATE_HISTORY | SH_RS_FULFILL_FLAG | CHAR(1) | NULL | No | No |
| STATE_HISTORY | SH_PLI_PART_NUMBER | VARCHAR2(50) | NULL | No | No |
| STATE_HISTORY | SH_VERIFICATION_METHOD | NUMBER(1) | NULL | No | No |
| STATE_HISTORY_REASON | SHRE_VAL_ID | NUMBER | NOT NULL | Yes | Yes |
| STATE_HISTORY_REASON | SHRE_SH_ID | NUMBER | NOT NULL | Yes | Yes |
| STATE_HISTORY_VALUE_PAIR | SHVP_VAL_ID | NUMBER | NOT NULL | Yes | Yes |
| STATE_HISTORY_VALUE_PAIR | SHVP_SH_ID | NUMBER | NOT NULL | Yes | Yes |
| STATES | STATE_ID | NUMBER | NOT NULL | Yes | No |
| STATES | COUNTRY_ID | NUMBER | NOT NULL | No | Yes |
| STATES | STATE_CODE | VARCHAR2(20) | NOT NULL | No | No |
| STATES | STATE_NAME | VARCHAR2(50) | NULL | No | No |
| SUBSCRIBER | SUBSCRIBER_ID | NUMBER(10) | NOT NULL | No | No |
| SUBSCRIBER | SUBSCRIBER_ACTIVE | NUMBER(1) | NOT NULL | No | No |
| SUBSCRIBER | ARA_ID | NUMBER(10) | NULL | No | No |
| SUBSCRIBER | ARA_DESCRIPTION | VARCHAR2(25) | NULL | No | No |
| SUBSCRIBER | SUBSCRIBER_NAME | VARCHAR2(50) | NULL | No | No |
| SUBSCRIBER | CONTACT1_FIRST_NAME | VARCHAR2(25) | NULL | No | No |
| SUBSCRIBER | CONTACT1_LAST_NAME | VARCHAR2(25) | NULL | No | No |
| SUBSCRIBER | CONTACT2_FIRST NAME | VARCHAR2(25) | NULL | No | No |
| SUBSCRIBER | CONTACT2_LAST_NAME | VARCHAR2(25) | NULL | No | No |
| SUBSCRIBER | ADDRESS1 | VARCHAR2(30) | NULL | No | No |
| SUBSCRIBER | ADDRESS2 | VARCHAR2(30) | NULL | No | No |
| SUBSCRIBER | CITY | VARCHAR2(25) | NULL | No | No |
| SUBSCRIBER | STATE | CHAR(2) | NULL | No | No |
| SUBSCRIBER | ZIP_CODE | VARCHAR2(10) | NULL | No | No |
| SUBSCRIBER | COUNTRY | VARCHAR2(25) | NULL | No | No |
| SUBSCRIBER | TOLL_FREE_PHONE | VARCHAR2(11) | NULL | No | No |
| SUBSCRIBER | LOCAL_PHONE | VARCHAR2(11) | NULL | No | No |
| SUBSCRIBER | FAX_PHONE | VARCHAR2(11) | NULL | No | No |
| SUBSCRIBER | E_MAIL | VARCHAR2(50) | NULL | No | No |
| SUBSCRIBER | WWW_ADDRESS | VARCHAR2(50) | NULL | No | No |
| TBL_NAME | TN_ID | NUMBER | NOT NULL | Yes | No |
| TBL_NAME | TN_CATL_ID | NUMBER | NULL | No | No |
| TBL_NAME | TN_ST_ID | NUMBER | NULL | No | No |
| TBL_NAME | TN_DESC | VARCHAR2(50) | NULL | No | No |
| TOTALS_1 | ID | NUMBER | NOT NULL | Yes | No |
| TOTALS_1 | ENVELOPE_ID | NUMBER | NULL | No | Yes |
| TOTALS_1 | TTL_TYPE | VARCHAR2(4) | NULL | No | No |
| TOTALS_1 | TTL_TYPECD | VARCHAR2(4) | NULL | No | No |
| TOTALS_1 | T_AMT | NUMBER(9,2) | NULL | No | No |
| TOTALS_1 | T_HRS | NUMBER(5,1) | NULL | No | No |
| TOTALS_1 | T_ADDLBR | NUMBER(9,2) | NULL | No | No |
| TOTALS_1 | T_DISCAMT | NUMBER(9,2) | NULL | No | No |
| TOTALS_1 | T_MKUPAMT | NUMBER(9,2) | NULL | No | No |
| TOTALS_1 | T_GDISCAMT | NUMBER(9,2) | NULL | No | No |
| TOTALS_1 | TAX_AMT | CHAR(18) | NULL | No | No |
| VEHICLE_INFO | VI_YEAR | VARCHAR2(20) | NULL | No | No |
| VEHICLE_INFO | VI_ADDITIONAL_INFO | VARCHAR2(100) | NULL | No | No |
| VEHICLESTATUS | BS_ID | NUMBER | NULL | No | No |
| VEHICLESTATUS | FIRSTNAME | VARCHAR2(50) | NULL | No | No |
| VEHICLESTATUS | LASTNAME | VARCHAR2(50) | NULL | No | No |
| VEHICLESTATUS | CLAIMNUMBER | VARCHAR2(50) | NULL | No | No |
| VEHICLESTATUS | REPAIRORDERNUMBER | VARCHAR2(50) | NULL | No | No |
| VEHICLESTATUS | REPORDERCREATIONDATE | DATE | NULL | No | No |
| VEHICLESTATUS | RECEPTIONDATE | DATE | NULL | No | No |
| VEHICLESTATUS | STARTDATE | DATE | NULL | No | No |
| VEHICLESTATUS | CUSTAPPROVEDATE | DATE | NULL | No | No |
| VEHICLESTATUS | INSRAPPROVEDATE | DATE | NULL | No | No |
| VEHICLESTATUS | DISASSEMBLYDATE | DATE | NULL | No | No |
| VEHICLESTATUS | BODYLABORDATE | DATE | NULL | No | No |
| VEHICLESTATUS | FRAMELABORDATE | DATE | NULL | No | No |
| VEHICLESTATUS | MECHANICALLABORDATE | DATE | NULL | No | No |
| VEHICLESTATUS | PREPARATIONDATE | DATE | NULL | No | No |
| VEHICLESTATUS | SPRAYDATE | DATE | NULL | No | No |
| VEHICLESTATUS | REFINISHDATE | DATE | NULL | No | No |
| VEHICLESTATUS | REASSEMBLYDATE | DATE | NULL | No | No |
| VEHICLESTATUS | DETAILBODYDATE | DATE | NULL | No | No |
| VEHICLESTATUS | DETAILOTHERDATE | DATE | NULL | No | No |
| VEHICLESTATUS | QCCHECKDATE | DATE | NULL | No | No |
| VEHICLESTATUS | COMPLETIONDATE | DATE | NULL | No | No |
| VEHICLESTATUS | EMAILADDRESS | VARCHAR2(255) | NULL | No | No |
| VEHICLESTATUS | NOTIFICATIONDATE | DATE | NULL | No | No |
| VEHICLESTATUS | TARGETDELIVERYDATE | DATE | NULL | No | No |
| VEHICLESTATUS | DELIVERYDATE | DATE | NULL | No | No |
| VEHICLESTATUS | LICENSEPLATE | VARCHAR2(10) | NULL | No | No |
| VEHICLESTATUS | PERCENTCOMPLETE | VARCHAR2(10) | NULL | No | No |
| VEHICLESTATUS | LASTUPDATED | DATE | NULL | No | No |
| VEHICLESTATUS | EMAILNOTIFICATIONDATE | DATE | NULL | No | No |
| VEHICLESTATUS | COMMENTS | VARCHAR2(100) | NULL | No | No |
| VENDOR_MAP | PV_ID | NUMBER | NOT NULL | No | Yes |
| VENDOR_MAP | BS_ID | NUMBER | NOT NULL | Yes | Yes |
| VENDOR_MAP | EXTERNAL_ID | VARCHAR2(12) | NOT NULL | Yes | No |
| VENDORSERVICEAREAS | VSA_ID | NUMBER | NOT NULL | Yes | No |
| VENDORSERVICEAREAS | PV_ID | NUMBER | NOT NULL | No | No |
| VENDORSERVICEAREAS | COUNTRY_ID | NUMBER | NULL | No | Yes |
| VENDORSERVICEAREAS | STATE_ID | NUMBER | NULL | No | Yes |
| VENDORSERVICEAREAS | CITY_ID | NUMBER | NULL | No | Yes |
| VENDORSERVICEAREAS | COUNTY_ID | NUMBER | NULL | No | Yes |
| VENDORSERVICEAREAS | ZIP_ID | NUMBER | NULL | No | Yes |
| VENDORSERVICEAREAS | MSA_ID | NUMBER | NULL | No | Yes |
| VENDORSERVICEAREAS | STATUS | NUMBER | NOT NULL | No | No |
| VENDORSERVICEAREAS | RADIALZIP | NUMBER | NULL | No | No |
| VENDORSERVICEAREAS | RADIUS | NUMBER | NULL | No | No |
| VENDORSERVICEAREAS | ENTIRE | NUMBER(1) | NULL | No | No |
| WEB_IMAGE | COMPANY_ID | NUMBER(10) | NOT NULL | No | No |
| WEB_IMAGE | CT_CODE | CHAR(2) | NULL | No | No |
| WEB_IMAGE | STATUS | CHAR(1) | NOT NULL | No | No |
| WEB_IMAGE | ATTR_KEY | VARCHAR2(32) | NOT NULL | No | No |
| WEB_IMAGE | MIME_TYPE | VARCHAR2(64) | NULL | No | No |
| WEB_IMAGE | IMAGE | LONG RAW | NULL | No | No |
| ZIPS | ZIP_ID | NUMBER | NOT NULL | Yes | No |
| ZIPS | POSTAL_CODE | VARCHAR2(5) | NOT NULL | No | No |
| ZIPS | CITY_ID | NUMBER | NULL | No | Yes |
| ZIPS | COUNTY_ID | NUMBER | NULL | No | Yes |
| ZIPS | MSA_ID | NUMBER | NULL | No | Yes |
| ZIPS | TIME_ZONE | VARCHAR2(4) | NULL | No | No |
| ZIPS | LATITUDE | NUMBER(7,4) | NULL | No | No |
| ZIPS | LONGITUDE | NUMBER(8,4) | NULL | No | No |
| ZIPS | STATE_ID | NUMBER | NULL | No | No |
| ZIPS_BACKUP | ZIP_ID | NUMBER | NOT NULL | No | No |
| ZIPS_BACKUP | POSTAL_CODE | VARCHAR2(5) | NOT NULL | No | No |
| ZIPS_BACKUP | CITY_ID | NUMBER | NULL | No | No |
| ZIPS_BACKUP | COUNTY_ID | NUMBER | NULL | No | No |
| ZIPS_BACKUP | MSA_ID | NUMBER | NULL | No | No |
| ZIPS_BACKUP | TIME_ZONE | VARCHAR2(4) | NULL | No | No |
| ZIPS_BACKUP | LATITUDE | NUMBER(7,4) | NULL | No | No |
| ZIPS_BACKUP | LONGITUDE | NUMBER(8,4) | NULL | No | No |
| ZIPS_BACKUP | STATE_ID | NUMBER | NULL | No | No |
| VEHICLE | V_COND | VARCHAR2(2) | NULL | No | No |
| VEHICLE | V_PROD_DT | VARCHAR2(4) | NULL | No | No |
| VEHICLE | V_MODEL_YR | VARCHAR2(4) | NULL | No | No |
| VEHICLE | V_MAKECODE | VARCHAR2(20) | NULL | No | No |
| VEHICLE | V_MAKEDESC | VARCHAR2(20) | NULL | No | No |
| VEHICLE | V_MODEL | VARCHAR2(50) | NULL | No | No |
| VEHICLE | V_TYPE | VARCHAR2(2) | NULL | No | No |
| VEHICLE | V_BSTYLE | VARCHAR2(20) | NULL | No | No |
| VEHICLE | V_TRIMCODE | VARCHAR2(20) | NULL | No | No |
| VEHICLE | TRIM_COLOR | VARCHAR2(20) | NULL | No | No |
| VEHICLE | V_MLDGCODE | VARCHAR2(20) | NULL | No | No |
| VEHICLE | V_ENGINE | VARCHAR2(20) | NULL | No | No |
| VEHICLE | V_MILEAGE | VARCHAR2(6) | NULL | No | No |
| VEHICLE | V_OPTIONS | VARCHAR2(4000) | NULL | No | No |
| VEHICLE | V_COLOR | VARCHAR2(20) | NULL | No | No |
| VEHICLE | V_TONE | NUMBER | NULL | No | No |
| VEHICLE | V_STAGE | NUMBER | NULL | No | No |
| VEHICLE | PAINT_CD1 | VARCHAR2(15) | NULL | No | No |
| VEHICLE | PAINT_CD2 | VARCHAR2(15) | NULL | No | No |
| VEHICLE | PAINT_CD3 | VARCHAR2(15) | NULL | No | No |
| VEHICLE | V_MEMO | VARCHAR2(100) | NULL | No | No |
| VEHICLE_DAMAGE_CODES | CODE | CHAR(6) | NOT NULL | Yes | No |
| VEHICLE_DAMAGE_CODES | DESCRIPTION | VARCHAR2(20) | NOT NULL | No | No |
| VEHICLE_INFO | VI_ID | NUMBER | NOT NULL | Yes | No |
| VEHICLE_INFO | VI_MK_ID | NUMBER | NULL | No | Yes |
| VEHICLE_INFO | VI_LICENSE_PLATE_NUMBER | VARCHAR2(20) | NULL | No | No |
| VEHICLE_INFO | VI_LICENSE_PLATE_STATE | VARCHAR2(20) | NULL | No | No |
| VEHICLE_INFO | VI_PRODUCTION_DATE | VARCHAR2(10) | NULL | No | No |
| VEHICLE_INFO | VI_VEHICLE_TYPE | VARCHAR2(20) | NULL | No | No |
| VEHICLE_INFO | VI_BODY_STYLE | VARCHAR2(50) | NULL | No | No |
| VEHICLE_INFO | VI_TRIM_CODE | VARCHAR2(20) | NULL | No | No |
| VEHICLE_INFO | VI_TRIM_COLOR | VARCHAR2(20) | NULL | No | No |
| VEHICLE_INFO | VI_MOLDING_CODE | VARCHAR2(20) | NULL | No | No |
| VEHICLE_INFO | VI_ENGINE_SIZE | VARCHAR2(40) | NULL | No | No |
| VEHICLE_INFO | VI_OPTIONS_LIST | VARCHAR2(4000) | NULL | No | No |
| VEHICLE_INFO | VI_COLOR | VARCHAR2(20) | NULL | No | No |
| VEHICLE_INFO | VI_TONE_INDICATOR | VARCHAR2(20) | NULL | No | No |
| VEHICLE_INFO | VI_PAINT_STAGE_INDICATOR | VARCHAR2(20) | NULL | No | No |
| VEHICLE_INFO | VI_PAINT_CODE_1 | VARCHAR2(20) | NULL | No | No |
| VEHICLE_INFO | VI_PAINT_CODE_2 | VARCHAR2(20) | NULL | No | No |
| VEHICLE_INFO | VI_PAINT_CODE_3 | VARCHAR2(20) | NULL | No | No |
| VEHICLE_INFO | VI_VEHICLE_MEMO | VARCHAR2(100) | NULL | No | No |
| VEHICLE_INFO | VI_VIN | VARCHAR2(30) | NULL | No | No |
| VEHICLE_INFO | VI_MILEAGE | VARCHAR2(20) | NULL | No | No |
| VEHICLE_INFO | VI_MODEL | VARCHAR2(50) | NULL | No | No |
| TOTALS_1 | NT_AMT | NUMBER(9,2) | NULL | No | No |
| TOTALS_1 | NT_HRS | NUMBER(5,1) | NULL | No | No |
| TOTALS_1 | NT_ADDLBR | NUMBER(9,2) | NULL | No | No |
| TOTALS_1 | NT_DISC | NUMBER(9,2) | NULL | No | No |
| TOTALS_1 | NT_MKUP | NUMBER(9,2) | NULL | No | No |
| TOTALS_1 | NT_GDIS | NUMBER(9,2) | NULL | No | No |
| TOTALS_1 | TTL_TYPAMT | NUMBER(9,2) | NULL | No | No |
| TOTALS_1 | TTL_HRS | NUMBER(5,1) | NULL | No | No |
| TOTALS_1 | TTL_AMT | NUMBER(9,2) | NULL | No | No |
| TOTALS_2 | ID | NUMBER | NOT NULL | Yes | No |
| TOTALS_2 | ENVELOPE_ID | NUMBER | NULL | No | Yes |
| TOTALS_2 | G_TTL_AMT | NUMBER(10,2) | NULL | No | No |
| TOTALS_2 | G_BETT_AMT | NUMBER(10,2) | NULL | No | No |
| TOTALS_2 | G_RPD_AMT | NUMBER(10,2) | NULL | No | No |
| TOTALS_2 | G_DED_AMT | NUMBER(10,2) | NULL | No | No |
| TOTALS_2 | G_CUST_AMT | NUMBER(10,2) | NULL | No | No |
| TOTALS_2 | G_AA_AMT | NUMBER(10,2) | NULL | No | No |
| TOTALS_2 | N_TTL_AMT | NUMBER(10,2) | NULL | No | No |
| TOTALS_2 | PREV_NET | NUMBER(10,2) | NULL | No | No |
| TOTALS_2 | SUPP_AMT | NUMBER(10,2) | NULL | No | No |
| TOTALS_2 | N_SUPP_ANT | NUMBER(10,2) | NULL | No | No |
| TOTALS_2 | G_UPD_AMT | NUMBER(10,2) | NULL | No | No |
| TOTALS_2 | G_TTL_DISC | NUMBER(10,2) | NULL | No | No |
| TOTALS_2 | G_TAX | NUMBER(10,2) | NULL | No | No |
| TOTALS_2 | GST_AMT | NUMBER(10,2) | NULL | No | No |
| USER_ROLE | USRR_CODE | VARCHAR2(4) | NOT NULL | Yes | No |
| USER_ROLE | USRR_NAME | VARCHAR2(20) | NOT NULL | No | No |
| USER_TERMS_OF_USE | TOU_USR_USER_NAME | VARCHAR2(50) | NULL | No | No |
| USER_TERMS_OF_USE | TOU_ENTRY_DATE | DATE | NULL | No | No |
| VALUE | VAL_ID | NUMBER | NOT NULL | Yes | No |
| VALUE | VAL_VALT_CODE | VARCHAR2(4) | NOT NULL | No | Yes |
| VALUE | VAL_NAME | VARCHAR2(50) | NULL | No | No |
| VALUE | VAL_DESCRIPTION | VARCHAR2(100) | NULL | No | No |
| VALUE_TYPE | VALT_CODE | VARCHAR2(4) | NOT NULL | Yes | No |
| VALUE_TYPE | VALT_TYPE | VARCHAR2(50) | NULL | No | No |
| VALUE_TYPE | VALT_DESCRIPTION | VARCHAR2(100) | NULL | No | No |
| VEHICLE | ID | NUMBER | NOT NULL | Yes | No |
| VEHICLE | ENVELOPE_ID | NUMBER | NULL | No | Yes |
| VEHICLE | IMPACT_1 | VARCHAR2(2) | NULL | No | No |
| VEHICLE | IMPACT_2 | VARCHAR2(30) | NULL | No | No |
| VEHICLE | DMG_MEMO | VARCHAR2(100) | NULL | No | No |
| VEHICLE | DB_V_CODE | VARCHAR2(7) | NULL | No | No |
| VEHICLE | PLATE_NO | VARCHAR2(10) | NULL | No | No |
| VEHICLE | PLATE_ST | VARCHAR2(2) | NULL | No | No |
| VEHICLE | V_VIN | VARCHAR2(25) | NULL | No | No |

Obviously, many modifications and variations of the present invention are possible in light of the above teachings. Thus, it is to be understood that, within the scope of the appended claims, the invention may be practiced otherwise than as specifically described above.

What is claimed and desired to be covered by a Letters patent is as follows:

1. An on-line parts location system for integrating a plurality of participating dealerships to provide a virtual network, the on-line parts location and ordering systems comprising:
a communication network;
an interface for interfacing said participating dealerships to said communication network to enable communications between said participating dealerships by way of a central office; and
a central office for configuring messages to and from said participating dealerships and connected to said communications network to enable parts to be located on-line from the parts inventories of said participating dealerships.

2. The on-line parts location system as recited in claim 1, further including part inventor processing system and a parts database for maintaining the parts inventory of said participating dealerships.

3. The on-line parts location system as recited in claim 2, wherein said parts inventor processing system automatically and periodically updates the parts inventor database.

4. The on-line parts location system as recited in claim 3, wherein said periodic updating of said parts inventory is provided by an extraction provider.

5. The on-line parts location system as recited in claim 1, wherein said interface includes a web browser for enabling at least one of participating dealerships to communicate with said central office by way of a public communications network.

6. The on-line parts location system as recited in claim 5, wherein said interface is configured to provide secure communications over said public communications network.

7. The on-line parts location system as recited in claim 6, wherein said system is configured to communicate over said network using a secure socket layer (SSL) protocol.

8. The on-line parts location system as recited in claim 6, wherein said system is configured to communicate over said network by way of a virtual private network.

9. The on-line parts location system as recited in claim 6, wherein said dealerships are configured to communicate with said central office by way of middleware server.

10. The parts location system as recited in claim 9, wherein communications between said participating dealerships and said middleware server are by way of a managed network.

11. The parts location system as recited in claim 10, wherein communications between said middleware server and said central office are by way of a public communication network.

12. The parts location system as recited in claim 11, wherein said communications over said public communication network are secure.

13. The parts location system as recited in claim 12, wherein said communications are by way of a secure sockets layer.

14. The parts location system as recited in claim 3, wherein said parts location system is integrated into application existing business management system (BMS) of one or more of said participating dealerships to provide access to said parts location system directly from said BMS application.

15. The parts location system as recited in claim 14 further including an on-line parts ordering system for enabling parts to be ordered from participating dealerships on-line.

16. The parts location system as recited in claim 15, wherein said parts location system enables participating dealerships to submit orders to one or more other participating dealerships on-line for parts.

17. The parts location system as recited in claim 16, wherein said parts ordering system is configured to provide an alert to participating selling dealerships of parts orders.

18. The parts location system as recited in claim 17, wherein said parts order system allows participating selling dealerships to accept or decline orders on-line and corresponding messages to be returned to the requesting dealership.

19. The parts location system as recited in claim 18, wherein said parts ordering system includes an orders database for storing order transactions.

20. The parts location system as recited in claim 15, wherein said parts ordering system is configured to generate parts purchase order on-line.
